(19) United States
(12) Patent Application Publication
(10) Pub. No.: US 2023/0164826 A1
(43) Pub. Date: May 25, 2023

(54) METHOD AND DEVICE IN NODES USED FOR WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 18/097,480

(22) Filed: Jan. 16, 2023

Related U.S. Application Data
(63) Continuation of application No. PCT/CN2021/102641, filed on Jun. 28, 2021.

(30) Foreign Application Priority Data
Jul. 18, 2020 (CN) 202010702813.0
Jul. 22, 2020 (CN) 202010713767.4
Jul. 31, 2020 (CN) 202010763650.7
Aug. 10, 2020 (CN) 202010794873.X
Aug. 24, 2020 (CN) 202010854453.6

(51) Int. Cl. H04W 72/563; H04L 1/1867; H04L 1/1829

(52) U.S. Cl. CPC H04W 72/563; H04L 1/1887; H04L 1/1854

(57) ABSTRACT

The present application provides a method and device in a node for wireless communications. A first receiver, receiving a first signaling and a second signaling; a first transmitter, transmits a first signal in a target radio resource block, the first signal carrying a first bit block; wherein the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block.

### CROSS REFERENCE TO RELATED APPLICATIONS

This application is the continuation of the international patent application No. PCT/CN2021/102641, filed on Jun. 28, 2021, which claims the priority benefit of Chinese Patent Application 202010702813.0, filed on Jul. 18, 2020; and claims the priority benefit of Chinese Patent Application 202010713767.4, filed on Jul. 22, 2020; and claims the priority benefit of Chinese Patent Application 202010763650.7, filed on Jul. 31, 2020; and claims the priority benefit of Chinese Patent Application 202010854453.6, filed on Aug. 24, 2020; and claims the priority benefit of Chinese Patent Application 202010794873.X, file on Aug. 10, 2020; the full disclosure of which is incorporated herein by reference.

### BACKGROUND

### Technical Field

The present application relates to transmission methods and devices in wireless communication systems, and in particular to a method and device of radio signal transmission in a wireless communication system supporting cellular networks.

### Related Art

In 5G systems, Enhance Mobile Broadband (eMBB) and Ultra Reliable and Low Latency Communication (URLLC) are two typical service types. Targeting requirements for lower target Block Error Ratio (BLER) of URLLC services, a new Modulation and Coding Scheme (MCS) table has been defined in 3rd Generation Partner Project (3GPP) New Radio (NR) Release 15.

1. In order to support higher reliability (for example: a target BLER is 10\hat{ }-6) and lower delay (for example: 0.5-1 ms) required by URLLC services, in 3GPP NR Release 16, a Downlink Control Information (DCI) signaling can indicate whether scheduled services are of low Priority or high Priority, where the high priority corresponds to URLLC services, and the low priority corresponds to eMBB services.

A Work Item (WI) of Ultra-reliable and Low Latency Communications (URLLC) enhancement in NR Release 17 was approved at 3GPP RAN Plenary, where the multiplexing of different Intra-User Equipment (UE) services is a focus to be researched.

2. 3GPP NR Release 16 has supported multiple repetition-based uplink transmission modes, comprising a transmission mode of PUSCH repetition type B.

A Work Item (WI) of URLLC enhancement in NR Release 17 was approved at 3GPP RAN Plenary, where URLLC services performed on the NR Unlicensed Spectrum (NR-U) is a focus to be researched.

### SUMMARY

A. After introducing the multiplexing of different intra-UE priority services, the UE can multiplex Uplink Control Information (UCI) with different priorities onto a same Physical Uplink Control Channel (PUCCH) for transmission; the UE may need to reselect PUCCH resources during the multiplexing procedure. How to deal with the collision with other channels incurred by PUCCH resource reselection is a key problem to be solved.

To address the above problem, the present application provides a solution. It should be noted that though the present application only took the Uplink for example in the statement above, it is also applicable to other transmission scenarios of Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first signaling and a second signaling; and

transmitting a first signal in a target radio resource block, the first signal carrying a first bit block;

herein, the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one embodiment, a problem to be solved in the present application comprises: when UCIs with different priorities (comprising Hybrid Automatic Repeat reQuest Acknowledgement (HARQ-ACK)) are allowed to be multiplexed into a same PUCCH, how to deal with the collision between multiple physical-layer channels incurred by the reselection of PUCCH resources.

In one embodiment, a problem to be solved in the present application comprises: how to ensure the communication performance of high-priority services while allowing the multiplexing of different intra-UE priority services.

In one embodiment, the above method is essential in that: when a PUCCH required to carry multiplexed UCIs with different priorities collides with another uplink physical-layer channel (e.g., a PUSCH), the priority corresponding to the another uplink physical-layer channel is used to determine whether the multiplexing is executed.

In one embodiment, the above method is essential in that: when a PUCCH required to carry multiplexed UCIs with different priorities collides with another uplink physical-layer channel (e.g., a PUSCH), a priority corresponding to the another uplink physical-layer channel is used to determine how UCIs with different priorities are multiplexed.

In one embodiment, the above method is essential in that: when a PUCCH required to carry the first bit block and the third bit block collides with another uplink physical-layer channel (such as a PUSCH), a priority corresponding to the another uplink physical-layer channel is used to determine whether the multiplexing is executed or how the multiplexing is executed.

In one embodiment, advantages of the above method comprise ensuring the transmission performance of high-priority data or control information.

In one embodiment, advantages of the above method comprise improving spectral efficiency.

In one embodiment, the word of collision in the present application comprises being overlapping in time domain.

According to one aspect of the present application, the above method is characterized in that

the first bit block comprises a first-type HARQ-ACK; the third bit block comprises a second-type HARQ-ACK.

According to one aspect of the present application, the above method is characterized in that

when a priority of the second bit block is a first priority, the target radio resource block is the fourth radio resource block; when a priority of the second bit block is not the first priority, the target radio resource block is the first radio resource block.

In one embodiment, advantages of the above method comprise: a PUCCH required to carry the first bit block and the third bit block collides with another uplink physical-layer channel (such as a PUSCH); when a priority corresponding to the another uplink physical-layer channel is a high priority, the transmission performance of the another uplink physical-layer channel in transmitted data or control information not being affected is ensured.

In one embodiment, advantages of the above method comprise: a PUCCH required to carry the first bit block and the third bit block collides with another uplink physical-layer channel (such as a PUSCH); when a priority corresponding to the another uplink physical-layer channel is a low priority, the third bit block is transmitted after being multiplexed, which improves the system performance.

According to one aspect of the present application, the above method is characterized in that

when a priority of the second bit block is a first priority, the target radio resource block is the fourth radio resource block; when a priority of the second bit block is not the first priority, the target radio resource block is the first radio resource block.

According to one aspect of the present application, the above method is characterized in that

N number range(s) corresponds (respectively correspond) to N radio resource block set(s); a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block set(s); the first radio resource block set comprises the first radio resource block.

According to one aspect of the present application, the above method is characterized in that

when the target radio resource block is the first radio resource block, the first node does not transmit a signal carrying the second bit block in a second radio resource sub-block; the second radio resource sub-block is a part overlapping with the first radio resource block in time domain and comprised in the second radio resource block.

In one embodiment, the above method is essential in that: when a PUCCH required to carry the first bit block and the third bit block collides with another uplink physical-layer channel (such as a PUSCH) and a priority corresponding to the another uplink physical-layer channel is a low priority, only partial signals in the another uplink physical-layer channel is not transmitted.

In one embodiment, advantages of the above method comprise: being conducive to executing an operation of cancellation.

According to one aspect of the present application, the above method is characterized in that

the first number is used to determine the fourth radio resource block; a number of bit(s) comprised in the first bit block and a number of bit(s) comprised in a fourth bit block are used to determine the first number; the fourth bit block is related to the third bit block; a number of bit(s) comprised in the fourth bit block is less than a number of bit(s) comprised in the third bit block.

In one embodiment, the above method is essential in that: when a PUCCH required to carry all high-priority UCIs and all low-priority UCIs collides with another uplink physical-layer channel (such as a PUSCH): (if a priority corresponding to the another uplink physical-layer channel is a high priority) the low-priority UCI is multiplexed to be transmitted on a PUCCH orthogonal to the another uplink physical-layer channel in time domain after a first processing.

In one embodiment, a number of bit(s) comprised in an input of the first processing is greater than a number of bit(s) comprised in an input of the first processor.

In one embodiment, the first processing comprises one or multiple operations of logical AND, logical OR, XOR, deleting bit, precoding, adding repeat bit or zero-padding.

In one embodiment, advantages of the above method comprise: the number of reported UCI information bit(s) is optimized without affecting the transmission of high-priority information.

The present application provides a method in a second node for wireless communications, comprising:

transmitting a first signaling and a second signaling; and

receiving a first signal in a target radio resource block, the first signal carrying a first bit block;

herein, the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

According to one aspect of the present application, the above method is characterized in that

the first bit block comprises a first-type HARQ-ACK; the third bit block comprises a second-type HARQ-ACK.

According to one aspect of the present application, the above method is characterized in that

when a priority of the second bit block is a first priority, the target radio resource block is the fourth radio resource block; when a priority of the second bit block is not the first priority, the target radio resource block is the first radio resource block.

According to one aspect of the present application, the above method is characterized in that

when a priority of the second bit block is a first priority, the target radio resource block is the fourth radio resource block; when a priority of the second bit block is not the first priority, the target radio resource block is the first radio resource block.

According to one aspect of the present application, the above method is characterized in that

N number range(s) corresponds (respectively correspond) to N radio resource block set(s); a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block set(s); the first radio resource block set comprises the first radio resource block.

According to one aspect of the present application, the above method is characterized in that

when the target radio resource block is the first radio resource block, the second node does not execute a signal reception for the second bit block in a second radio resource sub-block; the second radio resource sub-block is a part overlapping with the first radio resource block in time domain and comprised in the second radio resource block.

According to one aspect of the present application, the above method is characterized in that

the first number is used to determine the fourth radio resource block; a number of bit(s) comprised in the first bit block and a number of bit(s) comprised in a fourth bit block are used to determine the first number; the fourth bit block is related to the third bit block; a number of bit(s) comprised in the fourth bit block is less than a number of bit(s) comprised in the third bit block.

The present application provides a first node for wireless communications, comprising:

a first receiver, receiving a first signaling and a second signaling; and

a first transmitter, transmitting a first signal in a target radio resource block, the first signal carrying a first bit block;

herein, the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

The present application provides a second node for wireless communications, comprising:

a second transmitter, transmitting a first signaling and a second signaling; and

a second receiver, receiving a first signal on a target radio resource block, the first signal carrying a first bit block;

herein, the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one embodiment, the method in the present application is advantageous in the following aspects:
ensuring the transmission performance of high-priority data or control information (e.g., reliability or delay requirements);
improving spectral efficiency of the communication system;
balancing the transmission performance of high-priority information and the reporting performance of low-priority UCI;
being conducive to execute the operation of cancellation;
the number of reported UCI information bit(s) is optimized without affecting the transmission of high-priority information.

B. In the current version of the protocol, when a high-priority uplink physical-layer channel collides with a low-priority uplink physical-layer channel carrying a low-priority UCI, the low-priority UCI is directly dropped; this collision handling method will reduce the overall system efficiency; after introducing the multiplexing of different intra-UE priority services, it is possible to multiplex a low-priority UCI onto a high-priority Physical Uplink Shared CHannel (PUSCH)/Physical Uplink Control CHannel (PUCCH). How to reasonably perform the multiplexing between services with different priorities to improve the system performance under the condition of ensuring the requirements of reliability or delay of high-priority data/control information is a key problem to be solved in the Uplink (UL) of 5G systems. The above problems are applicable to a scenario of service multiplexing between URLLC and eMBB, as well as a scenario of the sidelink Hybrid Automatic Repeat reQuest Acknowledgment (HARQ-ACK) information reported on uplink in 5G systems comprising Sidelink (SL).

To address the above problem, the present application provides a solution. In description of the above problem, an Uplink is illustrated as an example; it is also applicable to other scenarios of Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first signaling; and

transmitting a first signal in a target radio resource block, the first signal carrying a bit block generated by a first bit block;

herein, the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one embodiment, a problem to be solved in the present application comprises: when a PUCCH carrying UCI (such as UL UCI, SL HARQ, etc.) collides with a PUSCH, how to determine in which physical-layer channel the UCI is transmitted according to a priority corresponding to the PUSCH and a priority corresponding to the UCI.

In one embodiment, a problem to be solved in the present application comprises: when a PUCCH carrying UCI (such as UL UCI, SL HARQ, etc.) collides with multiple PUSCHs with different priorities, how to determine in which physical-layer channel the UCI is transmitted.

In one embodiment, a problem to be solved in the present application comprises: when a PUCCH carrying UCI (such as UL UCI, SL HARQ, etc.) collides with one or multiple PUSCHs, how to determine in which physical-layer channel the UCI is transmitted according to a UCI with which priority is carried by a PUCCH.

In one embodiment, the phrase of collision in the present application comprises: being overlapping in time domain.

According to one aspect of the present application, the above method is characterized in that

when the first radio resource block group comprises a radio resource block corresponding to the first priority, a priority corresponding to the first bit block is not used to determine the target radio resource block; when the first radio resource block group does not comprise any radio resource block corresponding to the first priority, a priority corresponding to the first bit block is used to determine the target radio resource block.

According to one aspect of the present application, the above method is characterized in that

a second priority set comprises multiple priorities; the priority corresponding to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group.

In one embodiment, the above method is essential in that: when a PUCCH carrying UCI collides with a high-priority PUSCH, the UCI is transmitted in the high-priority PUSCH regardless of a priority of the UCI.

In one embodiment, advantages of the above method comprise enhancing the transmission performance of UCI, thus improving the system efficiency.

In one embodiment, the above method is essential in that: when a PUCCH carrying UCI collides with a high-priority PUSCH as well as a low-priority PUSCH, the UCI is transmitted in the high-priority PUSCH regardless of a priority of the UCI.

In one embodiment, advantages of the above method comprise avoiding unnecessary data retransmission incurred by HARQ-ACK being dropped in some cases.

According to one aspect of the present application, the above method is characterized in that

the first radio resource block group does not comprise any radio resource block corresponding to the first priority; when the priority corresponding to the first bit block is not the first priority, the target radio resource block is a radio resource block in the first radio resource block group, and a bit block generated by the first bit block is transmitted in the radio resource block in the first radio resource block group; when the priority corresponding to the first bit block is the first priority, the target radio resource block is the second radio resource block, and a bit block generated by the first bit block is transmitted in the second radio resource block.

In one embodiment, the above method is essential in that: a high-priority UCI cannot be multiplexed onto a low-priority PUSCH.

In one embodiment, advantages of the above method comprise ensuring the transmission performance of a high-priority UCI.

In one embodiment, advantages of the above method comprise being conducive to execute cancellation for a transmission of a low-priority PUSCH.

In one embodiment, advantages of the above method include: being conducive to satisfy latency requirements of high-priority data/control information.

According to one aspect of the present application, the above method is characterized in that

when the first radio resource block group does not comprise any radio resource block corresponding to the first priority, a size relation between a value of the priority corresponding to the first bit block and a first threshold is used to determine the target radio resource block.

In one embodiment, the above method is essential in judging whether the multiplexing is performed according to a priority of an SL HARQ-ACK.

According to one aspect of the present application, the above method is characterized in that

a value of the priority corresponding to the first bit block is less than a second threshold; the second threshold is greater than the first threshold.

According to one aspect of the present application, the above method is characterized in that

when the first radio resource block group does not comprise any radio resource block corresponding to the first priority, a bit block generated by the first bit block is transmitted in the second radio resource block; when the first radio resource block group comprises a radio resource block corresponding to the first priority, a priority corresponding to the first bit block is used to determine the target radio resource block.

In one embodiment, advantages of the above method comprise enhancing the transmission performance of a low-priority UCI in the PUCCH repetition scenario.

The present application provides a method in a second node for wireless communications, comprising:

transmitting a first signaling; and

receiving a first signal in a target radio resource block, the first signal carrying a bit block generated by a first bit block;

herein, the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

According to one aspect of the present application, the above method is characterized in that

when the first radio resource block group comprises a radio resource block corresponding to the first priority, a priority corresponding to the first bit block is not used to determine the target radio resource block; when the first radio resource block group does not comprise a radio resource block corresponding to the first priority, a priority corresponding to the first bit block is used to determine the target radio resource block.

According to one aspect of the present application, the above method is characterized in that

a second priority set comprises multiple priorities; the priority corresponding to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group.

According to one aspect of the present application, the above method is characterized in that

the first radio resource block group does not comprise a radio resource block corresponding to the first priority; when the priority corresponding to the first bit block is not the first priority, the target radio resource block is a radio resource block in the first radio resource block group, and a bit block generated by the first bit block is transmitted in the radio resource block in the first radio resource block group; when the priority corresponding to the first bit block is the first priority, the target radio resource block is the second radio resource block, and a bit block generated by the first bit block is transmitted in the second radio resource block.

According to one aspect of the present application, the above method is characterized in that

when the first radio resource block group does not comprise a radio resource block corresponding to the first priority, a size relation between a value of the priority corresponding to the first bit block and a first threshold is used to determine the target radio resource block.

According to one aspect of the present application, the above method is characterized in that

a value of the priority corresponding to the first bit block is less than a second threshold; the second threshold is greater than the first threshold.

According to one aspect of the present application, the above method is characterized in that

when the first radio resource block group does not comprise a radio resource block corresponding to the first priority, a bit block generated by the first bit block is transmitted in the second radio resource block; when the first radio resource block group comprises a radio resource block corresponding to the first priority, a priority corresponding to the first bit block is used to determine the target radio resource block.

The present application provides a first node for wireless communications, comprising:

a first receiver, receiving a first signaling; and

a first transmitter, transmitting a first signal in a target radio resource block, the first signal carrying a bit block generated by a first bit block;

herein, the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

The present application provides a second node for wireless communications, comprising:

a second transmitter, transmitting a first signaling; and

a second receiver, receiving a first signal in a target radio resource block, the first signal carrying a bit block generated by a first bit block;

herein, the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one embodiment, the method in the present application is advantageous in the following aspects:
enhancing the transmission performance of UCI, thus improving the system efficiency;
avoiding unnecessary data retransmission incurred by a low-priority HARQ-ACK being dropped in some cases.
ensuring the transmission performance of a high-priority UCI;
being conducive to execute cancellation for a transmission of a low-priority PUSCH;
being conducive to satisfy latency requirements of high-priority data/control information;
enhancing the transmission performance of a low-priority UCI in the PUCCH repetition scenario.

C. After introducing the multiplexing of different intra-UE priority services, the UE can multiplex a low-priority UCI onto a high-priority Physical Uplink Control Channel (PUCCH) for transmission. How to reasonably perform the multiplexing to improve the system performance while ensuring the reliability or delay of high-priority information is a key problem to be solved.

To address the above problem, the present application provides a solution. It should be noted that though the present application only took the Uplink for example in the statement above, it is also applicable to other scenarios of Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a second signaling and a first signaling; and

transmitting a first signal in a first radio resource block, the first signal carrying a first bit block;

herein, the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

In one embodiment, a problem to be solved in the present application comprises: when multiple PUCCHs carrying UCIs of different priorities, how to determine whether UCIs of different priorities are multiplexed into a same PUCCH.

In one embodiment, a problem to be solved in the present application comprises: when multiple PUCCHs carrying UCIs of different priorities, how to determine the multiplexing method of UCIs with different priorities.

In one embodiment, the above method is essential in that: when multiple PUCCHs carrying UCIs with different priorities collide with each other, a field comprised in a DCI corresponding to a high-priority Hybrid Automatic Repeat reQuest Acknowledgement (HARQ) dynamically indicates whether a low-priority UCI is multiplexed to a high-priority PUCCH.

In one embodiment, the above method is essential in that: the base station can dynamically indicate the UE to multiplex a low-priority UCI into a high-priority PUCCH for transmission or drop a transmission of a low-priority UCI according to the reliability or delay requirements of the high-priority information.

In one embodiment, advantages of the above method comprise: the base station can perform a dynamic indication according to the reliability or delay requirements of high-priority information, which is conducive to optimizing the overall system performance.

In one embodiment, the above method is essential in that: when multiple PUCCHs carrying UCIs with different priorities collide with each other, a field comprised in a DCI corresponding to a high-priority HARQ dynamically indicates a number of bit(s) of a low-priority UCI being multiplexed into a high-priority PUCCH.

In one embodiment, advantages of the above method comprise: reducing the impact of multiplexing between UCIs with different priorities on the transmission performance (comprising reliability or delay) of a high-priority UCI.

According to one aspect of the present application, the above method is characterized in that

a third radio resource block is reserved for the first bit block; a second radio resource block is reserved for the second bit block; the third radio resource block and the second radio resource block are overlapping in time domain.

According to one aspect of the present application, the above method is characterized in that

the second field in the first signaling is used to determine whether a bit block generated by the second bit block is used to determine a first radio resource block set; the first radio resource block is a radio resource block in the first radio resource block set.

In one embodiment, advantages of the above method include: the base station can dynamically indicate whether resources reserved for a high-priority UCI are used to transmit a low-priority UCI, which is conducive to the optimization of resource allocation.

According to one aspect of the present application, the above method is characterized in that

the number of bit(s) related to the second bit block and carried by the first signal is equal to one of K candidate numbers; the second field in the first signaling indicates an index of the number of bit(s) related to the second bit block and carried by the first signal among the K candidate numbers; K is greater than 1.

According to one aspect of the present application, the above method is characterized in that

when a value of the second field in the first signaling is equal to a first value, the second field in the first signaling indicates that the number of bit(s) related to the second bit block and carried by the first signal is equal to 0; when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

According to one aspect of the present application, the above method is characterized in that

the second field in the first signaling is used to determine whether a size of the first bit block is used to determine the number of bit(s) related to the second bit block and carried by the first signal.

In one embodiment, the above method is essential in that: the UE determines a number of bit(s) of the transmitted second-type HARQ-ACK (a low-priority HARQ-ACK) according to an indication of the second field in the first signaling and a size of the first bit block.

In one embodiment, advantages of the above method comprise: avoiding using too many high-priority resources to transmit priority information.

According to one aspect of the present application, the above method is characterized in that

the second field in the first signaling is used to determine whether a number of bit(s) of the second-type HARQ-ACK related to the second bit block and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

In one embodiment, the above method is essential in that: the base station dynamically indicates the UE to report HARQ-ACK information corresponding to which priority and which PDSCH group.

In one embodiment, advantages of the above method include: being able to report a HARQ-ACK more flexibly, thus reducing unnecessary resource overhead.

The present application provides a method in a second node for wireless communications, comprising:

transmitting a second signaling and a first signaling; and

receiving a first signal in a first radio resource block, the first signal carrying a first bit block;

herein, the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

According to one aspect of the present application, the above method is characterized in that

a third radio resource block is reserved for the first bit block; a second radio resource block is reserved for the second bit block; the third radio resource block and the second radio resource block are overlapping in time domain.

According to one aspect of the present application, the above method is characterized in that

the second field in the first signaling is used to determine whether a bit block generated by the second bit block is used to determine a first radio resource block set; the first radio resource block is a radio resource block in the first radio resource block set.

According to one aspect of the present application, the above method is characterized in that

the number of bit(s) related to the second bit block and carried by the first signal is equal to one of K candidate numbers; the second field in the first signaling indicates an index of the number of bit(s) related to the second bit block and carried by the first signal among the K candidate numbers; K is greater than 1.

According to one aspect of the present application, the above method is characterized in that

when a value of the second field in the first signaling is equal to a first value, the second field in the first signaling indicates that the number of bit(s) related to the second bit block and carried by the first signal is equal to 0;

when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

According to one aspect of the present application, the above method is characterized in that

the second field in the first signaling is used to determine whether a size of the first bit block is used to determine the number of bit(s) related to the second bit block and carried by the first signal.

According to one aspect of the present application, the above method is characterized in that

the second field in the first signaling is used to determine whether a number of bit(s) of the second-type HARQ-ACK related to the second bit block and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

The present application provides a first node for wireless communications, comprising:

a first receiver, receiving a second signaling and a first signaling; and

a first transmitter, transmitting a first signal in a first radio resource block, the first signal carrying a first bit block;

herein, the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

The present application provides a second node for wireless communications, comprising:

a second transmitter, transmitting a second signaling and a first signaling; and

a second receiver, receiving a first signal in a first radio resource block, the first signal carrying a first bit block;

herein, the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

In one embodiment, the method in the present application is advantageous in the following aspects:
the base station can dynamically indicate the reliability or delay requirements according to high-priority information, which is conducive to optimizing the overall system performance.
being conducive to optimizing the resource allocation;
reducing the impact on the transmission performance of a high-priority UCI incurred by UCIs with different priorities being multiplexed onto a same PUCCH (due to DCI loss and other reasons);
avoiding the transmission of low-priority information occupying too many resources reserved for high-priority information;
being able to more flexibly select HARQ-ACK information required to be reported;
reducing unnecessary resource overhead.

D. In a transmission mode of PUSCH repetition type B, an actual repetition occupying a single multicarrier symbol does not carry UCI. In the NR-U system, if Configured Grant Uplink Control Information (CG-UCI) is not carried, the base station will not be able to acquire Redundancy Version (RV) information required to resolve a received PUSCH.

To address the above problem, the present application provides a solution. It should be noted that though the present application only took the Uplink for example in the statement above, it is also applicable to other transmission scenarios, such as Downlink and Sidelink, where similar technical effects can be achieved. Additionally, the adoption of a unified solution for various scenarios (including but not limited to Uplink, Downlink and Sidelink) contributes to the reduction of hardcore complexity and costs. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first signaling; and

transmitting a first signal in a first time window, the first signal carrying a first bit block;

herein, the first signaling is used to determine the first time window; the first time window is reserved for a transmission of the first bit block; the first time window comprises one or more time element(s); a number of the time element(s) comprised in the first time window is used to determine whether a Redundancy Version (RV) corresponding to the first signal is determined by a bit block carried by the first signal.

In one embodiment, a problem to be solved in the present application includes: in a transmission mode of PUSCH repetition type B, how to determine a corresponding RV according to a number of multicarrier symbol(s) occupied by an actual repetition.

In one embodiment, a problem to be solved in the present application comprises: how to determine a corresponding RV according to a CG-UCI.

According to one aspect of the present application, the above method is characterized in that

the first signaling is used to determine K time windows, K being a positive integer greater than 1; the first time window is one of the K time windows.

In one embodiment, the above method is essential in that: the first time window is used to carry one of K repetitions of the first bit block.

According to one aspect of the present application, the above method is characterized in that

each of the K time windows is respectively reserved for a physical-layer channel transmission with configured grant used to carry the first bit block.

According to one aspect of the present application, the above method is characterized in that

when the number of the time element(s) comprised in the first time window is not greater than a first number, the first signal does not carry a bit block used to determine the RV corresponding to the first signal, and the RV corresponding to the first signal is a first RV; when the number of the time element(s) comprised in the first time window is greater than the first number, the first signal carries a second bit block, and the second bit block is used to determine the RV corresponding to the first signal.

In one embodiment, the above method is essential in that: an RV corresponding to the first signal is determined according to whether the first signal can carry a UCI.

In one embodiment, advantages of the above method comprise avoiding the inconsistent understanding of the RV corresponding to the first signal between both communication parties.

In one embodiment, advantages of the above method comprise: when the first signal can carry a UCI, the RV corresponding to the first signal is indicated through a carried UCI, thus ensuring the flexibility to optimize the communication performance.

In one embodiment, advantages of the above method comprise: reducing UCI overhead and improving resource utilization.

In one embodiment, advantages of the above method comprise: fully utilizing PUSCH resources of a single multicarrier symbol.

According to one aspect of the present application, the above method is characterized in that

K is used to determine the first RV.

In one embodiment, the above method is essential in that: when the first signal does not carry a UCI, the RV corresponding to the first signal is determined according to a number of repetition(s).

In one embodiment, advantages of the above method comprise: selecting the optimal RV corresponding to the first signal based on the number of repetition(s).

According to one aspect of the present application, the above method is characterized in that

a first time slice comprises the first time window; the first time slice is used to determine the first RV.

In one embodiment, the above method is essential in that: when the first signal does not carry a UCI, the RV corresponding to the first signal is determined according to which one of the multiple time slices the first time window belongs to.

In one embodiment, advantages of the above method comprise: optimizing the selection of an RV.

According to one aspect of the present application, the above method is characterized in that

the second bit block is transmitted in the first time window; the second bit block comprises indication information related to channel occupation time.

The present application provides a method in a second node for wireless communications, comprising:

transmitting a first signaling; and

receiving a first signal in a first time window, the first signal carrying a first bit block;

herein, the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

According to one aspect of the present application, the above method is characterized in that

the first signaling is used to determine K time windows, K being a positive integer greater than 1; the first time window is one of the K time windows.

According to one aspect of the present application, the above method is characterized in that

each of the K time windows is respectively reserved for a physical-layer channel transmission with configured grant used to carry the first bit block.

According to one aspect of the present application, the above method is characterized in that

when the number of the time element(s) comprised in the first time window is not greater than a first number, the first signal does not carry a bit block used to determine the RV corresponding to the first signal, and the RV corresponding to the first signal is a first RV; when the number of the time element(s) comprised in the first time window is greater than the first number, the first signal carries a second bit block, and the second bit block is used to determine the RV corresponding to the first signal.

According to one aspect of the present application, the above method is characterized in that

K is used to determine the first RV.

According to one aspect of the present application, the above method is characterized in that

a first time slice comprises the first time window; the first time slice is used to determine the first RV.

According to one aspect of the present application, the above method is characterized in that

the second bit block is transmitted in the first time window; the second bit block comprises indication information related to channel occupation time.

The present application provides a first node for wireless communications, comprising:

a first receiver, receiving a first signaling; and

a first transmitter, transmitting a first signal in a first time window, the first signal carrying a first bit block;

herein, the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

The present application provides a second node for wireless communications, comprising:

a second transmitter, transmitting a first signaling; and

a second receiver, receiving a first signal in a first time window, the first signal carrying a first bit block;

herein, the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

In one embodiment, the method in the present application is advantageous in the following aspects:
ensuring the flexibility;
avoiding an inconsistent understanding of the RV corresponding to the first signal between both communication parties;
reducing the UCI overhead and improving the resource utilization;
optimizing the selection of an RV to improve the communication performance.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of the processing of a first node according to one embodiment of the present application;

FIG. 1B illustrates a flowchart of the processing of a first node according to one embodiment of the present application;

FIG. 1C illustrates a flowchart of the processing of a first node according to one embodiment of the present application;

FIG. 1D illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of signal transmission according to one embodiment of the present application;

FIG. 5B illustrates a flowchart of signal transmission according to one embodiment of the present application;

FIG. 5C illustrates a flowchart of signal transmission according to one embodiment of the present application;

FIG. 5D illustrates a flowchart of signal transmission according to one embodiment of the present application;

FIG. 6A illustrates a schematic diagram of relations among a fifth radio resource block, a first bit block, a third radio resource block and a third bit block according to one embodiment of the present application;

FIG. 6B illustrates a schematic diagram of a flowchart of judging whether a priority corresponding to a first bit block is used to determine a target radio resource block according to one embodiment of the present application;

FIG. 6C illustrates a schematic diagram of relations among a first signaling, a third radio resource block, a second signaling and a second radio resource block according to one embodiment of the present application;

FIG. 6D illustrates a schematic diagram of relations among a first signaling, K time windows and a first time window according to one embodiment of the present application;

FIG. 7A illustrates a schematic diagram of relations among N number range(s), N radio resource block set(s), a sum of a number of bit(s) comprised in a first bit block and a number of bit(s) comprised in a third bit block, a first number range, a first radio resource block set and a first radio resource block according to one embodiment of the present application;

FIG. 7B illustrates a schematic diagram of a flowchart of determining the target radio resource block according to one embodiment of the present application;

FIG. 7C illustrates a schematic diagram of relations among a second field in a first signaling, a second bit block and a first radio resource block set according to one embodiment of the present application;

FIG. 7D illustrates a schematic diagram of a first signaling being used to determine K time windows according to one embodiment of the present application;

FIG. 8A illustrates a schematic diagram of a flowchart of a priority of a second bit block being used to determine a target radio resource block from a first radio resource block and a fourth radio resource block according to one embodiment of the present application;

FIG. 8B illustrates a schematic diagram of relations among a value of a priority corresponding to a first bit block, a first threshold and a target radio resource block according to one embodiment of the present application;

FIG. 8C illustrates a schematic diagram of a flowchart of a second field in a first signaling being used to determine a number of bit(s) related to a second bit block and carried by a first signal according to one embodiment of the present application;

FIG. 8D illustrates a schematic diagram of a first signaling being used to determine K time windows according to one embodiment of the present application;

FIG. 9A illustrates a schematic diagram of a flowchart of judging whether a signal carrying a second bit block is not transmitted in a second radio resource sub-block according to one embodiment of the present application;

FIG. 9B illustrates a schematic diagram of a relation between a first bit block and a first bit sub-block group according to one embodiment of the present application;

FIG. 9C illustrates a schematic diagram of relations among a number of bit(s) related to a second bit block and carried by a first signal, a first candidate number, a second field in a first signaling and a first candidate number index according to one embodiment of the present application;

FIG. 9D illustrates a schematic diagram of a flowchart of judging whether an RV corresponding to a first signal is determined by a bit block carried by a first signal according to one embodiment of the present application;

FIG. 10A illustrates a schematic diagram of judging whether a second signal is transmitted in a second radio resource block according to one embodiment of the present application;

FIG. 10B illustrates a schematic diagram of a flowchart of whether a priority corresponding to a first bit block being used to determine a target radio resource block according to another embodiment of the present application;

FIG. 10C illustrates a schematic diagram of a flowchart of relations among a second field in a first signaling, a size of a first bit block and a number of bit(s) related to a second bit block and carried by a first signal according to one embodiment of the present application;

FIG. 10D illustrates a schematic diagram of a relation between K and a first RV according to one embodiment of the present application;

FIG. 11A illustrates a schematic diagram of relations among a number of bit(s) comprised in a first bit block, a number of bit(s) comprised in a fourth bit block, a first number and a number of bit(s) comprised in a third bit block according to one embodiment of the present application;

FIG. 11B illustrates a structure block diagram of a processor in a first node according to one embodiment of the present application;

FIG. 11C illustrates a schematic diagram of relations among a first signaling, a second field in a first signaling, a third field in a first signaling and a HARQ_ACK carried by a first signal according to one embodiment of the present application;

FIG. 11D illustrates a schematic diagram of relations among a first time slice, a first time window and a first RV according to one embodiment of the present application;

FIG. 12A illustrates a structure block diagram of a processor in a first node according to one embodiment of the present application;

FIG. 12B illustrates a structure block diagram of a processor in second node according to one embodiment of the present application;

FIG. 12C illustrates a structure block diagram of a processor in a first node according to one embodiment of the present application;

FIG. 12D illustrates a structure block diagram of a processor in a first node according to one embodiment of the present application;

FIG. 13A illustrates a structure block diagram of a processor in second node according to one embodiment of the present application;

FIG. 13B illustrates a structure block diagram of a processor in second node according to one embodiment of the present application;

FIG. 13C illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

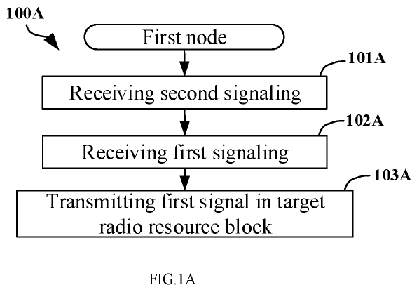

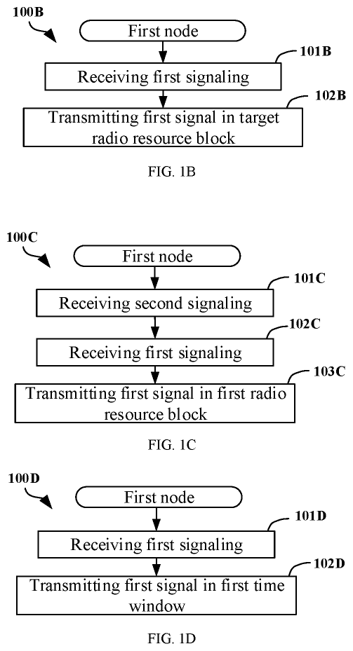

Embodiment 1A illustrates flowchart of the processing of a first node according to one embodiment of the present application, as shown in FIG. 1A.

In Embodiment 1A, the first node in the present application receives a second signaling in step 101A; receives a first signaling in step 102A; transmits a first signal in a target radio resource block in step 103A.

In embodiment 1A, the first signal carries a first bit block; the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one embodiment, the first signal comprises a radio signal.

In one embodiment, the first signal comprises a radio-frequency signal.

In one embodiment, the first signal comprises a baseband signal.

In one embodiment, the first node firstly receives the second signaling and then receives the first signaling.

In one embodiment, the first node firstly receives the first signaling and then receives the second signaling.

In one embodiment, the first node receives the first signaling and the second signaling at the same time.

In one embodiment, the first signaling is dynamically configured.

In one embodiment, the first signaling comprises a layer 1 (L1) signaling.

In one embodiment, the first signaling comprises an L1 control signaling.

In one embodiment, the first signaling comprises a physical-layer signaling.

In one embodiment, the first signaling comprises one or multiple fields in a physical-layer signaling.

In one embodiment, the first signaling comprises a higher-layer signaling.

In one embodiment, the first signaling comprises one or multiple fields in a higher-layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or multiple fields in an RRC signaling.

In one embodiment, the first signaling comprises one or multiple fields in a MAC CE signaling.

In one embodiment, the first signaling comprises Downlink Control Information (DCI).

In one embodiment, the first signaling comprises one or multiple fields in a DCI.

In one embodiment, the first signaling comprises Sidelink Control Information (SCI).

In one embodiment, the first signaling comprises one or multiple fields in an SCI.

In one embodiment, the first signaling comprises one or multiple fieldsmultiple fields in an Information Element (IE).

In one embodiment, the first signaling is a DownLink Grant Signalling.

In one embodiment, the first signaling is transmitted on a downlink physical-layer control channel (i.e., a downlink channel only capable of bearing a physical-layer signaling).

In one embodiment, the downlink physical-layer control channel in the present application is a Physical Downlink Control CHannel (PDCCH).

In one embodiment, the downlink physical-layer control channel in the present application is a short PDCCH (sPDCCH).

In one embodiment, the downlink physical-layer control channel in the present application is a Narrow Band PDCCH (NB-PDCCH).

In one embodiment, the first signaling is DCI format 1_0, and for the specific meaning of the DCI format 10, refer to section 7.3.1.2 in 3GPP TS38. 212.

In one embodiment, the first signaling is DCI format 1_1, and for the specific meaning of the DCI format 11, refer to section 7.3.1.2 in 3GPP TS38. 212.

In one embodiment, the first signaling is DCI format 1_2, and for the specific meaning of the DCI format 12, refer to section 7.3.1.2 in 3GPP TS38. 212.

In one embodiment, the first signaling is a signaling used to schedule a downlink physical-layer data channel.

In one embodiment, the downlink physical-layer data channel in the present application is a Physical Downlink Shared CHannel (PDSCH).

In one embodiment, the downlink physical-layer data channel in the present application is a short PDSCH (sPDSCH).

In one embodiment, the downlink physical-layer data channel in the present application is a Narrow Band PDSCH (NB-PDSCH).

In one embodiment, the second signaling is dynamically configured.

In one embodiment, the second signaling comprises a layer-1 signaling.

In one embodiment, the second signaling comprises a layer-1 control signaling.

In one embodiment, the second signaling comprises a physical-layer signaling.

In one embodiment, the second signaling comprises one or multiple fields in a physical-layer signaling.

In one embodiment, the second signaling comprises a higher-layer signaling.

In one embodiment, the second signaling comprises one or multiple fields in a higher-layer signaling.

In one embodiment, the second signaling comprises an RRC signaling.

In one embodiment, the second signaling comprises a MAC CE signaling.

In one embodiment, the second signaling comprises one or multiple fields in an RRC signaling.

In one embodiment, the second signaling comprises one or multiple fields in a MAC CE signaling.

In one embodiment, the second signaling comprises a DCI.

In one embodiment, the second signaling comprises one or multiple fields in a DCI.

In one embodiment, the second signaling comprises an SCI.

In one embodiment, the second signaling comprises one or multiple fields in an SCI.

In one embodiment, the second signaling comprises one or multiple fields in an IE.

In one embodiment, the second signaling is a downlink grant signaling.

In one embodiment, the second signaling is transmitted on a downlink physical-layer control channel (i.e., a downlink channel only capable of bearing a physical-layer signaling).

In one embodiment, the second signaling is DCI format 1_0, and for the specific meaning of the DCI format 10, refer to section 7.3.1.2 in 3GPP TS38.212.

In one embodiment, the second signaling is DCI format 1_1, and for the specific meaning of the DCI format 11, refer to section 7.3.1.2 in 3GPP TS38.212.

In one embodiment, the second signaling is DCI format 1_2, and for the specific meaning of the DCI format 10, refer to section 7.3.1.2 in 3GPP TS38.212.

In one embodiment, the second signaling is a signaling used to schedule a downlink physical-layer data channel.

In one embodiment, the phrase of the first signal carrying a first bit block comprises: the first signal comprises an output acquired after all or partial bits in the first bit block sequentially through part or all of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, when the target radio resource block is a former of the first radio resource block and the fourth radio resource block, the first signal carries the third bit block.

In one embodiment, when the first signal carries the third bit block: the first signal comprises an output acquired after all or partial bits in the third bit block sequentially through part or all of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, when the first signal carries the third bit block: the first signal comprises an output acquired after all or partial bits in the first bit block and the third bit block sequentially through part or all of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, the first radio resource block comprises a positive integer number of Resource Element(s) (RE(s)) in time frequency domain.

In one embodiment, the RE occupies a multicarrier symbol in time domain, and occupies a subcarrier in frequency domain.

In one embodiment, the multicarrier symbol in the present application is an Orthogonal Frequency Division Multiplexing (OFDM) symbol.

In one embodiment, the multicarrier symbol in the present application is a Single Carrier-Frequency Division Multiple Access (SC-FDMA) symbol.

In one embodiment, the multicarrier symbol in the present application is a Discrete Fourier Transform Spread OFDM (DFT-S-OFDM) symbol.

In one embodiment, the first radio resource block comprises a positive integer number of subcarrier(s) in frequency domain.

In one embodiment, the first radio resource block comprises a positive integer number of Physical resource block(s) (PRB(s)) in frequency domain.

In one embodiment, the first radio resource block comprises a positive integer number of Resource Block(s) (RB(s)) in frequency domain.

In one embodiment, the first radio resource block comprises a positive integer number of multicarrier symbol(s) in time domain.

In one embodiment, the first radio resource block comprises a positive integer number of slot(s) in time domain.

In one embodiment, the first radio resource block comprises a positive integer number of sub-slot(s) in time domain.

In one embodiment, the first radio resource block comprises a positive integer number of ms(s) in time domain.

In one embodiment, the first radio resource block comprises a positive integer number of continuous multicarrier symbol(s) in time domain.

In one embodiment, the first radio resource block comprises a positive integer number of discontinuous slot(s) in time domain.

In one embodiment, the first radio resource block comprises a positive integer number of continuous slot(s) in time domain.

In one embodiment, the first radio resource block comprises a positive integer number of sub-frame(s) in time domain.

In one embodiment, the first radio resource block is configured by a physical-layer signaling.

In one embodiment, the first radio resource block is configured by a higher-layer signaling.

In one embodiment, the first radio resource is configured by a Radio Resource Control (RRC) signaling.

In one embodiment, the first radio resource block is configured by a Medium Access Control layer Control Element (MAC CE) signaling.

In one embodiment, the first radio resource block is reserved for a physical-layer channel.

In one embodiment, the first radio resource block comprises radio resources reserved for a physical-layer channel.

In one embodiment, the first radio resource block comprises radio resources occupied by a physical-layer channel.

In one embodiment, the first radio resource block comprises time-frequency resources occupied by a physical-layer channel in time-frequency domain.

In one embodiment, the first radio resource block comprises time-frequency resources reserved for a physical-layer channel in time-frequency domain.

In one embodiment, the physical-layer channel in the present application comprises a Physical Uplink Control CHannel (PUCCH).

In one embodiment, the physical-layer channel in the present application comprises a Physical Uplink Shared CHannel (PUSCH).

In one embodiment, the physical-layer channel in the present application comprises an uplink physical-layer channel.

In one embodiment, the first radio resource block comprises a PUCCH resource.

In one embodiment, the first radio resource block comprises a PUCCH resource in a PUCCH resource set.

In one embodiment, the first signaling indicates the first radio resource block.

In one embodiment, the first signaling explicitly indicates the first radio resource block.

In one embodiment, the first signaling implicitly indicates the first radio resource block.

In one embodiment, the second signaling indicates the first radio resource block.

In one embodiment, the second signaling explicitly indicates the first radio resource block.

In one embodiment, the second signaling implicitly indicates the first radio resource block.

In one embodiment, the implicitly indicating in the present application comprises being implicitly indicated through a signaling format.

In one embodiment, the implicitly indicating in the present application comprises being implicitly indicated through a Radio Network Temporary Identity (RNTI).

In one embodiment, the second radio resource block comprises a positive integer number of RE(s) in time-frequency domain.

In one embodiment, the second radio resource block comprises a positive integer number of sub-carrier symbol(s) in frequency domain.

In one embodiment, the second radio resource block comprises a positive integer number of PRB(s) in frequency domain.

In one embodiment, the second radio resource block comprises a positive integer number of RB(s) in frequency domain.

In one embodiment, the second radio resource block comprises a positive integer number of multicarrier symbol(s) in time domain.

In one embodiment, the second radio resource block comprises a positive integer number of slot(s) in time domain.

In one embodiment, the second radio resource block comprises a positive integer number of sub-slot(s) in time domain.

In one embodiment, the second radio resource block comprises a positive integer number of ms(s) in time domain.

In one embodiment, the second radio resource block comprises a positive integer number of continuous multicarrier symbol(s) in time domain.

In one embodiment, the second radio resource block comprises a positive integer number of discontinuous slot(s) in time domain.

In one embodiment, the second radio resource block comprises a positive integer number of continuous slot(s) in time domain.

In one embodiment, the second radio resource block comprises a positive integer number of subframe(s) in time domain.

In one embodiment, the second radio resource block is configured by a physical-layer signaling.

In one embodiment, the second radio resource block is configured by a higher-layer signaling.

In one embodiment, the second radio resource block is configured by an RRC signaling.

In one embodiment, the second radio resource block is configured by a MAC CE signaling.

In one embodiment, the second radio resource block is reserved for a physical-layer channel.

In one embodiment, the second radio resource block comprises radio resources reserved for a physical-layer channel.

In one embodiment, the second radio resource block comprises radio resources occupied by a physical-layer channel.

In one embodiment, the second radio resource block comprises time-frequency resources occupied by a physical-layer channel in time-frequency domain.

In one embodiment, the second radio resource block comprises time-frequency resources reserved for a physical-layer channel in time-frequency domain.

In one embodiment, the second radio resource block comprises a PUCCH resource.

In one embodiment, the second radio resource block comprises a PUCCH resource in a PUCCH resource set.

In one embodiment, the second radio resource block comprises radio resources occupied by a PUSCH.

In one embodiment, the second radio resource block is reserved for a PUSCH transmission.

In one embodiment, the second radio resource block is reserved for a PUSCH transmission bearing the second bit block.

In one embodiment, the fourth radio resource block comprises a positive integer number of RE(s) in time-frequency domain.

In one embodiment, the fourth radio resource block comprises a positive integer number of sub-carrier symbol(s) in frequency domain.

In one embodiment, the fourth radio resource block comprises a positive integer number of PRB(s) in frequency domain.

In one embodiment, the fourth radio resource block comprises a positive integer number of RB(s) in frequency domain.

In one embodiment, the fourth radio resource block comprises a positive integer number of multicarrier symbol(s) in time domain.

In one embodiment, the fourth radio resource block comprises a positive integer number of slot(s) in time domain.

In one embodiment, the fourth radio resource block comprises a positive integer number of sub-slot(s) in time domain.

In one embodiment, the fourth radio resource block comprises a positive integer number of ms(s) in time domain.

In one embodiment, the fourth radio resource block comprises a positive integer number of continuous multicarrier symbol(s) in time domain.

In one embodiment, the fourth radio resource block comprises a positive integer number of discontinuous slot(s) in time domain.

In one embodiment, the fourth radio resource block comprises a positive integer number of continuous slot(s) in time domain.

In one embodiment, the fourth radio resource block comprises a positive integer number of subframe(s) in time domain.

In one embodiment, the fourth radio resource block is configured by a physical-layer signaling.

In one embodiment, the fourth radio resource block is configured by a higher-layer signaling.

In one embodiment, the fourth radio resource block is configured by an RRC signaling.

In one embodiment, the fourth radio resource block is configured by a MAC CE signaling.

In one embodiment, the fourth radio resource block is reserved for a physical-layer channel.

In one embodiment, the fourth radio resource block comprises radio resources reserved for a physical-layer channel.

In one embodiment, the fourth radio resource block comprises radio resources occupied by a physical-layer channel.

In one embodiment, the fourth radio resource block comprises time-frequency resources occupied by a physical-layer channel in time-frequency domain.

In one embodiment, the fourth radio resource block comprises time-frequency resources reserved for a physical-layer channel in time-frequency domain.

In one embodiment, the fourth radio resource block comprises a PUCCH resource.

In one embodiment, the fourth radio resource block comprises a PUCCH resource in a PUCCH resource set.

In one embodiment, the first signaling indicates the fourth radio resource block.

In one embodiment, the first signaling explicitly indicates the fourth radio resource block.

In one embodiment, the first signaling implicitly indicates the fourth radio resource block.

In one embodiment, the second signaling indicates the fourth radio resource block.

In one embodiment, the second signaling explicitly indicates the fourth radio resource block.

In one embodiment, the second signaling implicitly indicates the fourth radio resource block.

In one embodiment, the first bit block comprises a first-type HARQ-ACK.

In one embodiment, the first bit block comprises a positive integer number of bit(s).

In one embodiment, the first bit block comprises a positive integer number of ACK(s) or NACK(s).

In one embodiment, the first bit block comprises a positive integer number of first-type HARQ-ACK information bit(s).

In one embodiment, the first bit block comprises a HARQ-ACK codebook.

In one embodiment, all HARQ-ACKs comprised in the first bit block are the first-type HARQ-ACKs.

In one embodiment, the first-type HARQ-ACK comprises a HARQ-ACK corresponding to a QoS in multiple Quality of Service (QoS) types.

In one embodiment, the first-type HARQ-ACK comprises a HARQ-ACK corresponding to a URLLC service type.

In one embodiment, the first-type HARQ-ACK comprises a HARQ-ACK corresponding to an eMBB service type.

In one embodiment, the first-type HARQ-ACK comprises a high-priority HARQ-ACK.

In one embodiment, the first-type HARQ-ACK comprises a low-priority HARQ-ACK.

In one embodiment, the first-type HARQ-ACK comprises HARQ-ACK corresponding to priority index 1.

In one embodiment, the first-type HARQ-ACK comprises a HARQ-ACK corresponding to priority index 0.

In one embodiment, the first bit block comprises a UCI.

In one embodiment, the first bit block comprises a UCI corresponding to priority index 1.

In one embodiment, the first bit block comprises a UCI corresponding to priority index 0.

In one embodiment, the first bit block comprises a high-priority UCI.

In one embodiment, the first bit block comprises a low-priority UCI.

In one embodiment, the first bit block comprises a first-type UCI.

In one embodiment, the first bit block comprises a Scheduling Request (SR).

In one embodiment, the first bit block comprises an SR corresponding to priority index 1.

In one embodiment, the first bit block comprises an SR corresponding to priority index 0.

In one embodiment, the first bit block comprises a high-priority SR.

In one embodiment, the first bit block comprises a low-priority SR.

In one embodiment, the first bit block comprises a Channel State Information (CSI) reporting.

In one embodiment, the first-type HARQ-ACK comprises sidelink HARQ-ACK (SL HARQ-ACK).

In one embodiment, the first bit block comprises indication information of whether the first signaling is correctly received, or, the first bit block comprises indication information of whether a bit block scheduled by the first signaling is correctly received.

In one embodiment, the first-type HARQ-ACK comprised in the first bit block comprises a HARQ-ACK indicating whether the first signaling is correctly received, or, the first-type HARQ-ACK comprised in the first bit block comprises a HARQ-ACK indicating whether a bit block scheduled by the first signaling is correctly received.

In one embodiment, the first signaling comprises scheduling information of the bit block scheduled by the first signaling.

In one embodiment, the scheduling information in the present application comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a periodicity, a transmission antenna port, or a corresponding Transmission Configuration Indicator (TCI) state.

In one embodiment, the bit block scheduled by the first signaling comprises a positive integer number of bit(s).

In one embodiment, the bit block scheduled by the first signaling comprises a Transport Block (TB).

In one embodiment, the bit block scheduled by the first signaling comprises a Code Block (CB).

In one embodiment, the bit block scheduled by the first signaling comprises a Code Block Group (CBG).

In one embodiment, a sixth bit block comprises indication information of whether the first signaling is correctly received, or, a sixth bit block comprises indication information of whether a bit block scheduled by the first signaling is correctly received; the sixth bit block is used to generate the first bit block.

In one embodiment, a sixth bit block is used to generate the first bit block.

In one embodiment, the sixth bit block comprises a first-type HARQ-ACK.

In one embodiment, the sixth bit block comprises a positive integer number of bit(s).

In one embodiment, the sixth bit block comprises a positive integer number of ACK(s) or NACK(s).

In one embodiment, the sixth bit block comprises a positive integer number of the first-type HARQ-ACK information bit(s).

In one embodiment, the sixth bit block comprises a HARQ-ACK codebook.

In one embodiment, all HARQ-ACKs comprised in the sixth bit block are the first-type HARQ-ACKs.

In one embodiment, the sixth bit block comprises a UCI.

In one embodiment, the sixth bit block comprises a UCI corresponding to priority index 1.

In one embodiment, the sixth bit block comprises a UCI corresponding to priority index 0.

In one embodiment, the sixth bit block comprises a high-priority UCI.

In one embodiment, the sixth bit block comprises a low-priority UCI.

In one embodiment, the sixth bit block comprises a first-type UCI.

In one embodiment, the sixth bit block comprises an SR.

In one embodiment, the sixth bit block comprises an SR corresponding to priority index 1.

In one embodiment, the sixth bit block comprises an SR corresponding to priority index 0.

In one embodiment, the sixth bit block comprises a high-priority SR.

In one embodiment, the sixth bit block comprises a low-priority SR.

In one embodiment, the sixth bit block comprises a CSI reporting.

In one embodiment, the meaning of the phrase of a sixth bit block being used to generate the first bit block comprises: the first bit block is the sixth bit block.

In one embodiment, the meaning of the phrase of a sixth bit block being used to generate the first bit block comprises: the first bit block comprises all or partial bits in the sixth bit block.

In one embodiment, the meaning of the phrase of a sixth bit block being used to generate the first bit block comprises: the first bit block comprises an output acquired after all or partial bits in the sixth bit block sequentially through one or more operations of logic and, logical or, xor, deleting bit or zero-padding.

In one embodiment, the meaning of the phrase of a sixth bit block being used to generate the first bit block comprises: the first bit block comprises an output acquired after partial or all of bits in the sixth bit block sequentially through one or more of operations of logic and, logical or, xor, deleting bit, precoding, adding repeat bit or zero-padding.

In one embodiment, the third bit block comprises a second-type HARQ-ACK.

In one embodiment, the third bit block comprises a positive integer number of bit(s).

In one embodiment, the third bit block comprises a positive integer number of ACK(s) or NACK(s).

In one embodiment, the third bit block comprises a positive integer number of the second-type HARQ-ACK information bit(s).

In one embodiment, the third bit block comprises a HARQ-ACK codebook.

In one embodiment, all HARQ-ACKs comprised in the third bit block are the second-type HARQ-ACKs.

In one embodiment, the second-type HARQ-ACK comprises a HARQ-ACK corresponding to a QoS in multiple QoS types.

In one embodiment, the second-type HARQ-ACK comprises a HARQ-ACK corresponding to a URLLC service type.

In one embodiment, the second-type HARQ-ACK comprises a HARQ-ACK corresponding to an eMBB service type.

In one embodiment, the second-type HARQ-ACK comprises a high-priority HARQ-ACK.

In one embodiment, the second-type HARQ-ACK comprises a low-priority HARQ-ACK.

In one embodiment, the second-type HARQ-ACK comprises a HARQ-ACK corresponding to priority index 1.

In one embodiment, the second-type HARQ-ACK comprises a HARQ-ACK corresponding to priority index 0.

In one embodiment, the third bit block comprises a UCI.

In one embodiment, the third bit block comprises a UCI corresponding to priority index 1.

In one embodiment, the third bit block comprises a UCI corresponding to priority index 0.

In one embodiment, the third bit block comprises a high-priority UCI.

In one embodiment, the third bit block comprises a low-priority UCI.

In one embodiment, the third bit block comprises a second-type UCI.

In one embodiment, the first-type UCI and the second-type UCI are respectively different types of UCIs.

In one embodiment, the third bit block comprises an SR.

In one embodiment, the third bit block comprises an SR corresponding to priority index 1.

In one embodiment, the third bit block comprises an SR corresponding to priority index 0.

In one embodiment, the third bit block comprises a high-priority SR.

In one embodiment, the third bit block comprises a low-priority SR.

In one embodiment, the third bit block comprises a CSI reporting.

In one embodiment, the third bit block corresponds to priority index 0, and the first bit block corresponds to priority index 1.

In one embodiment, the third bit block corresponds to priority index 1, and the first bit block corresponds to priority index 0.

In one embodiment, the second-type HARQ-ACK comprises a sidelink HARQ-ACK (SL HARQ-ACK).

In one embodiment, the second-type HARQ-ACK and the first-type HARQ-ACK are respectively HARQ-ACKs for different links.

In one embodiment, the different links comprise an uplink and a sidelink.

In one embodiment, the second-type HARQ-ACK and the first-type HARQ-ACK are respectively different types of HARQ-ACKs.

In one embodiment, the second-type HARQ-ACK and the first-type HARQ-ACK are respectively HARQ-ACKs with different priorities.

In one embodiment, the second-type HARQ-ACK and the first-type HARQ-ACK are respectively HARQ-ACKs corresponding to different priority indexes.

In one embodiment, the second-type HARQ-ACK comprises a HARQ-ACK corresponding to priority index 1, and the first-type HARQ-ACK comprises a HARQ-ACK corresponding to priority index 0.

In one embodiment, the second-type HARQ-ACK comprises a HARQ-ACK corresponding to priority index 0, and the first-type HARQ-ACK comprises HARQ-ACK corresponding to priority index 1.

In one embodiment, a type of a HARQ-ACK comprised in the third bit block is different from a type of a HARQ-ACK comprised in the first bit block.

In one embodiment, the third bit block comprises indication information of whether the second signaling is correctly received, or, the third bit block comprises indication information of whether a bit block scheduled by the second signaling is correctly received.

In one embodiment, the second-type HARQ-ACK comprised in the third bit block comprises a HARQ-ACK indicating whether the second signaling is correctly received, or, the second-type HARQ-ACK comprised in the third bit block comprises a HARQ-ACK indicating whether a bit block scheduled by the second signaling is correctly received.

In one embodiment, the second signaling comprises scheduling information of the bit block scheduled by the second signaling

In one embodiment, the bit block scheduled by the second signaling comprises a positive integer number of bit(s).

In one embodiment, the bit block scheduled by the second signaling comprises a TB.

In one embodiment, the bit block scheduled by the second signaling comprises a CB.

In one embodiment, the bit block scheduled by the second signaling comprises a CBG.

In one embodiment, a seventh bit block comprises indication information of whether the second signaling is correctly received, or, a seventh bit block comprises indication information of whether a bit block scheduled by the second signaling is correctly received; the seventh bit block is used to generate the third bit block.

In one embodiment, a seventh bit block is used to generate the third bit block.

In one embodiment, the seventh bit block comprises a second-type HARQ-ACK.

In one embodiment, the seventh bit block comprises a positive integer number of bit(s).

In one embodiment, the seventh bit block comprises a positive integer number of ACK(s) or NACK(s).

In one embodiment, the seventh bit block comprises a positive integer number of the second-type HARQ-ACK information bit(s).

In one embodiment, the seventh bit block comprises a HARQ-ACK codebook.

In one embodiment, all HARQ-ACKs comprised in the seventh bit block are the second-type HARQ-ACKs.

In one embodiment, the seventh bit block comprises a UCI.

In one embodiment, the seventh bit block comprises a UCI corresponding to priority index 1.

In one embodiment, the seventh bit block comprises a UCI corresponding to priority index 0.

In one embodiment, the seventh bit block comprises a high-priority UCI.

In one embodiment, the seventh bit block comprises a low-priority UCI.

In one embodiment, the seventh bit block comprises a second-type UCI.

In one embodiment, the first-type UCI and the second-type UCI are respectively UCIs of different priorities.

In one embodiment, the first-type UCI and the second-type UCI are UCIs corresponding to different priority indexes.

In one embodiment, the first-type UCI correspond to priority index 1, and the second-type UCI correspond to priority index 0.

In one embodiment, the first-type UCI correspond to priority index 0, and the second-type UCI correspond to priority index 1.

In one embodiment, the first-type UCI and the second UCI are respectively UCIs for different links.

In one embodiment, the seventh bit block comprises an SR.

In one embodiment, the seventh bit block comprises an SR corresponding to priority index 1.

In one embodiment, the seventh bit block comprises an SR corresponding to priority index 0.

In one embodiment, the seventh bit block comprises a high-priority SR.

In one embodiment, the seventh bit block comprises a low-priority SR.

In one embodiment, the seventh bit block comprises a CSI reporting.

In one embodiment, a type of a UCI comprised in the first bit block is the same as a type of a UCI comprised in the sixth bit block.

In one embodiment, a type of a HARQ-ACK comprised in the first bit block is the same as a type of a HARQ-ACK comprised in the sixth bit block.

In one embodiment, a type of a UCI comprised in the third bit block is the same as a type of UCI comprised in the seventh bit block.

In one embodiment, a type of a HARQ-ACK comprised in the third bit block is the same as a type of a HARQ-ACK comprised in the seventh bit block.

In one embodiment, a type of a UCI comprised in the first bit block is the same as a type of UCI comprised in the sixth bit block.

In one embodiment, a type of a HARQ-ACK comprised in the first bit block is the same as a type of a HARQ-ACK comprised in the sixth bit block.

In one embodiment, a type of a UCI comprised in the third bit block is different from a type of a UCI comprised in the first bit block.

In one embodiment, a type of a HARQ-ACK comprised in the third bit block is different from a type of a HARQ-ACK comprised in the first bit block.

In one embodiment, the meaning of the phrase of a seventh bit block being used to generate the third bit block comprises: the third bit block is the seventh bit block.

In one embodiment, the meaning of the phrase of a seventh bit block being used to generate the third bit block comprises: the third bit block comprises all or partial bits in the seventh bit block.

In one embodiment, the meaning of the phrase of a seventh bit block being used to generate the third bit block comprises: the third bit block comprises an output acquired after partial or all bits in the seventh bit block sequentially through one or more operations of logic and, logical or, xor, deleting bit or zero-padding.

In one embodiment, the meaning of the phrase of a seventh bit block being used to generate the third bit block comprises: the third bit block comprises an output acquired after partial or all bits in the seventh bit block sequentially through one or more operations of logic and, logical or, xor, deleting bit, precoding, adding repeat bit or zero-padding.

In one embodiment, when the target radio resource block is a latter of the first radio resource block and the fourth radio resource block, the first signal carries a bit block generated by the seventh bit block.

In one embodiment, when the target radio resource block is a latter of the first radio resource block and the fourth radio resource block, the first signal carries only the first bit block in the first bit block and the third bit block.

In one embodiment, when the target radio resource block is a latter of the first radio resource block and the fourth radio resource block, the first signal does not carry the second-type HARQ-ACK.

In one embodiment, a number of bit(s) comprised in the seventh bit block is greater than a seventh threshold.

In one embodiment, only when a number of bit(s) comprised in the seventh bit block is greater than a seventh threshold, the priority of the second bit block is used to determine the target radio resource block from the first radio resource block and the fourth radio resource block.

In one subembodiment of the above embodiment, when the number of bit(s) comprised in the seventh bit block is not greater than the seventh threshold, the target radio resource block is the fourth radio resource block.

In one embodiment, only when a number of bit(s) comprised in the seventh bit block is not less than a seventh threshold, the priority of the second bit block is used to determine the target radio resource block from the first radio resource block and the fourth radio resource block.

In one subembodiment of the above embodiment, when the number of bit(s) comprised in the seventh bit block is less than the seventh threshold, the target radio resource block is the fourth radio resource block.

In one embodiment, the seventh threshold is greater than 0.

In one embodiment, the seventh threshold is configured by a higher-layer signaling.

In one embodiment, the seventh threshold is configured by an RRC signaling.

In one embodiment, the seventh threshold is configured by a MAC CE signaling.

In one embodiment, the seventh threshold is pre-defined.

In one embodiment, only when a number of bit(s) comprised in the seventh bit block is less than an eighth threshold, the priority of the second bit block is used to determine the target radio resource block from the first radio resource block and the fourth radio resource block.

In one subembodiment of the above embodiment, when the number of bit(s) comprised in the seventh bit block is not less than the eighth threshold, the target radio resource block is the first radio resource block.

In one embodiment, only when a number of bit(s) comprised in the seventh bit block is not greater than an eighth threshold, the priority of the second bit block is used to determine the target radio resource block from the first radio resource block and the fourth radio resource block.

In one subembodiment of the above embodiment, when the number of bit(s) comprised in the seventh bit block is greater than the eighth threshold, the target radio resource block is the first radio resource block.

In one embodiment, the eighth threshold is greater than 0.

In one embodiment, the eighth threshold is configured by a higher-layer signaling.

In one embodiment, the eighth threshold is configured by an RRC signaling.

In one embodiment, the eighth threshold is configured by a MAC CE signaling.

In one embodiment, the eighth threshold is pre-defined.

In one embodiment, the phrase of being overlapping in time domain in the present application comprises: being overlapping in time domain, and being overlapping in frequency domain.

In one embodiment, the phrase of being overlapping in time domain in the present application comprises: being overlapping in time domain, and being overlapping in frequency domain and being orthogonal in frequency domain.

In one embodiment, the first number is equal to a number of bit(s) comprised in the first bit block.

In one embodiment, the first number is greater than a number of bit(s) comprised in the first bit block, and the first number is less than a sum of a number of bit(s) comprised in the first bit block and a number of bit(s) comprised in the third bit block.

In one embodiment, the phrase of being orthogonal in the present application comprises: being non-overlapping.

In one embodiment, the first signaling indicates priority index 0, and the second signaling indicates priority index 1.

In one embodiment, the first signaling indicates priority index 1, and the second signaling indicates priority index 0.

In one embodiment, the first signaling comprises a field indicating priority.

In one embodiment, the second signaling comprises a field indicating priority.

In one embodiment, the field indicating priority is a Priority indicator field.

In one embodiment, the field indicating priority is used to indicate a priority index.

In one embodiment, the field indicating priority comprises one bit.

In one embodiment, the field indicating priority comprises two bits.

In one embodiment, the field indicating priority comprises three bit.

In one embodiment, the field indicating priority comprises multiple bits.

In one embodiment, a signaling format of the first signaling is used to indicate a priority index.

In one embodiment, a signaling format of the second signaling is used to indicate a priority index.

In one embodiment, a priority of the first bit block is different form a priority of the third bit block.

In one embodiment, a priority of the first bit block is greater than the third bit block.

In one embodiment, when the target radio resource block is the first radio resource block, a number of bit(s) related to the first bit block or a third bit block and transmitted in the first radio resource block is an eighth number; when the target radio resource is the fourth radio resource block, a number of bit(s) related to the first bit block or a third bit block and transmitted in the fourth radio resource block is a ninth number; the eighth number is greater than the ninth number.

In one subembodiment of the above embodiment, the eighth number is equal to a sum of the number of bit(s) comprised in the first bit block and the number of bit(s) comprised in the third bit block.

In one subembodiment of the above embodiment, the ninth number is equal to the first number.

In one embodiment, the meaning of the phrase of a first number being used to determine a fourth radio resource block comprises: the first number is used to determine the fourth radio resource block.

In one embodiment, the meaning of the phrase of a first number being used to determine a fourth radio resource block comprises: only when the target radio resource block is a latter of the first radio resource block and the fourth radio resource block, the first number is used to determine the fourth radio resource block.

In one embodiment, the meaning of the phrase of a first number being used to determine a fourth radio resource block comprises: only when a priority of the second bit block is the first priority, the first number is used to determine the fourth radio resource block.

In one embodiment, the meaning of the phrase of a first number being used to determine a fourth radio resource block comprises: when the target radio resource block is a latter of the first radio resource block and the fourth radio resource block, the first number is used to determine the fourth radio resource block.

In one embodiment, the meaning of the phrase of a first number being used to determine a fourth radio resource block comprises: when a priority of the second bit block is the first priority, the first number is used to determine the fourth radio resource block.

In one embodiment, the phrase of being used for in the present application comprises: being used by the first node in the present application for.

In one embodiment, the phrase of being used for in the present application comprises: being used by the second node in the present application for.

In one embodiment, the phrase of being used for in the present application comprises: being used by a transmitting end of the first signal for.

In one embodiment, the phrase of being used for in the present application comprises: being used by a receiving end of the first signal for.

In one embodiment, the meaning of the phrase of a number of bit(s) comprised in the first bit block and a number of bit(s) comprised in the third bit block being used to determine a first radio resource block comprises: a sum of the number of bit(s) comprised in the first bit block and the number of bit(s) comprised in the third bit block is used to determine the first radio resource block.

In one embodiment, a signaling different from the first signaling and the second signaling is used to determine the second bit block.

In one embodiment, a signaling different from the first signaling and the second signaling is used for an MCS of the second bit block.

In one embodiment, a signaling different from the first signaling and the second signaling is used to determine the second radio resource block.

In one embodiment, a signaling different from the first signaling and the second signaling indicates the second radio resource block.

In one embodiment, a signaling different from the first signaling and the second signaling indicates time-domain resources occupied by the second radio resource block.

In one embodiment, a signaling different from the first signaling and the second signaling indicates frequency-domain resources occupied by the second radio resource block.

In one embodiment, a signaling different from the first signaling and the second signaling indicates time-frequency resources occupied by the second radio resource block.

In one embodiment, the signaling different from the first signaling and the second signaling is dynamically configured.

In one embodiment, the signaling different from the first signaling and the second signaling comprises a layer-1 signaling.

In one embodiment, the signaling different from the first signaling and the second signaling comprises a layer-1 control signaling.

In one embodiment, the signaling different from the first signaling and the second signaling comprises a physical-layer signaling.

In one embodiment, the signaling different from the first signaling and the second signaling comprises one or multiple fields in a physical-layer signaling.

In one embodiment, the signaling different from the first signaling and the second signaling comprises a higher-layer signaling.

In one embodiment, the signaling different from the first signaling and the second signaling comprises one or multiple fields in a higher-layer signaling.

In one embodiment, the signaling different from the first signaling and the second signaling comprises an RRC signaling.

In one embodiment, the signaling different from the first signaling and the second signaling comprises a MAC CE signaling.

In one embodiment, the signaling different from the first signaling and the second signaling comprises one or multiple fields in an RRC signaling.

In one embodiment, the signaling different from the first signaling and the second signaling comprises one or multiple fields in a MAC CE signaling.

In one embodiment, the signaling different from the first signaling and the second signaling comprises a DCI.

In one embodiment, the signaling different from the first signaling and the second signaling comprises one or multiple fields in a DCI.

In one embodiment, the signaling different from the first signaling and the second signaling comprises an SCI.

In one embodiment, the signaling different from the first signaling and the second signaling comprises one or multiple fields in an SCI.

In one embodiment, the signaling different from the first signaling and the second signaling comprises one or multiple fields in an IE.

In one embodiment, the signaling different from the first signaling and the second signaling is an uplink grant signaling.

In one embodiment, the signaling different from the first signaling and the second signaling is a downlink grant signaling.

In one embodiment, the signaling different from the first signaling and the second signaling is transmitted on a downlink physical-layer control channel (i.e., a downlink channel only capable of bearing a physical-layer signaling).

In one embodiment, the signaling different from the first signaling and the second signaling is DCI format 0_0, and for the specific meaning of the DCI format 0_0, refer to section 7.3.1.1 in 3GPP TS38.212.

In one embodiment, the signaling different from the first signaling and the second signaling is DCI format 0_1, and for the specific meaning of the DCI format 0_1, refer to section 7.3.1.1 in 3GPP TS38.212.

In one embodiment, the signaling different from the first signaling and the second signaling is DCI format 0_2, and for the specific meaning of the DCI format 0_2, refer to section 7.3.1.1 in 3GPP TS38.212.

In one embodiment, the signaling different from the first signaling and the second signaling is a signaling used to schedule an uplink physical-layer data channel.

### Embodiment 1B

Embodiment 1B illustrates a flowchart of the processing of a first node according to one embodiment of the present application, as shown in FIG. 1.

In Embodiment 1B, the first node in the present application receives a first signaling in step 101B; transmits a first signal in a target radio resource block in step 102B.

In embodiment 1B, the first signal carries a bit block generated by a first bit block; the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one embodiment, the first signal comprises a radio signal.

In one embodiment, the first signal comprises a radio-frequency signal.

In one embodiment, the first signal comprises a baseband signal.

In one embodiment, the first signaling is an RRC-layer signaling.

In one embodiment, the first signaling comprises one or multiple fields in an RRC layer signaling.

In one embodiment, the first signaling is dynamically configured.

In one embodiment, the first signaling is a physical-layer signaling.

In one embodiment, the first signaling comprises one or multiple fields in a physical-layer signaling.

In one embodiment, the first signaling is a higher-layer signaling.

In one embodiment, the first signaling comprises one or multiple fields in a higher-layer signaling.

In one embodiment, the first signaling is a Downlink Control Information (DCI) signaling

In one embodiment, the first signaling comprises one or multiple fields in a piece of DCI.

In one embodiment, the first signaling comprises one or multiple fields in an Information Element (IE).

In one embodiment, the first signaling is a DownLink Grant Signalling.

In one embodiment, the first signaling is an UpLink Grant Signalling.

In one embodiment, the first signaling is transmitted on a downlink physical-layer control channel (i.e., a downlink channel only capable of bearing a physical-layer signaling).

In one embodiment, the downlink physical-layer control channel in the present application is a Physical Downlink Control CHannel (PDCCH).

In one embodiment, the downlink physical-layer control channel in the present application is a short PDCCH (sPDCCH).

In one embodiment, the downlink physical-layer control channel in the present application is a Narrow Band PDCCH (NB-PDCCH).

In one embodiment, the first signaling is DCI format 1_0, and for the specific meaning of the DCI format 1_0, refer to section 7.3.1.2 in 3GPP TS38.212.

In one embodiment, the first signaling is DCI format 1_1, and for the specific meaning of the DCI format 1_1, refer to section 7.3.1.2 in 3GPP TS38.212.

In one embodiment, the first signaling is DCI format 1_2, and for the specific meaning of the DCI format 1_2, refer to section 7.3.1.2 in 3GPP TS38.212.

In one embodiment, the first signaling is a signaling used to schedule a downlink physical-layer data channel.

In one embodiment, the downlink physical-layer data channel in the present application is a Physical Downlink Shared CHannel (PDSCH).

In one embodiment, the downlink physical-layer data channel in the present application is a short PDSCH (sPDSCH).

In one embodiment, the downlink physical-layer data channel in the present application is a Narrow Band PDSCH (NB-PDSCH).

In one embodiment, the first signaling is DCI format 0_0, and for the specific meaning of the DCI format 0_0, refer to section 7.3.1.1 in 3GPP TS38.212.

In one embodiment, the first signaling is DCI format 0_1, and for the specific meaning of the DCI format 0_1, refer to section 7.3.1.1 in 3GPP TS38.212.

In one embodiment, the first signaling is DCI format 0_2, and for the specific meaning of the DCI format 0_2, refer to section 7.3.1.1 in 3GPP TS38.212.

In one embodiment, the first signaling is a signaling used to schedule an uplink physical layer data channel.

In one embodiment, the uplink physical-layer data channel in the present application is a Physical Uplink Shared Channel (PUSCH).

In one subembodiment, the uplink physical-layer data channel in the present application is a short PUSCH (sPUSCH).

In one embodiment, the uplink physical-layer data channel in the present application is a Narrow Band PUSCH (NB-PUSCH).

In one embodiment, any radio resource block in the first radio resource block group comprises a positive integer number of Resource Element(s) (RE(s)) in time-frequency domain.

In one embodiment, the second radio resource block comprises a positive integer number of RE(s) in time-frequency domain.

In one embodiment, the RE occupies a multicarrier symbol in time domain, and occupies a subcarrier in frequency domain.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, any radio resource block in the first radio resource block group comprises a positive integer number of subcarrier(s) in frequency domain.

In one embodiment, any radio resource block in the first radio resource block group comprises a positive integer number of PRB(s) in frequency domain.

In one embodiment, any radio resource block in the first radio resource block group comprises a positive integer number of RB(s) in frequency domain.

In one embodiment, any radio resource block in the first radio resource block group comprises a positive integer number of multicarrier symbol(s) in time domain.

In one embodiment, any radio resource block in the first radio resource block group comprises a positive integer number of slot(s) in time domain.

In one embodiment, any radio resource block in the first radio resource block group comprises a positive integer number of sub-slot(s) in time domain.

In one embodiment, any radio resource block in the first radio resource block group comprises a positive integer number of ms(s) in time domain.

In one embodiment, any radio resource block in the first radio resource block group comprises a positive integer number of discontinuous slot(s) in time domain.

In one embodiment, any radio resource block in the first radio resource block group comprises a positive integer number of continuous slot(s) in time domain.

In one embodiment, any radio resource block in the first radio resource block group comprises a positive integer number of sub-frame(s) in time domain.

In one embodiment, any radio resource block in the first radio resource block group is configured by a higher-layer signaling.

In one embodiment, any radio resource block in the first radio resource block group is configured by an RRC signaling.

In one embodiment, any radio resource block in the first radio resource block group is configured by a Medium Access Control layer Control Element (MAC CE) signaling.

In one embodiment, any radio resource block in the first radio resource block group is reserved for a physical-layer channel.

In one embodiment, any radio resource block in the first radio resource block group comprises radio resources reserved for a physical-layer channel.

In one embodiment, any radio resource block in the first radio resource block group comprises radio resources occupied by a physical-layer channel.

In one embodiment, any radio resource block in the first radio resource block group comprises time-frequency resources occupied by a physical-layer channel in time-frequency domain.

In one embodiment, any radio resource block in the first radio resource block group comprises time-frequency resources reserved for a physical-layer channel in time-frequency domain.

In one embodiment, the physical-layer channel in the present application comprises an sPUSCH.

In one embodiment, the physical-layer channel in the present application comprises an NB-PUSCH.

In one embodiment, the physical-layer channel in the present application comprises a PUCCH.

In one embodiment, the physical-layer channel in the present application comprises a PUSCH.

In one embodiment, the physical-layer channel in the present application comprises a PUCCH or a PUSCH.

In one embodiment, the physical-layer channel in the present application comprises an uplink physical-layer channel.

In one embodiment, the physical-layer channel in the present application is a PUCCH or a PUSCH.

In one embodiment, the first radio resource block comprises a PUCCH resource.

In one embodiment, any radio resource block in the first radio resource block group comprises one transmission in multiple repetitions reserved for a PUCCH.

In one embodiment, the second radio resource block comprises a positive integer number of sub-carrier symbol(s) in frequency domain.

In one embodiment, the second radio resource block comprises a positive integer number of PRB(s) in frequency domain.

In one embodiment, the second radio resource block comprises a positive integer number of RB(s) in frequency domain.

In one embodiment, the second radio resource block comprises a positive integer number of multicarrier symbol(s) in time domain.

In one embodiment, the second radio resource block comprises a positive integer number of slot(s) in time domain.

In one embodiment, the second radio resource block comprises a positive integer number of sub-slot(s) in time domain.

In one embodiment, the second radio resource block comprises a positive integer number of ms(s) in time domain.

In one embodiment, the second radio resource block comprises a positive integer number of discontinuous slot(s) in time domain.

In one embodiment, the second radio resource block comprises a positive integer number of continuous slot(s) in time domain.

In one embodiment, the second radio resource block comprises a positive integer number of subframe(s) in time domain.

In one embodiment, the second radio resource block is configured by a higher-layer signaling.

In one embodiment, the second radio resource block is configured by an RRC signaling.

In one embodiment, the second radio resource block is configured by a MAC CE signaling.

In one embodiment, the second radio resource block is reserved for a physical-layer channel.

In one embodiment, the second radio resource block comprises radio resources reserved for a physical-layer channel.

In one embodiment, the second radio resource block comprises radio resources occupied by a physical-layer channel.

In one embodiment, the second radio resource block comprises time-frequency resources occupied by a physical-layer channel in time-frequency domain.

In one embodiment, the second radio resource block comprises time-frequency resources reserved for a physical-layer channel in time-frequency domain.

In one embodiment, the second radio resource block comprises a PUCCH resource.

In one embodiment, the first radio resource block group only comprises on radio resource block.

In one embodiment, the first radio resource block group comprises multiple radio resource blocks.

In one embodiment, the first radio resource block group comprises multiple radio resource blocks; and any two radio resource blocks in the first radio resource block group are non-overlapping in time domain.

In one embodiment, the phrase of each radio resource block in the first radio resource block group corresponding to a priority in a first priority set comprises: the first radio resource block group comprises K radio resource blocks; K signalings are respectively used to determine the K radio resource blocks; the K signalings respectively (explicitly or implicitly) indicate a priority in the first priority set; a priority corresponding to an i-th radio resource block in the K radio resource blocks is a priority in the first priority set indicated by an i-th signaling in the K signalings; K is a positive integer, i is a positive integer.

In one subembodiment of the above embodiment, the i-th signaling in the K signalings indicates the i-th radio resource block in the K radio resource blocks.

In one subembodiment of the above embodiment, the i-th signaling in the K signalings is used to determine radio resources occupied by the i-th radio resource block in the K radio resource blocks.

In one subembodiment of the above embodiment, the i-th signaling in the K signalings comprises configuration information of an uplink transmission based on configured grant; the i-th radio resource block in the K radio resource blocks is radio resources occupied by the uplink transmission based on configured grant within a period.

In one subembodiment of the above embodiment, the i-th radio resource block in the K radio resource blocks is radio resources of a periodic uplink transmission within a period reserved to be configured by the i-th signaling in the K signalings.

In one subembodiment of the above embodiment, the i-th signaling in the K signalings indicates the i-th radio resource block in the K radio resource blocks from a radio resource block set.

In one subembodiment of the above embodiment, K is equal to 1, and i is equal to 1.

In one subembodiment of the above embodiment, K is equal to 2, and i is equal to 1.

In one subembodiment of the above embodiment, K is equal to 2, and i is equal to 2.

In one subembodiment of the above embodiment, i is equal to any positive integer not greater than K.

In one embodiment, one of the K signalings is a physical-layer signaling or a higher-layer signaling.

In one embodiment, one of the K signalings is an RRC-layer signaling.

In one embodiment, one of the K signalings comprises one or multiple fields in an RRC-layer signaling.

In one embodiment, one of the K signalings comprises one or multiple fields in a physical-layer signaling.

In one embodiment, one of the K signalings comprises one or multiple fields in a higher-layer signaling.

In one embodiment, one of the K signalings is a DCI signaling.

In one embodiment, one of the K signalings comprises one or multiple fields in a DCI.

In one embodiment, one of the K signalings comprises one or multiple fields in an IE.

In one embodiment, one of the K signalings is dynamically configured.

In one embodiment, one of the K signalings is a downlink grant signaling.

In one embodiment, one of the K signalings is an uplink grant signaling.

In one embodiment, the K signalings do not comprise the first signaling.

In one embodiment, the first radio resource block group comprises K radio resource blocks; the K radio resource blocks are respectively reserved for transmitting K bit blocks; if one of the K bit blocks is transmitted; a transmitter of a signal carrying the bit block among the K bit blocks is a transmitter of the first signal; K is a positive integer.

In one embodiment, the first signaling indicates the second radio resource block.

In one embodiment, the first signaling explicitly indicates the second radio resource block.

In one embodiment, the first signaling implicitly indicates the second radio resource block.

In one embodiment, the first signaling indicates the second radio resource block from a radio resource block set.

In one embodiment, the radio resource block set comprises multiple PUCCH resources.

In one embodiment, the radio resource block set comprises a PUCCH resource set.

In one embodiment, the first signaling and a signaling other than the first signaling are used together to determine the second radio resource block.

In one embodiment, the second radio resource block and all radio resource blocks in the first radio resource block group are overlapping in frequency domain.

In one embodiment, the first radio resource block group comprises multiple radio resource blocks; the second radio resource block and partial radio resource blocks in the first radio resource block group are overlapping in frequency domain.

In one embodiment, the second radio resource block and all radio resource blocks in the first radio resource block group are not overlapping in frequency domain.

In one embodiment, the first radio resource block group comprises multiple radio resource blocks; different radio resource blocks in the first radio resource block group are respectively reserved for different bit blocks.

In one embodiment, the first radio resource block group comprises multiple radio resource blocks; partial or all radio resource blocks in the first radio resource block group are reserved for a same bit block.

In one embodiment, a radio resource block in the first radio resource block group is reserved for the first bit block.

In one embodiment, a radio resource block in the first radio resource block group is reserved for a bit block other than the first bit block.

In one embodiment, all radio resource blocks in the first radio resource block group are reserved for a bit block other than the first bit block.

In one embodiment, a radio resource block in the first radio resource block group is reserved for a bit block comprising a TB.

In one embodiment, a radio resource block in the first radio resource block group is reserved for a bit block comprising a CB.

In one embodiment, a radio resource block in the first radio resource block group is reserved for a bit block comprising a CBG.

In one embodiment, a radio resource block in the first radio resource block group is reserved for a bit block comprising UCI.

In one embodiment, a radio resource block in the first radio resource block group is reserved for a bit block comprising a HARQ-ACK.

In one embodiment, the first signaling is used to determine the first bit block.

In one embodiment, the first bit block comprises indication information of whether the first signaling is correctly received, or, the first bit block comprises indication information of whether a bit block scheduled by the first signaling is correctly received.

In one embodiment, the second radio resource block is reserved for the first bit block.

In one embodiment, the second radio resource block is reserved for a bit block generated by the first bit block.

In one embodiment, a bit block scheduled by the first signaling is a second bit block.

In one embodiment, the first signaling comprises scheduling information of a second bit block.

In one embodiment, the second bit block comprises a Transport Block (TB).

In one embodiment, the second bit block comprises a Code Block (CB).

In one embodiment, the second bit block comprises a Code Block Group (CBG).

In one embodiment, the first priority set comprises a PHY priority.

In one embodiment, the first priority set only comprises the first priority and the second priority.

In one embodiment, the first priority set also comprises a priority other than the first priority and the second priority.

In one embodiment, the first priority and the second priority are respectively different priorities.

In one embodiment, the first priority and the second priority are respectively different PHY priorities.

In one embodiment, the first priority is a high priority, and the second priority is a low priority.

In one embodiment, the first priority is a low priority, and the second priority is a high priority.

In one embodiment, a priority index of the first priority is equal to 1; a priority index of the second priority is equal to 0.

In one embodiment, a priority index of the first priority is equal to 0; a priority index of the second priority is equal to 1.

In one embodiment, the first priority is used to indicate URLLC services; the second priority is used to indicate eMBB services.

In one embodiment, the first priority is used to indicate eMBB services; the second priority is used to indicate URLLC services.

In one embodiment, a signaling scheduling a radio resource block in the first radio resource block group comprises a priority indicator field; the priority indicator field comprised in the signaling scheduling the radio resource block in the first radio resource block group indicates a priority index of the first priority or a priority index of the second priority.

In one embodiment, a signaling scheduling the second radio resource block group comprises a priority indicator field; the priority indicator field comprised in the signaling scheduling the second radio resource block group indicates a priority index of the first priority or a priority index of the second priority.

In one embodiment, a priority corresponding to the first bit block is the first priority or the second priority.

In one embodiment, a priority indicated by a signaling is used to determine a priority corresponding to the first bit block.

In one subembodiment of the above embodiment, the signaling comprises one or multiple fields in a DCI.

In one subembodiment of the above embodiment, the signaling comprises one or multiple fields in a Sidelink Control Information (SCI).

In one subembodiment of the above embodiment, the signaling comprises one or multiple fields in an RRC-layer signaling.

In one embodiment, the first signaling indicates a priority corresponding to the first bit block.

In one embodiment, a signaling other than the first signaling indicates a priority corresponding to the first bit block.

In one embodiment, the first signaling explicitly indicates a priority corresponding to the first bit block.

In one embodiment, a signaling other than the first signaling explicitly indicates a priority corresponding to the first bit block.

In one embodiment, the first signaling implicitly indicates a priority corresponding to the first bit block.

In one embodiment, a signaling other than the first signaling implicitly indicates a priority corresponding to the first bit block.

In one embodiment, the first bit block comprises indication information of whether the signaling other than the first signaling is correctly received, or, the first bit block comprises indication information of whether a bit block scheduled by the signaling other than the first signaling is correctly received.

In one embodiment, the signaling other than the first signaling is an RRC-layer signaling.

In one embodiment, the signaling other than the first signaling comprises one or multiple fields in an RRC-layer signaling.

In one embodiment, the signaling other than the first signaling is dynamically configured.

In one embodiment, the signaling other than the first signaling is a PHY signaling.

In one embodiment, the signaling other than the first signaling comprises one or multiple fields in a PHY signaling.

In one embodiment, the signaling other than the first signaling is a higher-layer signaling.

In one embodiment, the signaling other than the first signaling comprises one or multiple fields in a higher-layer signaling.

In one embodiment, the signaling other than the first signaling is a DCI signaling.

In one embodiment, the signaling other than the first signaling comprises one or multiple fields in a DCI.

In one embodiment, the signaling other than the first signaling comprises one or multiple fields in an IE.

In one embodiment, the signaling other than the first signaling is a downlink grant signaling.

In one embodiment, the first signaling is used to indicate a Semi-Persistent Scheduling (SPS) release.

In one embodiment, a transmitting end of the first signal receives a sixth bit block; the first signaling comprises scheduling information of the sixth bit block.

In one embodiment, the signaling other than the first signaling is used to indicate an SPS release.

In one embodiment, a transmitting end of the first signal receives a seventh bit block; the signaling other than the first signaling comprises scheduling information of the seventh bit block.

In one embodiment, the scheduling information in the present application comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a transmission antenna port, or a corresponding Transmission Configuration Indicator (TCI) state.

In one embodiment, the first bit block comprises a HARQ-ACK.

In one embodiment, the first bit block comprises a positive integer number of ACK(s) or NACK(s).

In one embodiment, the first bit block comprises a positive integer number of HARQ-ACK bit(s).

In one embodiment, the first bit block comprises a HARQ-ACK codebook.

In one embodiment, the first bit block comprises at least one of a HARQ-ACK of URLLC service type or a HARQ-ACK of eMBB service type.

In one embodiment, the first bit block comprises at least one of a high-priority HARQ-ACK or a low-priority HARQ-ACK.

In one embodiment, the first bit block comprises at least one of a HARQ-ACK corresponding to priority index 1 or a HARQ-ACK corresponding to priority index 0.

In one embodiment, the first bit block comprises at least one of a HARQ-ACK corresponding to the first priority or a HARQ-ACK corresponding to the second priority.

In one embodiment, the first bit block comprises a UCI.

In one embodiment, the first bit block comprises at least one of a UCI of URLLC service type or a UCI of eMBB service type.

In one embodiment, the first bit block comprises at least one of a high-priority UCI or a low-priority UCI.

In one embodiment, the first bit block comprises at least one of a UCI corresponding to priority index 1 or a UCI corresponding to priority index 0.

In one embodiment, the first bit block comprises at least one of UCI corresponding to the first priority or UCI corresponding to the second priority.

In one embodiment, the first bit block comprises a sidelink HARQ-ACK.

In one embodiment, an SL HARQ-ACK in the present application comprises a HARQ-ACK reporting in NR Vehicle to Everything (V2X) service.

In one embodiment, an SL HARQ-ACK in the present application comprises an SL HARQ-ACK reporting under Resource Allocation (RA) of NR V2X mode 1.

In one embodiment, the first bit block comprises a HARQ-ACK corresponding to services on licensed spectrum or a HARQ-ACK corresponding to services on unlicensed spectrum.

In one embodiment, when the first radio resource block comprises a radio resource block corresponding to the first priority, the first condition is satisfied.

In one embodiment, when the first radio resource block does not comprise a radio resource block corresponding to the first priority, the first condition is not satisfied.

In one embodiment, the bit block generated by the first bit block is the first bit block.

In one embodiment, the bit block generated by the first bit block comprises the first bit block.

In one embodiment, the bit block generated by the first bit block comprises all or partial bits in the first bit block.

In one embodiment, the bit block generated by the first bit block is an output acquired after partial or all bits in the first bit block sequentially through one or more operations of logic and, logical or, xor, deleting bit or zero-padding.

In one embodiment, the bit block generated by the first bit block comprises a HARQ-ACK.

In one embodiment, the bit block generated by the first bit block comprises a positive integer number of ACK(s) or NACK(s).

In one embodiment, the bit block generated by the first bit block comprises a positive integer number of HARQ-ACK bit(s).

In one embodiment, the bit block generated by the first bit block comprises a HARQ-ACK codebook.

In one embodiment, the bit block generated by the first bit block comprises at least one of a HARQ-ACK of URLLC service type or a HARQ-ACK or eMBB service type.

In one embodiment, the bit block generated by the first bit block comprises at least one of a high-priority HARQ-ACK or a low-priority HARQ-ACK.

In one embodiment, the bit block generated by the first bit block comprises at least one of a HARQ-ACK corresponding to priority index 1 or a HARQ-ACK corresponding to priority index 0.

In one embodiment, the bit block generated by the first bit block comprises at least one of a HARQ-ACK corresponding to the first priority or a HARQ-ACK corresponding to the second priority.

In one embodiment, the bit block generated by the first bit block comprises a UCI.

In one embodiment, the bit block generated by the first bit block comprises at least one of UCI of URLLC service type or UCI of eMBB service type.

In one embodiment, the bit block generated by the first bit block comprises at least one of a high-priority UCI or a low-priority UCI.

In one embodiment, the bit block generated by the first bit block comprises at least one of a UCI corresponding to priority index 1 or a UCI corresponding to priority index 0.

In one embodiment, the bit block generated by the first bit block comprises at least one of a UCI corresponding to the first priority or a UCI corresponding to the second priority.

In one embodiment, the bit block generated by the first bit block comprises a sidelink HARQ-ACK.

In one embodiment, the bit block generate by the first bit block comprises a HARQ-ACK corresponding to services on licensed spectrum or a HARQ-ACK corresponding to services on unlicensed spectrum.

In one embodiment, the phrase of the first signal carrying a bit block generated by a first bit block comprises: the first signal comprises an output acquired after all or partial bits in the bit block generated by the first bit block sequentially through partial or all of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, whether the first condition is satisfied is used to determine whether a size relation between a value of a priority corresponding to the first bit block and a first threshold is used to determine the target radio resource block.

In one embodiment, a transmitting end of the first signal executes calculation or/and judgment to determine each radio resource block in the first radio resource block group.

In one embodiment, a receiving end of the first signal executes calculation or/and judgment to determine each radio resource block in the first radio resource block group.

In one embodiment, a transmitting end of the first signal executes calculation or/and judgment to determine the second radio resource block.

In one embodiment, a receiving end of the first signal executes calculation or/and judgment to determine the second radio resource block.

In one embodiment, a transmitting end of the first signal executes calculation or/and judgment to determine the second radio resource block according to an indication of the first signaling.

In one embodiment, the first radio resource block group comprises one or multiple radio resource blocks overlapping with the second radio resource block in time domain.

In one embodiment, N value ranges respectively correspond to N radio resource block sets; a second value range is one of the N value ranges; a second radio resource block set is a radio resource block set corresponding to the second value range among the N radio resource block set(s); a second value is equal to a value in the second value range; the first signaling indicates the second radio resource bock from the second radio resource block set.

In one subembodiment of the above embodiment, a number of bit(s) comprised in the bit block generated by the first bit block is used to determine the second value.

In one subembodiment of the above embodiment, a number of bit(s) comprised in a second bit block is used to determine the second value.

In one subembodiment of the above embodiment, the N radio resource block sets respectively comprise N PUCCH resource sets.

In one embodiment, the phrase of being overlapping in time domain in the present application comprises: being overlapping in time domain and frequency domain.

In one embodiment, the phrase of being overlapping in time domain in the present application comprises: being overlapping in time domain, and being overlapping or non-overlapping in frequency domain.

In one embodiment, the implicitly indicating in the present application comprises: being implicitly indicated through a signaling format.

In one embodiment, the implicitly indicating in the present application comprises: being implicitly indicated through an RNTI.

### Embodiment 1C

Embodiment 1C illustrates a flowchart of the processing of a first node according to one embodiment of the present application, as shown in FIG. 1C.

In embodiment 1C, the first node in the present application receives a second signaling in step 101; receives a first signaling in step 102C; transmits a first signal in a first radio resource block in step 103C.

In embodiment 1C, the first signal carries a first bit block; the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

In one embodiment, the first signal comprises a radio signal.

In one embodiment, the first signal comprises a radio-frequency signal.

In one embodiment, the first signal comprises a baseband signal.

In one embodiment, a transmitting end of the first signal firstly receives the second signaling and then receives the first signaling.

In one embodiment, a transmitting end of the first signal firstly receives the first signaling and then receives the second signaling.

In one embodiment, a transmitting end of the first signal receives the first signaling and the second signaling at the same time.

In one embodiment, a transmitting end of the first signal firstly transmits the second signaling and then transmits the first signaling.

In one embodiment, a transmitting end of the first signal firstly transmits the first signaling and then transmits the second signaling.

In one embodiment, a transmitting end of the first signal transmits the first signaling and the second signaling at the same time.

In one embodiment, the first signaling is an RRC-layer signaling.

In one embodiment, the first signaling comprises one or multiple fields in an RRC-layer signaling.

In one embodiment, the first signaling is dynamically configured.

In one embodiment, the first signaling is a physical-layer signaling.

In one embodiment, the first signaling comprises one or multiple fields in a physical-layer signaling.

In one embodiment, the first signaling is a higher-layer signaling.

In one embodiment, the first signaling comprises one or multiple fields in a higher-layer signaling.

In one embodiment, the first signaling is a Downlink Control Information (DCI) signaling.

In one embodiment, the first signaling comprises a DC.

In one embodiment, the first signaling comprises one or multiple fields in a DCI.

In one embodiment, the first signaling comprises one or multiple fields in an Information Element (IE).

In one embodiment, the first signaling is a DownLink Grant Signalling.

In one embodiment, the first signaling is transmitted on a downlink physical-layer control channel (i.e., a downlink channel only capable of bearing a physical-layer signaling).

In one embodiment, the downlink physical-layer control channel in the present application is a Physical Downlink Control CHannel (PDCCH).

In one subembodiment of the above embodiment, the downlink physical-layer control channel in the present application is a short PDCCH (sPDCCH).

In one embodiment, the downlink physical-layer control channel in the present application is a Narrow Band PDCCH (NB-PDCCH).

In one embodiment, the first signaling is DCI format 1_0, and for the specific meaning of the DCI format 1_0, refer to section 7.3.1.2 in 3GPP TS38.212.

In one embodiment, the first signaling is DCI format 1_1, and for the specific meaning of the DCI format 1_1, refer to section 7.3.1.2 in 3GPP TS38.212.

In one embodiment, the first signaling is DCI format 1_2, and for the specific meaning of the DCI format 1_2, refer to section 7.3.1.2 in 3GPP TS38.212.

In one embodiment, the first signaling is a signaling used to schedule a downlink physical-layer data channel.

In one embodiment, the downlink physical-layer data channel in the present application is a Physical Downlink Shared CHannel (PDSCH).

In one embodiment, the downlink physical-layer data channel in the present application is a short PDSCH (sPDSCH).

In one embodiment, the downlink physical-layer data channel in the present application is a Narrow Band PDSCH (NB-PDSCH).

In one embodiment, the second signaling is an RRC-layer signaling.

In one embodiment, the second signaling comprises one or multiple fields in an RRC-layer signaling.

In one embodiment, the second signaling is dynamically configured.

In one embodiment, the second signaling is a physical-layer signaling.

In one embodiment, the second signaling comprises one or multiple fields in a physical-layer signaling.

In one embodiment, the second signaling is a higher-layer signaling.

In one embodiment, the second signaling comprises one or multiple fields in a higher-layer signaling.

In one embodiment, the second signaling is a DCI.

In one embodiment, the second signaling comprises a DC.

In one embodiment, the second signaling comprises one or multiple fields of a DCI.

In one embodiment, the second signaling comprises one or multiple fields in an IE.

In one embodiment, the second signaling is a downlink grant signaling.

In one embodiment, the second signaling is transmitted on a downlink physical-layer control channel (i.e., a downlink channel only capable of bearing a physical-layer signaling).

In one embodiment, the second signaling is DCI format 1_0, and for the specific meaning of the DCI format 10, refer to section 7.3.1.2 in 3GPP TS38.212.

In one embodiment, the second signaling is DCI format 1_1, and for the specific meaning of the DCI format 11, refer to section 7.3.1.2 in 3GPP TS38.212.

In one embodiment, the second signaling is DCI format 1_2, and for the specific meaning of the DCI format 12, refer to section 7.3.1.2 in 3GPP TS38.212.

In one embodiment, the second signaling is a signaling used to schedule a downlink physical-layer data channel.

In one embodiment, the first radio resource block comprises a positive integer number of RE(s) in time frequency domain.

In one embodiment, the RE occupies a multicarrier symbol in time domain, and occupies a subcarrier in frequency domain.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the first radio resource block comprises a positive integer number of subcarrier(s) in frequency domain.

In one embodiment, the first radio resource block comprises a positive integer number of PRB(s) in frequency domain.

In one embodiment, the first radio resource block comprises a positive integer number of RB(s) in frequency domain.

In one embodiment, the first radio resource block comprises a positive integer number of multicarrier symbol(s) in time domain.

In one embodiment, the first radio resource block comprises a positive integer number of slot(s) in time domain.

In one embodiment, the first radio resource block comprises a positive integer number of sub-slot(s) in time domain.

In one embodiment, the first radio resource block comprises a positive integer number of ms(s) in time domain.

In one embodiment, the first radio resource block comprises a positive integer number of discontinuous slot(s) in time domain.

In one embodiment, the first radio resource block comprises a positive integer number of continuous slot(s) in time domain.

In one embodiment, the first radio resource block comprises a positive integer number of sub-frame(s) in time domain.

In one embodiment, the first radio resource block is configured by a higher-layer signaling.

In one embodiment, the first radio resource is configured by a Radio Resource Control (RRC) signaling.

In one embodiment, the first radio resource block is configured by a Medium Access Control layer Control Element (MAC CE) signaling.

In one embodiment, the first radio resource block is reserved for a physical-layer channel.

In one embodiment, the first radio resource block comprises radio resources reserved for a physical-layer channel.

In one embodiment, the first radio resource block comprises radio resources occupied by a physical-layer channel.

In one embodiment, the first radio resource block comprises time-frequency resources occupied by a physical-layer channel in time-frequency domain.

In one embodiment, the first radio resource block comprises time-frequency resources reserved for a physical-layer channel in time-frequency domain.

In one embodiment, the physical-layer channel in the present application comprises a PUCCH.

In one embodiment, the physical-layer channel in the present application comprises a PUSCH.

In one embodiment, the physical-layer channel in the present application comprises an uplink physical-layer channel.

In one embodiment, the first radio resource block comprises a PUCCH resource.

In one embodiment, the first bit block comprises indication information of whether the first signaling is correctly received, or, the first bit block comprises indication information of whether a bit block scheduled by the first signaling is correctly received.

In one embodiment, the first-type HARQ-ACK comprised in the first bit block comprises a HARQ-ACK indicating whether the first signaling is correctly received, or, the first-type HARQ-ACK comprised in the first bit block comprises a HARQ-ACK indicating whether a bit block scheduled by the first signaling is correctly received.

In one embodiment, the first signaling comprises scheduling information of the bit block scheduled by the first signaling.

In one embodiment, the scheduling information in the present application comprises at least one of occupied time-domain resources, occupied frequency-domain resources, a Modulation and Coding Scheme (MCS), configuration information of DeModulation Reference Signals (DMRS), a Hybrid Automatic Repeat request (HARQ) process number, a Redundancy Version (RV), a New Data Indicator (NDI), a periodicity, a transmission antenna port, or a corresponding Transmission Configuration Indicator (TCI) state.

In one embodiment, the bit block scheduled by the first signaling comprises a positive integer number of bit(s).

In one embodiment, the bit block scheduled by the first signaling comprises a Transport Block (TB).

In one embodiment, the bit block scheduled by the first signaling comprises a Code Block (CB).

In one embodiment, the bit block scheduled by the first signaling comprises a Code Block Group (CBG).

In one embodiment, the first bit block comprises a positive integer number of bit(s).

In one embodiment, the first bit block comprises a positive integer number of ACK(s) or NACK(s).

In one embodiment, the first bit block comprises a positive integer number of the first-type HARQ-ACK information bit(s).

In one embodiment, the first bit block comprises a HARQ-ACK codebook.

In one embodiment, the first-type HARQ-ACK comprises a HARQ-ACK corresponding to URLLC service type.

In one embodiment, the first-type HARQ-ACK comprises a HARQ-ACK corresponding to eMBB service type.

In one embodiment, the first-type HARQ-ACK comprises a high-priority HARQ-ACK.

In one embodiment, the first-type HARQ-ACK comprises a low-priority HARQ-ACK.

In one embodiment, the first-type HARQ-ACK comprises HARQ-ACK corresponding to priority index 1.

In one embodiment, the first-type HARQ-ACK comprises a HARQ-ACK corresponding to priority index 0.

In one embodiment, the first bit block comprises a UCI.

In one embodiment, the first-type HARQ-ACK comprises a sidelink HARQ-ACK (SL HARQ-ACK).

In one embodiment, the second bit block comprises indication information of whether the second signaling is correctly received, or, the second bit block comprises indication information of whether a bit block scheduled by the second signaling is correctly received.

In one embodiment, the second-type HARQ-ACK comprised in the second bit block comprises a HARQ-ACK indicating whether the second signaling is correctly received, or, the second-type HARQ-ACK comprised in the second bit block comprises a HARQ-ACK indicating whether a bit block scheduled by the second signaling is correctly received.

In one embodiment, the second signaling comprises scheduling information of the bit block scheduled by the second signaling.

In one embodiment, the bit block scheduled by the second signaling comprises at least one bit.

In one embodiment, the bit block scheduled by the second signaling comprises a TB.

In one embodiment, the bit block scheduled by the second signaling comprises a CB.

In one embodiment, the bit block scheduled by the second signaling comprises a CBG.

In one embodiment, the second bit block comprises a positive integer number of bit(s).

In one embodiment, the second bit block comprises a positive integer number of ACK(s) or NACK(s).

In one embodiment, the second bit block comprises a positive integer number of the first-type HARQ-ACK information bit(s).

In one embodiment, the second bit block comprises a HARQ-ACK codebook.

In one embodiment, the second-type HARQ-ACK comprises a HARQ-ACK corresponding to URLLC service type.

In one embodiment, the second-type HARQ-ACK comprises a HARQ-ACK corresponding to an eMBB service type.

In one embodiment, the second-type HARQ-ACK comprises a high-priority HARQ-ACK.

In one embodiment, the second-type HARQ-ACK comprises a low-priority HARQ-ACK.

In one embodiment, the second-type HARQ-ACK comprises a HARQ-ACK corresponding to priority index 1.

In one embodiment, the second-type HARQ-ACK comprises a HARQ-ACK corresponding to priority index 0.

In one embodiment, the second bit block comprises a UCI.

In one embodiment, the second-type HARQ-ACK comprises a sidelink HARQ-ACK.

In one embodiment, the first-type HARQ-ACK comprised in the first bit block and the second-type HARQ-ACK comprised in the second bit block respectively comprise different types of HARQ-ACK information bits.

In one embodiment, the first-type HARQ-ACK comprised in the first bit block and the second-type HARQ-ACK comprised in the second bit block respectively correspond to different priority indexes.

In one embodiment, the HARQ-ACK in the present application comprises indication information of whether a signaling or a bit block is correctly received.

In one embodiment, the meaning of the HARQ-ACK in the present application comprises: a bit in a HARQ-ACK codebook.

In one embodiment, the first signaling indicates a first index.

In one embodiment, the first signaling explicitly indicates a first index.

In one embodiment, the first signaling implicitly indicates a first index.

In one embodiment, the first signaling comprises a priority indicator field, and the priority indicator field comprised in the first signaling indicates a first index.

In one embodiment, the second signaling indicates a second index.

In one embodiment, the second signaling explicitly indicates a second index.

In one embodiment, the second signaling implicitly indicates a second index.

In one embodiment, the second signaling comprises a priority indicator field, and the priority indicator field comprised in the second signaling indicates a second index.

In one embodiment, both the first index and the second index are priority indexes.

In one embodiment, all the first-type HARQ-ACKs comprised in the first bit block correspond to the first index.

In one embodiment, all the second-type HARQ-ACKs comprised in the second bit block correspond to the second index.

In one embodiment, the first bit block and the second bit block respectively correspond to different priority indexes.

In one embodiment, the first bit block corresponds to the first index.

In one embodiment, the second bit block correspond to the second index.

In one embodiment, the first index is Priority Index 1, and the second index is Priority Index 0.

In one embodiment, the first index is Priority Index 0, and the second index is Priority Index 1.

In one embodiment, the first index and the second index are respectively indexes indicating different priorities.

In one embodiment, the first index and the second index respectively correspond to different service types.

In one embodiment, the first index and the second index are used to determine a PHY priority.

In one embodiment, the first bit block corresponds to a first index, and the second bit block corresponds to a second index.

In one embodiment, the first-type HARQ-ACK corresponds to the first index, and the second-type HARQ-ACK corresponds to the second index.

In one embodiment, the first radio resource block corresponds to the first index.

In one embodiment, the first radio resource block is reserved for a physical-layer channel corresponding the first index.

In one embodiment, the first radio resource block is reserved for a PUCCH corresponding the first index.

In one embodiment, the first signaling indicates the first radio resource block.

In one embodiment, the first signaling indicates time-domain resources comprised in the first radio resource block.

In one embodiment, the first signaling indicates frequency-domain resources comprised in the first radio resource block.

In one embodiment, the first signaling indicates the first radio resource block from a first radio resource block set.

In one embodiment, the first signaling indicates an index of the first radio resource block in the first radio resource block set.

In one embodiment, the first radio resource block set comprises a PUCCH resource set.

In one embodiment, the second field comprises a positive integer number of bit(s).

In one embodiment, the second field comprises 1 bit.

In one embodiment, the second field comprises 2 bits.

In one embodiment, a priority corresponding to the first bit block is greater than a priority corresponding to the second bit block.

In one embodiment, the phrase of the second field in the first signaling being used to determine a number of bit(s) related to the second bit block and carried by the first signal comprises: the second field in the first signaling is used to determine whether the number of bit(s) related to the second bit block and carried by the first signal is greater than 0.

In one embodiment, the phrase of the second field in the first signaling being used to determine a number of bit(s) related to the second bit block and carried by the first signal comprises: the second field in the first signaling is used to determine the number of bit(s) related the second-type HARQ-ACK comprised in the second bit block and carried by the first signal.

In one embodiment, the phrase of the second field in the first signaling being used to determine a number of bit(s) related to the second bit block and carried by the first signal comprises: the second field in the first signaling is used to determine whether the number of bit(s) related the second-type HARQ-ACK comprised in the second bit block and carried by the first signal is greater than 0.

In one embodiment, a bit related to the second bit block comprises: the second bit block.

In one embodiment, a bit related to the second bit block comprises: bit(s) comprised in the second bit block.

In one embodiment, a bit related to the second bit block comprises: bit(s) comprised in a bit block generated by the second bit block.

In one embodiment, a bit related to the second bit block comprises: all or partial bits in the second bit block.

In one embodiment, a bit related to the second bit block comprises: an output acquired after partial or all bits in the second bit block sequentially through one or more operations of logic and, logical or, xor, deleting bit or zero-padding.

In one embodiment, bit(s) related to the second-type HARQ-ACK comprised in the second bit block comprises: the second-type HARQ-ACK comprised in the second bit block.

In one embodiment, bit(s) related to the second-type HARQ-ACK comprised in the second bit block comprises: a bit comprised in a bit block generated by the second-type HARQ-ACK comprised in the second bit block.

In one embodiment, bit(s) related to the second-type HARQ-ACK comprised in the second bit block comprises: all or partial bits in the second-type HARQ-ACK comprised in the second bit block.

In one embodiment, bit(s) related to the second-type HARQ-ACK comprised in the second bit block comprises: an output acquired after partial or all bits in the second-type HARQ-ACK information bit comprised in the second bit block sequentially through one or more operations of logic and, logical or, xor, deleting bit or zero-padding.

In one embodiment, the phrase of the first signal carrying a first bit block comprises: the first signal comprises an output acquired after all or partial bits in the first bit block sequentially through partial or all operations of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, when the first signal carries a bit related to the second bit block: the first signal comprises an output acquired after all or partial bits related to the second bit block sequentially through partial or all operations of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, the implicitly indicating in the present application comprises: being implicitly indicated through a signaling format.

In one embodiment, the implicitly indicating in the present application comprises: being implicitly indicated through an RNTI.

### Embodiment 1D

Embodiment 1D illustrates a flowchart of the processing of a first node according to one embodiment of the present application, as shown in FIG. 1D.

In Embodiment 1D, the first node in the present application receives a first signaling in step 101D; transmits a first signal in a first time window in step 102D.

In Embodiment 1D, the first signal carries a first bit block; the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

In one embodiment, the first signal comprises a radio signal.

In one embodiment, the first signal comprises a radio-frequency signal.

In one embodiment, the first signal comprises a baseband signal.

In one embodiment, the first signaling comprises a physical-layer signaling.

In one embodiment, the first signaling comprises a dynamic signaling.

In one embodiment, the first signaling comprises a layer 1 (L1) signaling.

In one embodiment, the first signaling comprises an L1 control signaling.

In one embodiment, the first signaling comprises Downlink Control Information (DCI).

In one embodiment, the first signaling comprises one or multiple fields in a DCI.

In one embodiment, the first signaling comprises one or multiple fields in an SCI.

In one embodiment, the first signaling comprises a DCI used for UpLink Grant.

In one embodiment, the first signaling comprises an activated DCI used for Configured Uplink Grant Type 2.

In one embodiment, the first signaling comprises a higher-layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or multiple fields in a higher-layer signaling.

In one embodiment, the first signaling comprises one or multiple fields in an RRC signaling

In one embodiment, the first signaling comprises one or multiple fields in a MAC CE signaling.

In one embodiment, the first signaling comprises information in one or multiple fields in an IE.

In one embodiment, the first signaling comprises scheduling information of the first signal.

In one embodiment, the modulation information comprises one or multiple of time-domain resources, frequency-domain resources, a Modulation and Coding Scheme (MCS) and a DeModulation Reference Signals (DMRS) port.

In one embodiment, the first signaling explicitly indicates the first time window.

In one embodiment, the first signaling implicitly indicates the first time window.

In one embodiment, information indicated by the first signaling is used to infer the first time window.

In one embodiment, the first signaling and a signaling other than the first signaling are used together to determine the first time window.

In one embodiment, the signaling other than the first signaling comprises a DCI.

In one embodiment, the signaling other than the first signaling comprises a higher-layer signaling.

In one embodiment, the signaling other than the first signaling comprises an RRC signaling.

In one embodiment, the signaling other than the first signaling comprises a MAC CE signaling.

In one embodiment, the first signaling is an UpLink Grant Signalling.

In one embodiment, the first signaling is transmitted on a downlink physical-layer control channel (i.e., a downlink channel only capable of bearing a physical-layer signaling).

In one embodiment, the downlink physical-layer control channel in the present application is a Physical Downlink Control CHannel (PDCCH).

In one subembodiment of the above embodiment, the downlink physical-layer control channel in the present application is a short PDCCH (sPDCCH).

In one embodiment, the downlink physical-layer control channel in the present application is a Narrow Band PDCCH (NB-PDCCH).

In one embodiment, the first signaling is DCI format 0_0, and for the specific meaning of the DCI format 00, refer to section 7.3.1.1 in 3GPP TS38.212.

In one embodiment, the first signaling is DCI format 0_1, and for the specific meaning of the DCI format 01, refer to section 7.3.1.1 in 3GPP TS38.212.

In one embodiment, the first signaling is DCI format 0_2, and for the specific meaning of the DCI format 02, refer to section 7.3.1.1 in 3GPP TS38.212.

In one embodiment, the first signaling is a signaling used to schedule an uplink physical-layer data channel.

In one embodiment, the uplink physical-layer data channel in the present application is a Physical Uplink Shared Channel (PUSCH).

In one subembodiment, the uplink physical-layer data channel in the present application is a short PUSCH (sPUSCH).

In one embodiment, the uplink physical-layer data channel in the present application is a Narrow Band PUSCH (NB-PUSCH).

In one embodiment, the phrase of the first signal carrying a first bit block comprises: the first signal comprises an output acquired after all or partial bits in the first bit block sequentially through partial or all operations of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, the first time window is a continuous duration.

In one embodiment, the first time window comprises a positive integer number of time element(s).

In one embodiment, the first time window comprises one or multiple continuous time elements.

In one embodiment, the first time window comprises a slot.

In one embodiment, the first time window comprises a positive integer number of slot(s).

In one embodiment, the first time window comprises a sub-slot.

In one embodiment, a length of the first time window is not greater than a slot.

In one embodiment, the first time window is reserved for a transmission of the first bit block.

In one embodiment, the time element comprises a multicarrier symbol.

In one embodiment, the time element is a multicarrier symbol.

In one embodiment, the multicarrier symbol comprises an Orthogonal Frequency Division Multiplexing (OFDM) symbol.

In one embodiment, the multicarrier symbol comprises a Single Carrier-Frequency Division Multiple Access (SC-FDMA) symbol.

In one embodiment, the multicarrier symbol comprises a Discrete Fourier Transform Spread OFDM (DFT-S-OFDM) symbol.

In one embodiment, the time element comprises a ms.

In one embodiment, the positive integer greater than 1 is equal to 2.

In one embodiment, the positive integer greater than 1 is equal to 3.

In one embodiment, the positive integer greater than 1 is equal to 4.

In one embodiment, the positive integer greater than 1 is equal to 7.

In one embodiment, the positive integer greater than 1 is not greater than 12.

In one embodiment, the positive integer greater than 1 is not greater than 14.

In one embodiment, the positive integer greater than 1 is not greater than 12000.

In one embodiment, the positive integer greater than 1 is not greater than 14000.

In one embodiment, the RV corresponding to the first signal comprises: an RV being applied to a transmission of the first signal.

In one embodiment, a transmission of the first signal comprises a transmission of a TB; the RV corresponding to the first signal comprises an RV being applied to the transmission of the TB.

In one embodiment, a transmission of the first signal comprises a transmission of the first bit block; the RV corresponding to the first signal comprises an RV being applied to the transmission of the first bit block.

In one embodiment, a transmission of the first signal comprises a PUSCH transmission; the RV corresponding to the first signal comprises an RV of the PUSCH transmission.

In one embodiment, the first bit block comprises a Transport Block (TB).

In one embodiment, the first bit block comprises a Code Block (CB).

In one embodiment, the first bit block comprises a Code Block Group (CBG).

In one embodiment, the first bit block comprises a positive integer number of bit(s).

In one embodiment, the RV in the present application is used to implement a HARQ transmission of Incremental redundancy (IR).

In one embodiment, the implicitly indicating in the present application comprises: being implicitly indicated through a signaling format.

In one embodiment, the implicitly indicating in the present application comprises: being implicitly indicated through an RNTI.

### Embodiment 2

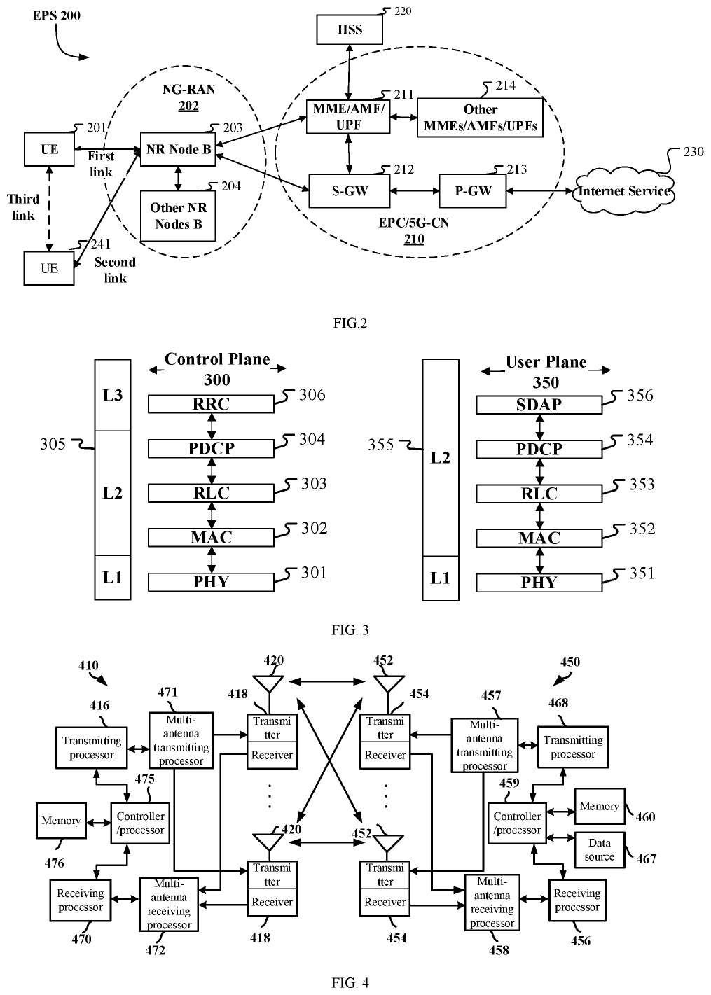

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 241 corresponds to the second node in the present application.

In one embodiment, the gNB 203 corresponds to the first node in the present application.

In one embodiment, the gNB 203 corresponds to the second node in the present application.

In one embodiment, the UE 241 corresponds to the first node in the present application.

In one embodiment, the UE 201 corresponds to the second node in the present application.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the SDAP sublayer 356.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the third bit block in the present application is generated by the RRC sublayer 306.

In one embodiment, the third bit block in the present application is generated by the MAC sublayer 302.

In one embodiment, the third bit block in the present application is generated by the MAC sublayer 352.

In one embodiment, the third bit block in the present application is generated by the PHY 301.

In one embodiment, the third bit block in the present application is generated by the PHY 351.

In one embodiment, the sixth bit block in the present application is generated by the RRC sublayer 306.

In one embodiment, the sixth bit block in the present application is generated by the MAC sublayer 302.

In one embodiment, the sixth bit block in the present application is generated by the MAC sublayer 352.

In one embodiment, the sixth bit block in the present application is generated by the PHY 301.

In one embodiment, the sixth bit block in the present application is generated by the PHY 351.

In one embodiment, the seventh bit block in the present application is generated by the RRC sublayer 306.

In one embodiment, the seventh bit block in the present application is generated by the MAC sublayer 302.

In one embodiment, the seventh bit block in the present application is generated by the MAC sublayer 352.

In one embodiment, the seventh bit block in the present application is generated by the PHY 301.

In one embodiment, the seventh bit block in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, the second signaling in the present application is generated by the RRC sublayer 306.

In one embodiment, the second signaling in the present application is generated by the MAC sublayer 302.

In one embodiment, the second signaling in the present application is generated by the MAC sublayer 352.

In one embodiment, the second signaling in the present application is generated by the PHY 301.

In one embodiment, the second signaling in the present application is generated by the PHY 351.

In one embodiment, the first bit block in the present application is generated by the SDAP sublayer 356.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the SDAP sublayer 356.

In one embodiment, the second bit block in the present application is generated by the RRC sublayer 306.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, one of the K signalings in the present application is generated by the RRC sublayer 306.

In one embodiment, one of the K signalings in the present application is generated by the MAC sublayer 302.

In one embodiment, one of the K signalings in the present application is generated by the MAC sublayer 352.

In one embodiment, one of the K signalings in the present application is generated by the PHY 301.

In one embodiment, one of the K signalings in the present application is generated by the PHY 351.

In one embodiment, a signaling in the first signaling group in the present application is generated by the RRC sublayer 306.

In one embodiment, a signaling in the first signaling in the present application is generated by the MAC sublayer 302.

In one embodiment, a signaling in the first signaling in the present application is generated by the MAC sublayer 352.

In one embodiment, a signaling in the first signaling group in the present application is generated by the PHY 301.

In one embodiment, a signaling in the first signaling group in the present application is generated by the PHY 351.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, the second signaling in the present application is generated by the RRC sublayer 306.

In one embodiment, the second signaling in the present application is generated by the MAC sublayer 302.

In one embodiment, the second signaling in the present application is generated by the MAC sublayer 352.

In one embodiment, the second signaling in the present application is generated by the PHY 301.

In one embodiment, the second signaling in the present application is generated by the PHY351.

In one embodiment, the first bit block in the present application is generated by the SDAP sublayer 356.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application and the second signaling in the present application; transmits the first signal in the present application in the target radio resource block in the present application, and the first signal carries the first bit block in the present application; the first signaling is used to determine the first bit block, and the second signaling is used to determine the third bit block in the present application; the second radio resource block in the present application is reserved for the second bit block in the present application; a number of bit(s) comprised in the first bit block and a number of bit(s) comprised in the third bit block are used to determine the first radio resource block in the present application, and the first radio resource block overlaps with the second radio resource block in time domain; the first number in the present application is used to determine a fourth radio resource block in the present application, the first number is not less than a number of bit(s) comprised in the first bit block and is less than a sum of a number of bit(s) comprised in the first bit block and a number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application and the second signaling in the present application; transmitting the first signal in the present application in the target radio resource block in the present application, and the first signal carrying the first bit block in the present application; the first signaling is used to determine the first bit block, and the second signaling is used to determine the third bit block in the present application; the second radio resource block in the present application is reserved for the second bit block in the present application; a number of bit(s) comprised in the first bit block and a number of bit(s) comprised in the third bit block are used to determine the first radio resource block in the present application, and the first radio resource block overlaps with the second radio resource block in time domain; the first number in the present application is used to determine a fourth radio resource block in the present application, the first number is not less than a number of bit(s) comprised in the first bit block and is less than a sum of a number of bit(s) comprised in the first bit block and a number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application and the second signaling in the present application; receives the first signal in the present application in the target radio resource block in the present application, and the first signal carries the first bit block in the present application; the first signaling is used to determine the first bit block, and the second signaling is used to determine the third bit block in the present application; the second radio resource block in the present application is reserved for the second bit block in the present application; a number of bit(s) comprised in the first bit block and a number of bit(s) comprised in the third bit block are used to determine the first radio resource block in the present application, and the first radio resource block overlaps with the second radio resource block in time domain; the first number in the present application is used to determine a fourth radio resource block in the present application, the first number is not less than a number of bit(s) comprised in the first bit block and is less than a sum of a number of bit(s) comprised in the first bit block and a number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application and the second signaling in the present application; receiving the first signal in the present application in the target radio resource block in the present application, and the first signal carrying the first bit block in the present application; the first signaling is used to determine the first bit block, and the second signaling is used to determine the third bit block in the present application; the second radio resource block in the present application is reserved for the second bit block in the present application; a number of bit(s) comprised in the first bit block and a number of bit(s) comprised in the third bit block are used to determine the first radio resource block in the present application, and the first radio resource block overlaps with the second radio resource block in time domain; the first number in the present application is used to determine a fourth radio resource block in the present application, the first number is not less than a number of bit(s) comprised in the first bit block and is less than a sum of a number of bit(s) comprised in the first bit block and a number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the receiver 454, the multi-antenna receiving processor 458, the receiving processor 456, the controller/processor 459, the memory 460, or the data source 467 is used to receive the second signaling in the present application.

In one embodiment, at least one of the antenna 420, the transmitter 418, the multi-antenna transmitting processor 471, the transmitting processor 416, the controller/processor 475, or the memory 476 is used to transmit the second signaling in the present application.

In one embodiment, at least one of the antenna 452, the transmitter 454, the multi-antenna transmission processor 458, the transmitting processor 468, the controller/processor 459, the memory 460, or the data source 467 is used to transmit the first signal in the present application in the target radio resource block in the present application.

In one embodiment, at least one of the antenna 420, the receiver 418, the multi-antenna receiving processor 472, the receiving processor 470, the controller/processor 475, or the memory 476 is used to receive the first signal in the present application in the target radio resource block in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application; and transmits the first signal in the present application in the target radio resource block in the present application, and the first signal carries a bit block generated by the first bit block in the present application; the first signaling is used to determine the second radio resource block in the present application; the second radio resource block and all radio resource blocks in the first radio resource block group in the present application are overlapping in time domain; any radio resource block in the first radio resource block group is reserved for a bit block; each radio resource block in the first radio resource block group corresponds to a priority in the first priority set in the present application; the first priority set comprises the first priority in the present application and the second priority in the present application, and the first priority is different from the second priority; the target radio resource block is the second radio resource block or a radio resource block in the first radio resource block group; whether the first condition in the present application is satisfied is used to determine whether a priority corresponding to the first bit block is used to determine the target radio resource block; the first condition comprises: the first radio resource block group comprises a radio resource block corresponding to the first priority.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application; and transmitting the first signal in the present application in the target radio resource block in the present application, and the first signal carrying a bit block generated by the first bit block in the present application; the first signaling is used to determine the second radio resource block in the present application; the second radio resource block and all radio resource blocks in the first radio resource block group in the present application are overlapping in time domain; any radio resource block in the first radio resource block group is reserved for a bit block; each radio resource block in the first radio resource block group corresponds to a priority in the first priority set in the present application; the first priority set comprises the first priority in the present application and the second priority in the present application, and the first priority is different from the second priority; the target radio resource block is the second radio resource block or a radio resource block in the first radio resource block group; whether the first condition in the present application is satisfied is used to determine whether a priority corresponding to the first bit block is used to determine the target radio resource block; the first condition comprises: the first radio resource block group comprises a radio resource block corresponding to the first priority.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application; and receives the first signal in the present application in the target radio resource block in the present application, and the first signal carries a bit block generated by the first bit block in the present application; the first signaling is used to determine the second radio resource block in the present application; the second radio resource block and all radio resource blocks in the first radio resource block group in the present application are overlapping in time domain; any radio resource block in the first radio resource block group is reserved for a bit block; each radio resource block in the first radio resource block group corresponds to a priority in the first priority set in the present application; the first priority set comprises the first priority in the present application and the second priority in the present application, and the first priority is different from the second priority; the target radio resource block is the second radio resource block or a radio resource block in the first radio resource block group; whether the first condition in the present application is satisfied is used to determine whether a priority corresponding to the first bit block is used to determine the target radio resource block; the first condition comprises: the first radio resource block group comprises a radio resource block corresponding to the first priority.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application; and receiving the first signal in the present application in the target radio resource block in the present application, and the first signal carrying a bit block generated by the first bit block in the present application; the first signaling is used to determine the second radio resource block in the present application; the second radio resource block and all radio resource blocks in the first radio resource block group in the present application are overlapping in time domain; any radio resource block in the first radio resource block group is reserved for a bit block; each radio resource block in the first radio resource block group corresponds to a priority in the first priority set in the present application; the first priority set comprises the first priority in the present application and the second priority in the present application, and the first priority is different from the second priority; the target radio resource block is the second radio resource block or a radio resource block in the first radio resource block group; whether the first condition in the present application is satisfied is used to determine whether a priority corresponding to the first bit block is used to determine the target radio resource block; the first condition comprises: the first radio resource block group comprises a radio resource block corresponding to the first priority.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmission processor 458, the transmitting processor 468, the controller/processor 459, the memory 460, or the data source 467 is used to transmit the first signal in the present application in the target radio resource block in the present application.

In one embodiment, at least one of the antenna 420, the receiver 418, the multi-antenna receiving processor 472, the receiving processor 470, the controller/processor 475, or the memory 476 is used to receive the first signal in the present application in the target radio resource block in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the second signaling in the present application and the first signaling in the present application; transmits the first signal in the present application in the first radio resource block in the present application, and the first signal carries the first bit block in the present application; the first signaling and the second signaling are respectively used to determine the first bit block and the second bit block in the present application; the first signaling is used to determine the first radio resource block; the first bit block comprises the first-type HARQ-ACK in the present application, and the second bit block comprises the second-type HARQ-ACK in the present application; the first-type HARQ-ACK and the second-type HARQ-ACK are respectively different types of HARQ-ACKs; the first bit block and the second bit block respectively correspond to different indexes; the first signaling comprises the second field in the present application; the second field in the first signaling is used to determine a number of bit(s) related to the second bit block and carried by the first signal.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the second signaling in the present application and the first signaling in the present application; transmitting the first signal in the present application in the first radio resource block in the present application, and the first signal carrying the first bit block in the present application; the first signaling and the second signaling are respectively used to determine the first bit block and the second bit block in the present application; the first signaling is used to determine the first radio resource block; the first bit block comprises the first-type HARQ-ACK in the present application, and the second bit block comprises the second-type HARQ-ACK in the present application; the first-type HARQ-ACK and the second-type HARQ-ACK are respectively different types of HARQ-ACKs; the first bit block and the second bit block respectively correspond to different indexes; the first signaling comprises the second field in the present application; the second field in the first signaling is used to determine a number of bit(s) related to the second bit block and carried by the first signal.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the second signaling in the present application and the first signaling in the present application; receives the first signal in the present application in the first radio resource block in the present application, and the first signal carries the first bit block in the present application; the first signaling and the second signaling are respectively used to determine the first bit block and the second bit block in the present application; the first signaling is used to determine the first radio resource block; the first bit block comprises the first-type HARQ-ACK in the present application, and the second bit block comprises the second-type HARQ-ACK in the present application; the first-type HARQ-ACK and the second-type HARQ-ACK are respectively different types of HARQ-ACKs; the first bit block and the second bit block respectively correspond to different indexes; the first signaling comprises the second field in the present application; the second field in the first signaling is used to determine a number of bit(s) related to the second bit block and carried by the first signal.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the second signaling in the present application and the first signaling in the present application; receiving the first signal in the present application in the first radio resource block in the present application, and the first signal carrying the first bit block in the present application; the first signaling and the second signaling are respectively used to determine the first bit block and the second bit block in the present application; the first signaling is used to determine the first radio resource block; the first bit block comprises the first-type HARQ-ACK in the present application, and the second bit block comprises the second-type HARQ-ACK in the present application; the first-type HARQ-ACK and the second-type HARQ-ACK are respectively different types of HARQ-ACKs; the first bit block and the second bit block respectively correspond to different indexes; the first signaling comprises the second field in the present application; the second field in the first signaling is used to determine a number of bit(s) related to the second bit block and carried by the first signal.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the receiver 454, the multi-antenna receiving processor 458, the receiving processor 456, the controller/processor 459, the memory 460, or the data source 467 is used to receive the second signaling in the present application.

In one embodiment, at least one of the antenna 420, the transmitter 418, the multi-antenna transmitting processor 471, the transmitting processor 416, the controller/processor 475, or the memory 476 is used to transmit the second signaling in the present application.

In one embodiment, at least one of the antenna 452, the transmitter 454, the multi-antenna transmission processor 458, the transmitting processor 468, the controller/processor 459, the memory 460, or the data source 467 is used to transmit the first signal in the present application in the first radio resource block in the present application.

In one embodiment, at least one of the antenna 420, the receiver 418, the multi-antenna receiving processor 472, the receiving processor 470, the controller/processor 475, or the memory 476 is used to receive the first signal in the present application in the first radio resource block in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application; and transmits the first signal in the present application in the first time window in the present application, and the first signal carries the first bit block in the present application; the first signaling is used to determine the first time window; the first time window is reserved for a transmission of the first bit block; the first time window comprises one or more time element(s) in the present application; a number of the time element(s) comprised in the first time window is used to determine whether the RV in the present application corresponding to the first signal is determined by a bit block carried by the first signal.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application; and transmitting the first signal in the present application in the first time window in the present application, and the first signal carrying the first bit block in the present application; the first signaling is used to determine the first time window; the first time window is reserved for a transmission of the first bit block; the first time window comprises one or more time element(s) in the present application; a number of the time element(s) comprised in the first time window is used to determine whether the RV in the present application corresponding to the first signal is determined by a bit block carried by the first signal.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application; and receives the first signal in the present application in the first time window in the present application, and the first signal carries the first bit block in the present application; the first signaling is used to determine the first time window; the first time window is reserved for a transmission of the first bit block; the first time window comprises one or more time element(s) in the present application; a number of the time element(s) comprised in the first time window is used to determine whether the RV in the present application corresponding to the first signal is determined by a bit block carried by the first signal.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application; and receiving the first signal in the present application in the first time window in the present application, and the first signal carrying the first bit block in the present application; the first signaling is used to determine the first time window; the first time window is reserved for a transmission of the first bit block; the first time window comprises one or more time element(s) in the present application; a number of the time element(s) comprised in the first time window is used to determine whether the RV in the present application corresponding to the first signal is determined by a bit block carried by the first signal.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmission processor 458, the transmitting processor 468, the controller/processor 459, the memory 460, or the data source 467 is used to transmit the first signal in the present application in the first time window in the present application.

In one embodiment, at least one of the antenna 420, the receiver 418, the multi-antenna receiving processor 472, the receiving processor 470, the controller/processor 475, or the memory 476 is used to receive the first signal in the present application in the first time window in the present application.

### Embodiment 5A

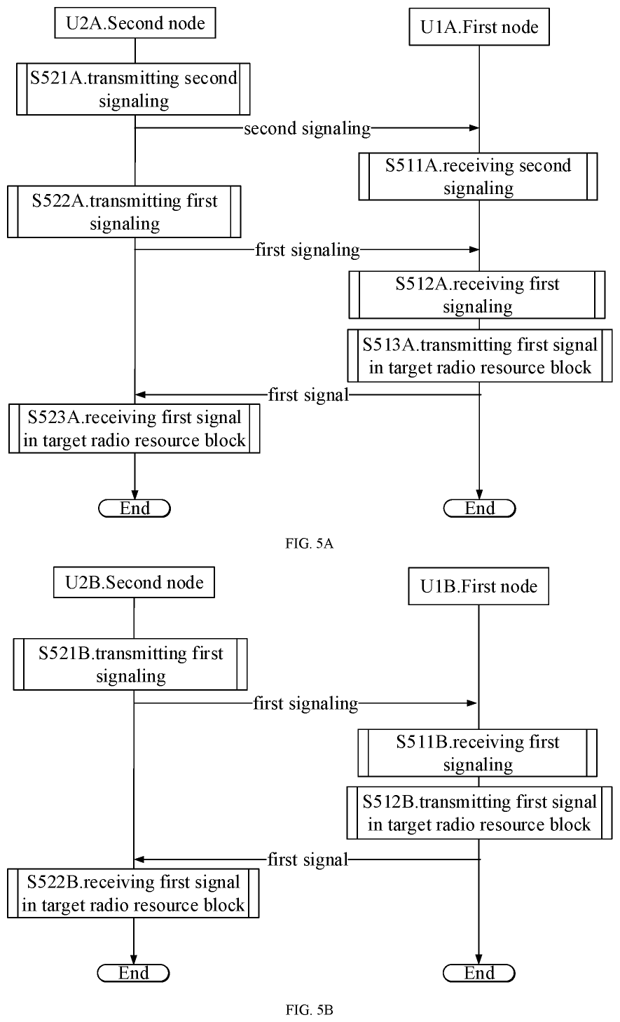

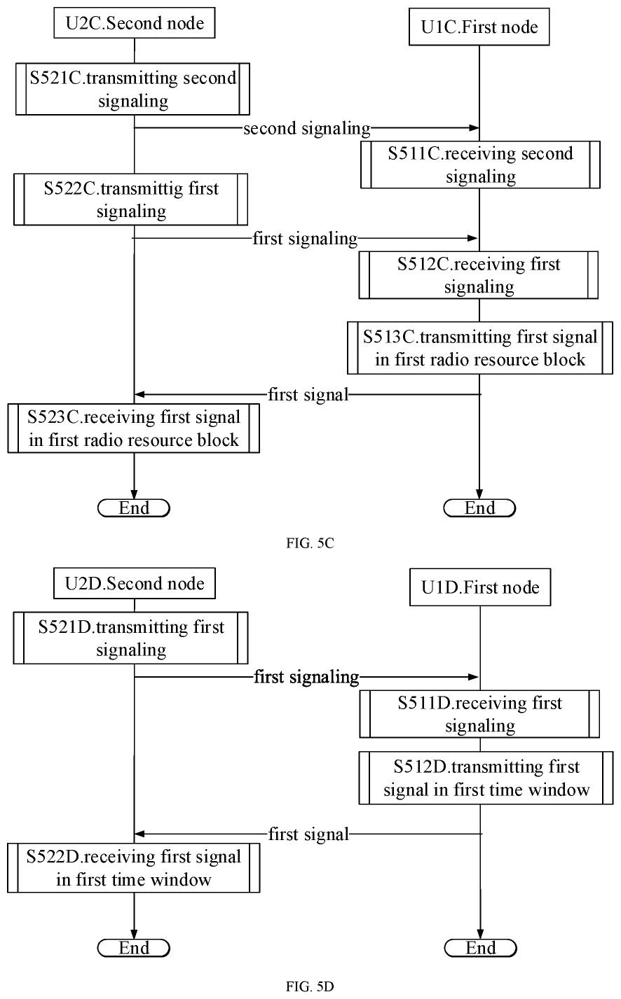

Embodiment 5A illustrates a flowchart of radio signal transmission according to one embodiment in the present application, as shown in FIG. 5. In FIG. 5A, a first node U1A and a second node U2A are in communications via an air interface. Particularly, the sequence between {S521A, S511A} and {S522A, S512A} in FIG. 5A does not represent a specific chronological sequence.

The first node U1A receives a second signaling in step S511A; receives a first signaling in step S512A; transmits a first signal in a target radio resource block in step S513A;

The second node U2A transmits a second signaling in step S521A; transmits a first signaling in step S522A; receives a first signal in a target radio resource block in step S523A.

In embodiment 5A, the first signal carries a first bit block; the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block; when a priority of the second bit block is a first priority, the target radio resource block is the fourth radio resource block; when a priority of the second bit block is not the first priority, the target radio resource block is the first radio resource block; a fifth radio resource block is reserved for the first bit block; a third radio resource block is reserved for the third bit block; the fifth radio resource block and the third time-frequency resource block are overlapping in time domain; N number range(s) corresponds (respectively correspond) to N radio resource block set(s); a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block set(s); the first radio resource block set comprises the first radio resource block.

In one subembodiment of embodiment 5A, the first bit block comprises a first-type HARQ-ACK; the third bit block comprises a second-type HARQ-ACK.

In one subembodiment of embodiment 5A, when the target radio resource block is the first radio resource block, the first node U1A does not transmit a signal carrying the second bit block in a second radio resource sub-block; the second radio resource sub-block is a part overlapping with the first radio resource block in time domain and comprised in the second radio resource block.

In one subembodiment of embodiment 5A, the first number is used to determine the fourth radio resource block; a number of bit(s) comprised in the first bit block and a number of bit(s) comprised in a fourth bit block are used to determine the first number; the fourth bit block is related to the third bit block; a number of bit(s) comprised in the fourth bit block is less than a number of bit(s) comprised in the third bit block.

In one embodiment, the first node U1A is the first node in the present application.

In one embodiment, the second node U2A is the second node in the present application.

In one embodiment, the first node U1A is a UE.

In one embodiment, the second node U2A is a base station.

In one embodiment, the second node U2A is a UE.

In one embodiment, an air interface between the second node U2A and the first node U1A is a Uu interface.

In one embodiment, an air interface between the second node U2A and the first node U1A comprises a cellular link.

In one embodiment, an air interface between the second node U2A and the first node U1A is a PC5 interface.

In one embodiment, an air interface between the second node U2A and the first node U1A comprises a sidelink.

In one embodiment, an air interface between the second node U2A and the first node U1A comprises a radio interface between a base station and a UE.

In one embodiment, a second radio resource block group comprises the third radio resource block and the fifth radio resource block.

In one embodiment, a second radio resource block group comprises the second radio resource block, the third radio resource block and the fifth radio resource block.

In one embodiment, a second radio resource block group comprises the third radio resource block and the first radio resource block.

In one embodiment, a second radio resource block group comprises the second radio resource block, the third radio resource block and the first radio resource block.

In one embodiment, a second radio resource block group comprises the third radio resource block and the fourth radio resource block.

In one embodiment, a second radio resource block group comprises the second radio resource block, the third radio resource block and the fourth radio resource block.

In one embodiment, a second radio resource block group comprises the first radio resource block, the third radio resource block and the fourth radio resource block.

In one embodiment, a second radio resource block group comprises the first radio resource block, the fifth radio resource block, the third radio resource block and the fourth radio resource block.

In one embodiment, a second radio resource block group comprises the second radio resource block, the first radio resource block, the fifth radio resource block, the third radio resource block and the fourth radio resource block.

In one embodiment, all radio resource blocks in the second radio resource block group satisfy conditions in a second condition set.

In one embodiment, conditions in the second condition set are related to UE processing time.

In one embodiment, conditions in the second condition set are related to UE processing capability.

In one embodiment, conditions in the second condition set comprise timeline conditions related to the second radio resource block group, and for the specific description of the timeline condition, refer to section 9.2.5 in 3GPP TS38.213.

In one embodiment, conditions in the second condition set comprise: a time interval between a second time and a start time of a first multicarrier symbol of an earliest radio resource block in the second radio resource block group is not less than a third value.

In one subembodiment of the above embodiment, the third value is related to UE processing time.

In one subembodiment of the above embodiment, the third value is related to UE processing capability.

In one subembodiment of the above embodiment, the third value is related to UE PDSCH processing capability.

In one subembodiment of the above embodiment, at least one of, or is used to determine the third value, and for specific definitions of the, the, the and the, refer to section 9.2.5 in 3GPP TS38. 213.

In one subembodiment of the above embodiment, the second time is an end time of a transmitted downlink physical-layer channel.

In one subembodiment of the above embodiment, the second time is an end time of a transmitted downlink physical-layer channel; the transmitted downlink physical-layer channel comprises a PDSCH or a PDCCH.

In one embodiment, a third signaling indicates that the third bit block is allowed to be transmitted in a radio resource block determined by the first signaling.

In one embodiment, a third signaling comprises a first field; the first field comprised in the third signaling indicates that the third bit block is allowed to be transmitted in a radio resource block determined by the first signaling.

In one embodiment, a third signaling indicates that the second-type HARQ-ACK is allowed to be transmitted in a radio resource block determined by the first signaling.

In one embodiment, a third signaling comprises a first field; the first field comprised in the third signaling indicates that the second-type HARQ-ACK is allowed to be transmitted in a radio resource block determined by the first signaling.

In one embodiment, the radio resource block determined by the first signaling is the first radio resource block.

In one embodiment, the radio resource block determined by the first signaling is the fourth radio resource block.

In one embodiment, a third signaling indicates that the first bit block is allowed to be transmitted in a radio resource block determined by the second signaling.

In one embodiment, a third signaling comprises a first field; the first field comprised in the third signaling indicates that the first bit block is allowed to be transmitted in a radio resource block determined by the second signaling.

In one embodiment, a third signaling indicates that the first-type HARQ-ACK is allowed to be transmitted in a radio resource block determined by the second signaling.

In one embodiment, a third signaling comprises a first field; the first field comprised in the third signaling indicates that the first-type HARQ-ACK is allowed to be transmitted in a radio resource block determined by the second signaling.

In one embodiment, the radio resource block determined by the second signaling is the first radio resource block.

In one embodiment, the radio resource block determined by the second signaling is the fourth radio resource block.

In one embodiment, a third signaling comprises a first field.

In one embodiment, the first field is used to determine whether UCIs of different priorities are allowed to be multiplexed into a same channel.

In one embodiment, the first field is used to determine whether HARQ-ACKs of different priorities are allowed to be multiplexed into a same channel.

In one embodiment, the first field in the third signaling is used to determine whether UCIs of different priorities are allowed to be multiplexed into a same channel.

In one embodiment, the first field in the third signaling is used to determine whether HARQ-ACKs of different priorities are allowed to be multiplexed into a same channel.

In one embodiment, the first field is used to determine whether UCIs of different types are allowed to be multiplexed into a same channel.

In one embodiment, the first field is used to determine whether HARQ-ACKs of different types are allowed to be multiplexed into a same channel.

In one embodiment, the first field in the third signaling is used to determine whether UCIs of different types are allowed to be multiplexed into a same channel.

In one embodiment, the first field in the third signaling is used to determine whether HARQ-ACKs of different types are allowed to be multiplexed into a same channel.

In one embodiment, the first field comprises one bit.

In one embodiment, the first field comprises 2 bits.

In one embodiment, the first field comprises multiple bits.

In one embodiment, the third signaling is the first signaling.

In one embodiment, the third signaling is the second signaling.

In one embodiment, the third signaling is dynamically configured.

In one embodiment, the third signaling comprises a layer-1 signaling.

In one embodiment, the third signaling comprises a layer-1 control signaling.

In one embodiment, the third signaling comprises a physical-layer signaling.

In one embodiment, the third signaling comprises one or multiple fields in a physical-layer signaling.

In one embodiment, the third signaling comprises a higher-layer signaling.

In one embodiment, the third signaling comprises one or multiple fields in a higher-layer signaling.

In one embodiment, the third signaling comprises an RRC signaling.

In one embodiment, the third signaling comprises a MAC CE signaling.

In one embodiment, the third signaling comprises one or multiple fields in an RRC signaling.

In one embodiment, the third signaling comprises one or multiple fields in a MAC CE signaling.

In one embodiment, the third signaling comprises a DCI.

In one embodiment, the third signaling comprises one or multiple fields in a DCI.

In one embodiment, the third signaling comprises an SCI.

In one embodiment, the third signaling comprises one or multiple fields in an SCI.

In one embodiment, the third signaling comprises one or multiple fields in an IE.

In one embodiment, a start time of the first radio resource block is not earlier than a first time.

In one embodiment, a start time of the fourth radio resource block is not earlier than a first time.

In one embodiment, a start time of the fourth radio resource block is earlier than a first time.

In one embodiment, the target radio resource block is the first radio resource block; a start time of the first radio resource block is not earlier than a first time; the advantages of the above constraints are in being conducive for the first node to cancel a transmission of all or partial signals carrying the second bit block in the second radio resource block.

In one embodiment, the first signaling is used to determine the first time.

In one embodiment, the first time is later than an end time of the first signaling in time domain; a time interval between the first time and the end time of the first signaling in time domain is equal to time-domain resources occupied by P multicarrier symbols.

In one embodiment, the first time is later than an end time of a physical-layer channel carrying the first signaling in time domain; a time interval between the first time and the end time of the physical-layer channel carrying the first signaling in time domain is equal to time-domain resources occupied by P multicarrier symbols.

In one embodiment, the physical-layer channel bearing the first signaling comprises a PDCCH.

In one embodiment, the physical-layer channel bearing the first signaling comprises an sPDCCH.

In one embodiment, the physical-layer channel bearing the first signaling comprises an NB-PDCCH.

In one embodiment, the first time is later than an end time of a physical-layer channel scheduled by the first signaling in time domain; a time interval between the first time and the end time of the physical-layer channel scheduled by the first signaling in time domain is equal to time-domain resources occupied by P multicarrier symbols.

In one embodiment, the physical-layer channel scheduled by the first signaling comprises a PDSCH.

In one embodiment, the physical-layer channel scheduled by the first signaling comprises an sPDSCH.

In one embodiment, the physical-layer channel scheduled by the first signaling comprises an NB-PDSCH.

In one embodiment, the second signaling is used to determine the first time.

In one embodiment, the first time is later than an end time of the second signaling in time domain; a time interval between the first time and the end time of the second signaling in time domain is equal to time-domain resources occupied by P multicarrier symbols.

In one embodiment, the first time is later than an end time of a physical-layer channel bearing the second signaling in time domain; a time interval between the first time and the end time of the physical-layer channel bearing the second signaling in time domain is equal to time-domain resources occupied by P multicarrier symbols.

In one embodiment, the physical-layer channel bearing the second signaling comprises a PDCCH.

In one embodiment, the physical-layer channel bearing the second signaling comprises an sPDCCH.

In one embodiment, the physical-layer channel bearing the second signaling comprises an NB-PDCCH.

In one embodiment, the first time is later than an end time of a physical-layer channel scheduled by the second signaling in time domain; a time interval between the first time and the end time of the physical-layer channel scheduled by the second signaling in time domain is equal to time-domain resources occupied by P multicarrier symbols.

In one embodiment, the physical-layer channel scheduled by the second signaling comprises a PDSCH.

In one embodiment, the physical-layer channel scheduled by the second signaling comprises an sPDSCH.

In one embodiment, the physical-layer channel scheduled by the second signaling comprises an NB-PDSCH.

In one embodiment, P is equal to 1.

In one embodiment, P is greater than 1.

In one embodiment, UE processing capability is used to determine the first time.

In one embodiment, time-domain resources occupied by the P multicarrier symbols are equal to Tproc,2 +d1.

In one subembodiment of the above embodiment, the Tproc,2 corresponds to UE processing capability of the first node.

In one subembodiment of the above embodiment, for the definition of Tproc,2, refer to section 6.4 in 3GPP TS38.214.

In one subembodiment of the above embodiment, d1 is equal to 0.

In one subembodiment of the above embodiment, d1 is equal to time-domain resources occupied by one multicarrier symbol.

In one subembodiment of the above embodiment, d1 is equal to time-domain resources occupied by two multicarrier symbol.

In one subembodiment of the above embodiment, d1 is reported by UE capability.

In one embodiment, the first signaling is used to determine the first radio resource block.

In one embodiment, the first signaling is used to determine the fourth radio resource block.

In one embodiment, the second signaling is used to determine the first radio resource block.

In one embodiment, the second signaling is used to determine the fourth radio resource block.

In one embodiment, the first signaling is used to determine the fifth radio resource block.

In one embodiment, the second signaling is used to determine the third radio resource block.

In one embodiment, a first priority is different from a second priority.

In one embodiment, a first priority and a second priority are respectively different priorities.

In one embodiment, the first signaling indicates the first priority, and the second signaling indicates the second priority.

In one embodiment, the first signaling indicates the second priority, and the second signaling indicates the first priority.

In one embodiment, all information bits comprised in the first bit block are information bits of the first priority.

In one embodiment, all information bits comprised in the first bit block are information bits of the second priority.

In one embodiment, all information bits comprised in the third bit block are information bits of the first priority.

In one embodiment, all information bits comprised in the third bit block are information bits of the second priority.

In one embodiment, a priority of the sixth bit block is the same as a priority of the first bit block.

In one embodiment, a priority of the seventh bit block is the same as a priority of the third bit block.

In one embodiment, all information bits comprised in the sixth bit block are information bits of the first priority.

In one embodiment, all information bits comprised in the sixth bit block are information bits of the second priority.

In one embodiment, all information bits comprised in the seventh bit block are information bits of the first priority.

In one embodiment, all information bits comprised in the seventh bit block are information bits of the second priority.

In one embodiment, the first priority is a priority greater than the second priority.

In one embodiment, the first priority and the second priority respectively correspond to different service types.

In one embodiment, both the first priority and the second priority are PHY priorities.

In one embodiment, a priority index of the first priority is equal to 1, and a priority index of the second priority is equal to 0.

In one embodiment, a priority index of the first priority is equal to 0, and a priority index of the second priority is equal to 1.

In one embodiment, a priority of the first bit block is a first priority in the first priority and a second priority, and a priority of the third bit block is the second priority in the first priority and the second priority.

In one embodiment, a priority of the first bit block is a second priority in the first priority and the second priority, and a priority of the third bit block is the first priority in the first priority and the second priority.

In one embodiment, the first-type HARQ-ACK corresponds to the first priority, and the second-type HARQ-ACK corresponds to the second priority.

In one embodiment, the first-type HARQ-ACK corresponds to the second priority, and the second-type HARQ-ACK corresponds to the first priority.

In one embodiment, the first bit block and the third bit block respectively comprise UCIs of different priorities.

In one embodiment, the first signaling indicates a priority in a first priority set; a priority of the first bit block and the priority in the first priority set indicated by the first signaling are the same.

In one embodiment, the second signaling indicates a priority in a first priority set; a priority of the third bit block and the priority in the first priority set indicated by the second signaling are the same.

In one embodiment, a priority of the first bit block is a priority in a first priority set.

In one embodiment, a priority of the second bit block is a priority in a first priority set.

In one embodiment, a priority of the third bit block is a priority in a first priority set.

In one embodiment, a QoS value corresponding to a bit block transmitted on sidelink is used to determine a priority of the third bit block.

In one embodiment, a priority corresponding to a bit block transmitted on an uplink is used to determine a priority of the first bit block.

In one subembodiment of the above embodiment, the bit block transmitted on sidelink is transmitted in a PSSCH.

In one embodiment, a priority indicated by a signaling transmitted on sidelink is used to determine a priority of the third bit block.

In one embodiment, a priority indicated by the first signaling transmitted on an uplink is used to determine a priority of the first bit block.

In one subembodiment of the above embodiment, the signaling transmitted on sidelink comprises an SCI.

In one subembodiment of the above embodiment, the signaling transmitted on sidelink comprises one or multiple fields in an SCI.

In one embodiment, the second signaling indicates transmitting a positive integer number of second-type HARQ-ACK information bit(s) in a first time-domain element.

In one embodiment, the second signaling indicates that the first node transmits a positive integer number of second-type HARQ-ACK information bit(s) in a first time-domain element.

In one embodiment, the third bit block comprises the second-type HARQ-ACK information bit transmitted in the first time-domain element.

In one embodiment, the first time-domain element comprises a slot.

In one embodiment, the first time-domain element comprises a sub-slot.

In one embodiment, the first time-domain element comprises one multicarrier symbol.

In one embodiment, the first priority set comprises multiple priorities.

In one embodiment, the first priority set comprises the first priority and the second priority.

In one embodiment, the first priority set comprises multiple priorities corresponding to different QoS values.

In one embodiment, the first priority set comprises multiple priorities corresponding to different QoS value ranges.

In one embodiment, the second bit block comprises a TB.

In one embodiment, the second bit block comprises a CB.

In one embodiment, the second bit block comprises a CBG.

In one embodiment, the second bit block comprises a UCI.

In one embodiment, the second bit block comprises an SR.

In one embodiment, the second bit block comprises a CSI reporting.

In one embodiment, a priority of the second bit block corresponds to priority index 1 or priority index 0.

In one embodiment, a priority of the second bit block is the first priority or the second priority.

In one embodiment, a priority of the second bit block is a priority related to QoS.

### Embodiment 5B

Embodiment 5B illustrates a flowchart of radio signal transmission according to one embodiment in the present application, as shown in FIG. 5. In FIG. 5B, a first node U1B and a second node U2B are in communications via an air interface.

The first node U1B receives a first signaling in step S511B; transmits a first signal in a target radio resource block in step S512B.

The second node U2B transmits a first signaling in step S521B; receives a first signal in a target radio resource block in step S522B.

In embodiment 5B, the first signal carries a bit block generated by a first bit block; the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one subembodiment of embodiment 5B, when the first radio resource block group comprises a radio resource block corresponding to the first priority, a priority corresponding to the first bit block is not used to determine the target radio resource block; when the first radio resource block group does not comprise a radio resource block corresponding to the first priority, a priority corresponding to the first bit block is used to determine the target radio resource block.

In one subembodiment of embodiment 5B, a second priority set comprises multiple priorities; the priority corresponding to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group.

In one subembodiment of embodiment 5B, the first radio resource block group does not comprise a radio resource block corresponding to the first priority; when the priority corresponding to the first bit block is not the first priority, the target radio resource block is a radio resource block in the first radio resource block group, and a bit block generated by the first bit block is transmitted in the radio resource block in the first radio resource block group; when the priority corresponding to the first bit block is the first priority, the target radio resource block is the second radio resource block, and a bit block generated by the first bit block is transmitted in the second radio resource block.

In one subembodiment of embodiment 5B, when the first radio resource block group does not comprise a radio resource block corresponding to the first priority, a size relation between a value of the priority corresponding to the first bit block and a first threshold is used to determine the target radio resource block.

In one subembodiment of embodiment 5B, a value of the priority corresponding to the first bit block is less than a second threshold; the second threshold is greater than the first threshold.

In one subembodiment of embodiment 5B, when the first radio resource block group does not comprise a radio resource block corresponding to the first priority, a bit block generated by the first bit block is transmitted in the second radio resource block; when the first radio resource block group comprises a radio resource block corresponding to the first priority, a priority corresponding to the first bit block is used to determine the target radio resource block.

In one embodiment, the first node U1B is the first node in the present application.

In one embodiment, the second node U2B is the second node in the present application.

In one embodiment, the first node U1B is a UE.

In one embodiment, the second node U2B is a base station.

In one embodiment, the second node U2B is a UE.

In one embodiment, an air interface between the second node U2B and the first node U1B is a Uu interface.

In one embodiment, an air interface between the second node U2B and the first node U1B comprises a cellular link.

In one embodiment, an air interface between the second node U2B and the first node U1B is a PC5 interface.

In one embodiment, an air interface between the second node U2B and the first node U1B comprises a Sidelink.

In one embodiment, an air interface between the second node U2B and the first node U1B comprises a radio interface between a base station and a UE.

In one embodiment, a second radio resource block group comprises the first radio resource block group and the second radio resource block.

In one embodiment, all radio resource blocks in the second radio resource block group satisfy conditions in a second condition set.

In one embodiment, conditions in the second condition set are related to UE processing time.

In one embodiment, conditions in the second condition set comprise timeline conditions related to the second radio resource block group, and for the specific description of the timeline condition, refer to section 9.2.5 in 3GPP TS38.213.

In one embodiment, conditions in the second condition set comprise: a time interval between a first time and a start time of a first multicarrier symbol of an earliest radio resource block in the second radio resource block group is not less than a third value.

In one subembodiment of the above embodiment, the third value is related to UE processing time.

In one subembodiment of the above embodiment, at least one of, or is used to determine the third value, and for specific definitions of the, the, the and the, refer to section 9.2.5 in 3GPP TS38. 213.

In one subembodiment of the above embodiment, the first time is an end time of a transmitted downlink physical-layer channel.

In one subembodiment of the above embodiment, the transmitted downlink physical-layer channel comprises a PDSCH or a PDCCH.

In one embodiment, a start time of an earliest radio resource block in the second radio resource block group is not later than a start time of any radio resource block other than the earliest radio resource block in the second radio resource block group.

In one embodiment, a second priority set comprises multiple priorities; a priority corresponds to the first bit block is a priority in the second priority set.

In one embodiment, the first bit block corresponds to a priority in the second priority set.

In one embodiment, a priority corresponding to the first bit block is a priority related to priorities of one or multiple bit blocks transmitted on sidelink.

In one embodiment, a priority corresponding to the first bit block is a priority related to QoSs of one or multiple bit blocks transmitted on sidelink.

In one embodiment, the second priority set comprises multiple priorities.

In one embodiment, the second priority set is different from the first priority set.

In one embodiment, the second priority set is the same as the first priority set.

In one embodiment, the second priority set is the first priority set.

In one embodiment, each priority in the second priority set respectively corresponds to a QoS value.

In one embodiment, a priority corresponding to the second radio resource block is the same as a priority corresponding to the first bit block.

In one embodiment, each priority in the second priority set respectively corresponds to a value.

In one embodiment, each priority in the second priority set respectively corresponds to a priority value.

In one embodiment, the phrase of a bit block generated by the first bit block being always transmitted in a radio resource block corresponding to the first priority comprised in the first radio resource block group comprises: the target radio resource block is a radio resource block corresponding to the first priority comprised in the first radio resource block group.

In one embodiment, the phrase of a bit block generated by the first bit block being always transmitted in a radio resource block corresponding to the first priority comprised in the first radio resource block group comprises: multiple radio resource blocks corresponding to the first priority and comprised in the first radio resource block group; the target radio resource block is one of the multiple radio resource blocks corresponding to the first priority comprised in the first radio resource block group.

In one embodiment, the phrase of a bit block generated by the first bit block being always transmitted in a radio resource block corresponding to the first priority comprised in the first radio resource block group comprises: a radio resource block corresponding to the first priority and another radio resource block corresponding to the second radio priority comprised in the first radio resource block group; the target radio resource block is the radio resource block corresponding to the first priority comprised in the first radio resource block group.

In one embodiment, the phrase of a bit block generated by the first bit block being always transmitted in a radio resource block corresponding to the first priority comprised in the first radio resource block group comprises: the radio resource block corresponding to the first priority comprised in the first radio resource block is reserved for a third physical-layer channel; the bit block generated by the first bit block is always transmitted on the third physical-layer channel.

In one embodiment, a second priority set comprises multiple priorities; a priority corresponds to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group; the radio resource block corresponding to the first priority comprised in the first radio resource block group is an earliest radio resource block in all radio resource blocks corresponding to the first priority comprised in the first radio resource block group.

In one embodiment, the second radio resource block is reserved for a second physical-layer channel; when the target radio resource block is a radio resource block in the first radio resource block group, the second physical-layer channel is not transmitted.

In one embodiment, a radio resource block in the first radio resource block group is reserved for a first physical-layer channel; when the target radio resource block is the second radio resource block, the first physical-layer channel is not transmitted.

In one embodiment, the first physical-layer channel in the present application is a physical-layer channel.

In one embodiment, the second physical-layer channel in the present application is a physical-layer channel.

In one embodiment, the first radio resource block group comprises multiple radio resource blocks; the multiple radio resource blocks comprised in the first radio resource block group belong to a serving cell.

In one embodiment, the first radio resource block group comprises multiple radio resource blocks; the multiple radio resource blocks comprised in the first radio resource block group belong to multiple serving cells.

### Embodiment 5C

Embodiment 5C illustrates a flowchart of radio signal transmission according to one embodiment in the present application, as shown in FIG. 5. In FIG. 5C, a first node U1C and a second node U2C are in communications via an air interface. In particular, the sequence between {S521C, S511C} and {S522C, S512C} in FIG. 5C does not represent a specific chronological sequence.

The first node U1C receives a second signaling in step S511C; receives a first signaling in step S512C; transmits a first signal in a first radio resource block in step S513C.

The second node U2C transmits a second signaling in step S521C; transmits a first signaling in step S522C; receives a first signal in a first radio resource block in step S523C.

In embodiment 5C, the first signal carries a first bit block; the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal; the second field in the first signaling is used to determine whether a bit block generated by the second bit block is used to determine a first radio resource block set; the first radio resource block is a radio resource block in the first radio resource block set.

In one subembodiment of embodiment 5C, a third radio resource block is reserved for the first bit block; a second radio resource block is reserved for the second bit block; the third radio resource block and the second radio resource block are overlapping in time domain.

In one subembodiment of embodiment 5C, the number of bit(s) related to the second bit block and carried by the first signal is equal to one of K candidate numbers; the second field in the first signaling indicates an index of the number of bit(s) related to the second bit block and carried by the first signal among the K candidate numbers; K is greater than 1; when a value of the second field in the first signaling is equal to a first value, the second field in the first signaling indicates that the number of bit(s) related to the second bit block and carried by the first signal is equal to 0; when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

In one subembodiment of embodiment 5C, the second field in the first signaling is used to determine whether a size of the first bit block is used to determine the number of bit(s) related to the second bit block and carried by the first signal.

In one subembodiment of embodiment 5C, the second field in the first signaling is used to determine whether a number of bit(s) of the second-type HARQ-ACK related to the second bit block and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

In one embodiment, the first node U1C is the first node in the present application.

In one embodiment, the second node U2C is the second node in the present application.

In one embodiment, the first node U1C is a UE.

In one embodiment, the second node U2C is a base station.

In one embodiment, the second node U2C is a UE.

In one embodiment, an air interface between the second node U2C and the first node U1C is a Uu interface.

In one embodiment, an air interface between the second node U2C and the first node U1C comprises a cellular link.

In one embodiment, an air interface between the second node U2C and the first node U1C is a PC5 interface.

In one embodiment, an air interface between the second node U2C and the first node U1C comprises a sidelink.

In one embodiment, an air interface between the second node U2C and the first node U1C comprises a radio interface between a base station and a UE.

In one embodiment, a second radio resource block group comprises the third radio resource block and the second radio resource block.

In one embodiment, all radio resource blocks in the second radio resource block group satisfy conditions in a second condition set.

In one embodiment, conditions in the second condition set are related to UE processing time.

In one embodiment, conditions in the second condition set comprise timeline conditions related to the second radio resource block group, and for the specific descriptions of the timeline condition, refer to section 9.2.5 in 3GPP TS38. 213.

In one embodiment, conditions in the second condition set comprise: a time interval between a first time and a start time of a first multicarrier symbol of an earliest radio resource block in the second radio resource block group is not less than a third value.

In one subembodiment of the above embodiment, the third value is related to UE processing time.

In one subembodiment of the above embodiment, the third value is related to UE PDSCH processing capability.

In one subembodiment of the above embodiment, at least one of, or is used to determine the third value, and for specific definitions of the, the, the and the, refer to section 9.2.5 in 3GPP TS38. 213.

In one subembodiment of the above embodiment, the first time is an end time of a transmitted downlink physical-layer channel.

In one subembodiment of the above embodiment, the first time is an end time of a transmitted downlink physical-layer channel; the transmitted downlink physical-layer channel comprises a PDSCH or a PDCCH.

In one embodiment, a method used in the first node comprises: receiving first information; only when the first information indicates that the first signaling comprises the second field; the first signaling comprises the second field, the second field in the first signaling is used to determine a number of bit(s) related to the second bit block and carried by the first signal.

In one embodiment, a method used in the second node comprises: transmitting first information; only when the first information indicates that the first signaling comprises the second field; the first signaling comprises the second field, the second field in the first signaling is used to determine a number of bit(s) related to the second bit block and carried by the first signal.

In one embodiment, the first information (explicitly or implicitly) indicates whether the first signaling comprises the second field.

### Embodiment 5D

Embodiment 5D illustrates a flowchart of radio signal transmission according to one embodiment in the present application, as shown in FIG. 5D. In FIG. 5D, a first node U1D and a second node U2D are in communications via an air interface.

The first node U1D receives a first signaling in step S511D; transmits a first signal in a first time window in step S512D.

The second node U2D transmits a first signaling in step S521D; receives a first signal in a first time window in step S522D.

In embodiment 5D, the first signal carries a first bit block; the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal; the first signaling is used to determine K time windows, K being a positive integer greater than 1; the first time window is one of the K time windows; each of the K time windows is respectively reserved for a physical-layer channel transmission with configured grant used to carry the first bit block; when the number of the time element(s) comprised in the first time window is not greater than a first number, the first signal does not carry a bit block used to determine the RV corresponding to the first signal, and the RV corresponding to the first signal is a first RV; when the number of the time element(s) comprised in the first time window is greater than the first number, the first signal carries a second bit block, and the second bit block is used to determine the RV corresponding to the first signal; when the second bit block is transmitted in the first time window; the second bit block comprises indication information related to channel occupation time.

In one subembodiment of embodiment 5D, K is used to determine the first RV.

In one subembodiment of embodiment 5D, a first time slice comprises the first time window; the first time slice is used to determine the first RV.

In one embodiment, the first node U1D is the first node in the present application.

In one embodiment, the second node U2D is the second node in the present application.

In one embodiment, the first node U1D is a UE.

In one embodiment, the second node U2D is a base station.

In one embodiment, the second node U2D is a UE.

In one embodiment, an air interface between the second node U2D and the first node U 1D is a Uu interface.

In one embodiment, an air interface between the second node U2D and the first node U1D comprises a cellular link.

In one embodiment, an air interface between the second node U2D and the first node U1D is a PC5 interface.

In one embodiment, an air interface between the second node U2D and the first node U1D comprises a Sidelink.

In one embodiment, an air interface between the second node U2D and the first node U1D comprises a radio interface between a base station and a UE.

In one embodiment, when the number of the time element(s) comprised in the first time window is not greater than a first number, the RV corresponding to the first signal is not determined by a bit block carried by the first signal; when the number of the time element(s) comprised in the first time window is greater than the first number, the first signal carries a second bit block, and the second bit block is used to determine the RV corresponding to the first signal.

In one embodiment, when the number of the time element(s) comprised in the first time window is greater than a first number, the RV corresponding to the first signal is not determined by a bit block carried by the first signal; when the number of the time element(s) comprised in the first time window is not greater than the first number, the first signal carries a second bit block, and the second bit block is used to determine the RV corresponding to the first signal.

In one embodiment, when the number of the time element(s) comprised in the first time window is equal to a first number, the RV corresponding to the first signal is not determined by a bit block carried by the first signal; when the number of the time element(s) comprised in the first time window is not equal to the first number, the first signal carries a second bit block, and the second bit block is used to determine the RV corresponding to the first signal.

In one embodiment, when the number of the time element(s) comprised in the first time window is not equal to a first number, the RV corresponding to the first signal is not determined by a bit block carried by the first signal; when the number of the time element(s) comprised in the first time window is equal to the first number, the first signal carries a second bit block, and the second bit block is used to determine the RV corresponding to the first signal.

In one embodiment, when the number of the time element(s) comprised in the first time window belongs to a first number range, the RV corresponding to the first signal is not determined by a bit block carried by the first signal; when the number of the time element(s) comprised in the first time window belongs to a second number range, the first signal carries a second bit block, and the second bit block is used to determine the RV corresponding to the first signal; the first number range is orthogonal to the second number range.

In one embodiment, the phrase of the RV corresponding to the first signal not being determined by a bit block carried by the first signal comprises: the RV corresponding to the first signal is unrelated to any bit block carried by the first signal.

In one embodiment, the phrase of the RV corresponding to the first signal being not determined by a bit block carried by the first signal comprises: the first signal not carrying any bit block indicating the RV corresponding to the first signal.

In one embodiment, the phrase of the RV corresponding to the first signal being not determined by a bit block carried by the first signal comprises: the first signal does not carry a CG-UCI.

In one embodiment, the phrase of the RV corresponding to the first signal being not determined by a bit block carried by the first signal comprises: the RV corresponding to the first signal is fixed.

In one embodiment, the phrase of the RV corresponding to the first signal being not determined by a bit block carried by the first signal comprises: the RV corresponding to the first signal is pre-defined.

In one embodiment, the phrase of the RV corresponding to the first signal being not determined by a bit block carried by the first signal comprises: the RV corresponding to the first signal is configured by a higher-layer signaling.

In one embodiment, the phrase of the RV corresponding to the first signal being not determined by a bit block carried by the first signal comprises: the RV corresponding to the first signal is configured by an RRC signaling.

In one embodiment, the phrase of the RV corresponding to the first signal being not determined by a bit block carried by the first signal comprises: the RV corresponding to the first signal is configured by a MAC CE signaling.

In one embodiment, the phrase of the RV corresponding to the first signal being not determined by a bit block carried by the first signal comprises: the RV corresponding to the first signal is a Redundancy Version 0.

In one embodiment, the phrase of the RV corresponding to the first signal being not determined by a bit block carried by the first signal comprises: the RV corresponding to the first signal is a Redundancy Version 1.

In one embodiment, the phrase of the RV corresponding to the first signal being not determined by a bit block carried by the first signal comprises: the RV corresponding to the first signal is a Redundancy Version 2.

In one embodiment, the phrase of the RV corresponding to the first signal being not determined by a bit block carried by the first signal comprises: the RV corresponding to the first signal is a Redundancy Version 3.

In one embodiment, when the RV corresponding to the first signal is not determined by a bit block carried by the first signal; the RV corresponding to the first signal is a first RV, and the first signal not carrying any bit block is used to determine the first RV.

In one embodiment, a relation between the first time window and the K time windows is used to determine the first RV.

In one embodiment, an order of the first time window among the K time windows (according to an ascending chronological order of start times of time windows) is used to determine the first RV.

In one embodiment, the first time window is an r-th time window among the K time windows.

In one embodiment, according to an ascending chronological order of start times of time windows, the first time window is an r-th time window among the K time windows.

In one embodiment, the first time window is an r-th time window among the K time windows; a number of time window(s) among the K time windows whose start time(s) is(are) earlier than a start time of the first time window is equal to r−1.

In one embodiment, r is used to determine the first RV.

In one embodiment, r is greater than 1.

In one embodiment, r is not greater than K.

In one embodiment, when r is an odd number, the first RV is RV i1; when r is an even number, the first RV is RV i2; i1 is not equal to i2.

In one embodiment, i1 and the i2 are respectively equal to one of 0, 1, 2 or 3.

In one embodiment, the RV i1 and the RV i2 are configured by a higher-layer signaling.

In one embodiment, the RV i1 and the RV i2 are configured by an RRC signaling.

In one embodiment, the RV i1 and the RV i2 are configured by a MAC CE signaling.

In one embodiment, the RV i1 and the RV i2 are pre-defined.

In one embodiment, the RV i1 and the RV i2 are fixed.

In one embodiment, a first value sequence is used to determine the first RV.

In one embodiment, r and a first value sequence are used together to determine the first RV.

In one embodiment, a first value sequence comprises P values, and the P values are sequentially i_0, i_1, . . . , i_{P−1}; P is greater than 1; a result acquired after executing a modulo operation on the P after subtracting 1 from r is equal to e((r−1) mod P=e), the first RV is RV i_e.

In one embodiment, the first value sequence is configured by a higher-layer signaling.

In one embodiment, the first value sequence is configured by an RRC signaling.

In one embodiment, the first value sequence is configured by a MAC CE signaling.

In one embodiment, the first value sequence is predefined.

In one embodiment, the first value sequence is fixed.

In one embodiment, the first value sequence comprises two values.

In one embodiment, the first value sequence comprises four values.

In one embodiment, the first value sequence comprises two values; the first value sequence is {0,3}.

In one embodiment, the first value sequence comprises four values; the first value sequence is {0,3,0,3}.

In one embodiment, the first value sequence comprises four values; the first value sequence is {0,2,3,1}.

In one embodiment, a signal transmitted in a time window comprising D the time element(s) among the K time windows carries a UCI; D is greater than the first number.

In one embodiment, a signal transmitted in a time window comprising D the time element(s) among the K time windows carries a CG-UCI; D is greater than the first number.

In one embodiment, a signal transmitted in a time window comprising D the time element(s) among the K time windows carries a bit block indicating an RV; D is greater than the first number.

In one embodiment, a signal transmitted in a time window comprising D the time element(s) among the K time windows carries a bit block comprising a Redundancy version field; D is greater than the first number.

In one embodiment, a first signal carries a first bit block, and the first signal is transmitted in a first time window; a first time window is one of K time windows, K is a positive integer greater than 1; the K time windows are respectively reserved for K repetitions of a first bit block; when the number of multicarrier symbol(s) comprised in the first time window is not greater than a first number, the first signal does not carry a bit block used to determine the RV corresponding to the first signal; when the number of multicarrier symbol(s) comprised in the first time window is greater than the first number, the first signal carries a second bit block, and the second bit block is used to determine the RV corresponding to the first signal.

In one subembodiment of the above embodiment, the first time window is reserved for one of K actual repetitions of the first bit block.

In one subembodiment of the above embodiment, the phrase of the first signal not carrying a bit block used to determine the RV corresponding to the first signal comprises: the first signal does not carry a CG-UCI.

In one subembodiment of the above embodiment, the first number is equal to 1.

In one subembodiment of the above embodiment, the second bit block comprises a CG-UCI.

In one subembodiment of the above embodiment, when the number of multicarrier symbol(s) comprised in the first time window is not greater than the first number; the RV corresponding to the first signal is fixed, or the RV corresponding to the first signal is pre-defined, or the RV corresponding to the first signal is configured by an RRC signaling, or, the RV corresponding to the first signal is configured by a MAC CE signaling, or, the RV corresponding to the first signal is configured by a higher-layer signaling.

In one embodiment, the phrase of a number of the time element(s) comprised in the first time window being used to determine whether an RV corresponding to the first signal is determined by a bit block carried by the first signal comprises: the number of the time element(s) comprised in the first time window is used to determine whether an RV corresponding to the first signal is determined by a bit block carried by the first signal or a higher-layer signaling.

In one embodiment, the phrase of a number of the time element(s) comprised in the first time window being used to determine whether an RV corresponding to the first signal is determined by a bit block carried by the first signal comprises: the number of the time element(s) comprised in the first time window is used to determine whether an RV corresponding to the first signal is determined by a bit block carried by the first signal or an RRC signaling.

In one embodiment, the phrase of a number of the time element(s) comprised in the first time window being used to determine whether an RV corresponding to the first signal is determined by a bit block carried by the first signal comprises: the number of the time element(s) comprised in the first time window is used to determine whether an RV corresponding to the first signal is determined by a bit block carried by the first signal or a MAC CE signaling.

In one embodiment, the phrase of a number of the time element(s) comprised in the first time window being used to determine whether an RV corresponding to the first signal is determined by a bit block carried by the first signal comprises: the number of the time element(s) comprised in the first time window is used to determine whether an RV corresponding to the first signal is determined by a bit block carried by the first signal or pre-defined.

### Embodiment 6A

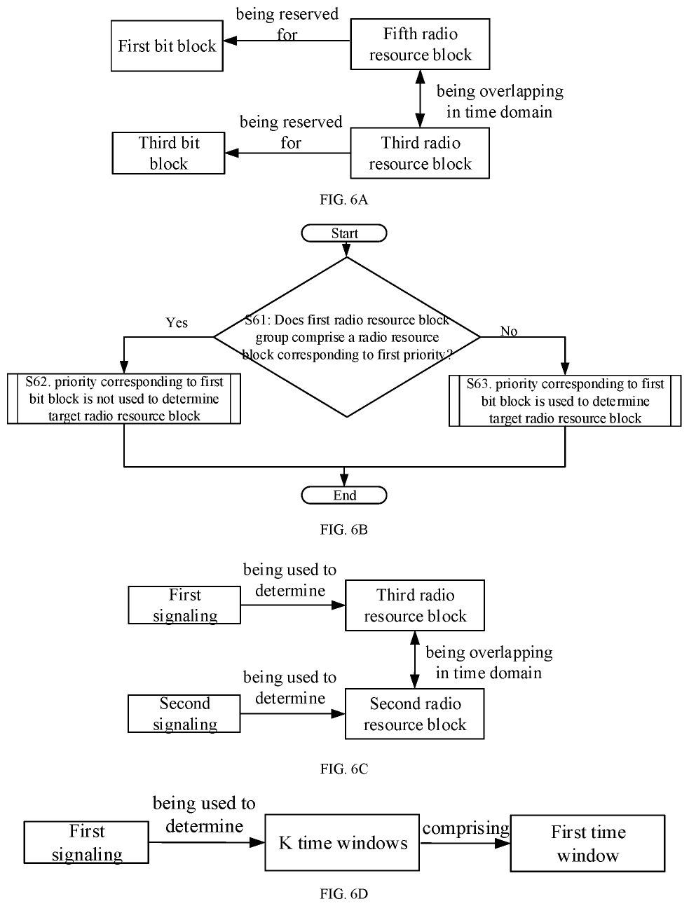

Embodiment 6A illustrates a schematic diagram of relations among a fifth radio resource block, a first bit block, a third radio resource block and a third bit block according to one embodiment of the present application, as shown in FIG. 6A.

In embodiment 6A, a fifth radio resource block is reserved for a first bit block; a third radio resource block is reserved for a third bit block; the fifth radio resource block overlaps with the third time-frequency resource block in time domain.

In one embodiment, the fifth radio resource block is the fourth radio resource block in the present application.

In one embodiment, the fourth radio resource block in the present application is the fifth radio resource block.

In one embodiment, the fifth radio resource block is not the fourth radio resource block in the present application.

In one embodiment, the fourth radio resource block in the present application is not the fifth radio resource block.

In one embodiment, the fifth radio resource block and the second radio resource block are orthogonal in time domain.

In one embodiment, the second radio resource block and the third radio resource block are orthogonal in time domain.

In one embodiment, a fifth radio resource block is reserved for the sixth bit block in the present application.

In one embodiment, a third radio resource block is reserved for the seventh bit block in the present application.

In one embodiment, the third radio resource block comprises a positive integer number of RE(s) in time-frequency domain.

In one embodiment, the third radio resource block comprises a positive integer number of sub-carrier symbol(s) in frequency domain.

In one embodiment, the third radio resource block comprises a positive integer number of PRB(s) in frequency domain.

In one embodiment, the third radio resource block comprises a positive integer number of RB(s) in frequency domain.

In one embodiment, the third radio resource block comprises a positive integer number of multicarrier symbol(s) in time domain.

In one embodiment, the third radio resource block comprises a positive integer number of slot(s) in time domain.

In one embodiment, the third radio resource block comprises a positive integer number of sub-slot(s) in time domain.

In one embodiment, the third radio resource block comprises a positive integer number of ms(s) in time domain.

In one embodiment, the third radio resource block comprises a positive integer number of continuous multicarrier symbol(s) in time domain.

In one embodiment, the third radio resource block comprises a positive integer number of discontinuous slot(s) in time domain.

In one embodiment, the third radio resource block comprises a positive integer number of continuous slot(s) in time domain.

In one embodiment, the third radio resource block comprises a positive integer number of subframe(s) in time domain.

In one embodiment, the third radio resource block is configured by a physical-layer signaling.

In one embodiment, the third radio resource block is configured by a higher-layer signaling.

In one embodiment, the third radio resource block is configured by an RRC signaling.

In one embodiment, the third radio resource block is configured by a MAC CE signaling.

In one embodiment, the third radio resource block is reserved for a physical-layer channel.

In one embodiment, the third radio resource block comprises radio resources reserved for a physical-layer channel.

In one embodiment, the third radio resource block comprises radio resources occupied by a physical-layer channel.

In one embodiment, the third radio resource block comprises time-frequency resources occupied by a physical-layer channel in time-frequency domain.

In one embodiment, the third radio resource block comprises time-frequency resources reserved for a physical-layer channel in time-frequency domain.

In one embodiment, the third radio resource block comprises a PUCCH resource.

In one embodiment, the third radio resource block comprises a PUCCH resource in a PUCCH resource set.

In one embodiment, the second signaling indicates the third radio resource block.

In one embodiment, the second signaling explicitly indicates the third radio resource block.

In one embodiment, the second signaling implicitly indicates the third radio resource block.

In one embodiment, the fifth radio resource block comprises a positive integer number of RE(s) in time-frequency domain.

In one embodiment, the fifth radio resource block comprises a positive integer number of sub-carrier symbol(s) in frequency domain.

In one embodiment, the fifth radio resource block comprises a positive integer number of PRB(s) in frequency domain.

In one embodiment, the fifth radio resource block comprises a positive integer number of RB(s) in frequency domain.

In one embodiment, the fifth radio resource block comprises a positive integer number of multicarrier symbol(s) in time domain.

In one embodiment, the fifth radio resource block comprises a positive integer number of slot(s) in time domain.

In one embodiment, the fifth radio resource block comprises a positive integer number of sub-slot(s) in time domain.

In one embodiment, the fifth radio resource block comprises a positive integer number of ms(s) in time domain.

In one embodiment, the fifth radio resource block comprises a positive integer number of continuous multicarrier symbol(s) in time domain.

In one embodiment, the fifth radio resource block comprises a positive integer number of discontinuous slot(s) in time domain.

In one embodiment, the fifth radio resource block comprises a positive integer number of continuous slot(s) in time domain.

In one embodiment, the fifth radio resource block comprises a positive integer number of subframe(s) in time domain.

In one embodiment, the fifth radio resource block is configured by a physical-layer signaling.

In one embodiment, the fifth radio resource block is configured by a higher-layer signaling.

In one embodiment, the fifth radio resource block is configured by an RRC signaling.

In one embodiment, the fifth radio resource block is configured by a MAC CE signaling.

In one embodiment, the fifth radio resource block is reserved for a physical-layer channel.

In one embodiment, the fifth radio resource block comprises radio resources reserved for a physical-layer channel.

In one embodiment, the fifth radio resource block comprises radio resources occupied by a physical-layer channel.

In one embodiment, the fifth radio resource block comprises time-frequency resources occupied by a physical-layer channel in time-frequency domain.

In one embodiment, the fifth radio resource block comprises time-frequency resources reserved for a physical-layer channel in time-frequency domain.

In one embodiment, the fifth radio resource block comprises a PUCCH resource.

In one embodiment, the fifth radio resource block comprises a PUCCH resource in a PUCCH resource set.

In one embodiment, the first signaling indicates the fifth radio resource block.

In one embodiment, the first signaling explicitly indicates the fifth radio resource block.

In one embodiment, the first signaling implicitly indicates the fifth radio resource block.

### Embodiment 6B

Embodiment 6B illustrates a schematic diagram of a flowchart of judging whether a priority corresponding to a first bit block is used to determine a target radio resource block according to one embodiment of the present application, as shown in FIG. 6B.

In embodiment 6B, the first node in the present application judges whether a first radio resource block group comprises a radio resource block corresponding to a first priority in step S61; if yes, determines that a priority corresponding to a first bit block is not used to determine a target radio resource block in step S62; otherwise, determines that a priority corresponding to a first bit block is used to determine a target radio resource block in step S63.

In one embodiment, when the first radio resource block group comprises a radio resource block corresponding to the first priority, a priority corresponding to the first bit block is used to determine the target radio resource block; when the first radio resource block group does not comprise a radio resource block corresponding to the first priority, a priority corresponding to the first bit block is not used to determine a target radio resource block.

In one embodiment, the phrase in the present application of the first radio resource block group not comprising a radio resource block corresponding to the first priority comprises: the first radio resource block group does not comprise any radio resource block corresponding to the first priority.

In one embodiment, the phrase in the present application of the first radio resource block group not comprising a radio resource block corresponding to the first priority comprises: all radio resource blocks in the first radio resource block group correspond to a priority different from the first priority.

In one embodiment, the phrase in the present application of the first radio resource block group not comprising a radio resource block corresponding to the first priority comprises: all radio resource blocks in the first radio resource block group do not correspond to the first priority.

In one embodiment, when a priority corresponding to a radio resource block in the first radio resource block group is not the first priority, a priority corresponding to the radio resource block in the first radio resource block group is the second priority.

In one embodiment, the first radio resource block group comprises a radio resource block corresponding to the first priority; the first radio resource block group comprises another radio resource block corresponding to the second priority.

In one embodiment, the first radio resource block group comprises a radio resource block corresponding to the first priority; the first radio resource block group does not comprise a radio resource block corresponding to the second priority.

In one embodiment, the first radio resource block group does not comprise a radio resource block corresponding to the first priority; the first radio resource block group comprises a radio resource block corresponding to the second priority.

### Embodiment 6C

Embodiment 6C illustrates a schematic diagram of relations among a first signaling, a third radio resource block, a second signaling and a second radio resource block according to one embodiment of the present application, as shown in FIG. 6C.

In embodiment 6C, a first signaling is used to determine a third radio resource block; a second signaling is used to determine a second radio resource block; the third radio resource block and the second radio resource block are overlapping in time domain.

In one embodiment, a transmitting end of the first signal drops a signal transmission in the second radio resource block.

In one embodiment, the second radio resource block comprises a positive integer number of sub-carrier symbol(s) in frequency domain.

In one embodiment, the second radio resource block comprises a positive integer number of PRB(s) in frequency domain.

In one embodiment, the second radio resource block comprises a positive integer number of RB(s) in frequency domain.

In one embodiment, the second radio resource block comprises a positive integer number of multicarrier symbol(s) in time domain.

In one embodiment, the second radio resource block comprises a positive integer number of slot(s) in time domain.

In one embodiment, the second radio resource block comprises a positive integer number of sub-slot(s) in time domain.

In one embodiment, the second radio resource block comprises a positive integer number of ms(s) in time domain.

In one embodiment, the second radio resource block comprises a positive integer number of discontinuous slot(s) in time domain.

In one embodiment, the second radio resource block comprises a positive integer number of continuous slot(s) in time domain.

In one embodiment, the second radio resource block comprises a positive integer number of subframe(s) in time domain.

In one embodiment, the second radio resource block is configured by a higher-layer signaling.

In one embodiment, the second radio resource block is configured by an RRC signaling.

In one embodiment, the second radio resource block is configured by a MAC CE signaling.

In one embodiment, the second radio resource block is reserved for a physical-layer channel.

In one embodiment, the second radio resource block comprises radio resources reserved for a physical-layer channel.

In one embodiment, the second radio resource block comprises radio resources occupied by a physical-layer channel.

In one embodiment, the second radio resource block comprises time-frequency resources occupied by a physical-layer channel in time-frequency domain.

In one embodiment, the second radio resource block comprises time-frequency resources reserved for a physical-layer channel in time-frequency domain.

In one embodiment, the second radio resource block comprises a PUCCH resource.

In one embodiment, the second radio resource block corresponds to the second index.

In one embodiment, the second radio resource block is reserved for a physical-layer channel corresponding the second index.

In one embodiment, the second radio resource block is reserved for a PUCCH corresponding the second index.

In one embodiment, the second signaling is used to determine the second radio resource block.

In one embodiment, the second signaling indicates the second radio resource block.

In one embodiment, the second signaling indicates time-domain resources comprised in the second radio resource block.

In one embodiment, the second signaling indicates frequency-domain resources comprised in the second radio resource block.

In one embodiment, the second signaling indicates the second radio resource block from a second radio resource block set.

In one embodiment, the second radio resource block set comprises a PUCCH resource set.

In one embodiment, the second signaling indicates an index of the second radio resource block in the second radio resource block set.

In one embodiment, N number range(s) corresponds (respectively correspond) to N radio resource block set(s); a second number range is one of the N number range(s); a total number of bit(s) comprised in the second bit block is equal to a number in the second number range; a second radio resource block set is a radio resource block set corresponding to the second number range among the N radio resource block set(s).

In one embodiment, each of the N radio resource block set(s) comprises a PUCCH resource set.

In one embodiment, the third radio resource block comprises a positive integer number of sub-carrier symbol(s) in frequency domain.

In one embodiment, the third radio resource block comprises a positive integer number of PRB(s) in frequency domain.

In one embodiment, the third radio resource block comprises a positive integer number of RB(s) in frequency domain.

In one embodiment, the third radio resource block comprises a positive integer number of multicarrier symbol(s) in time domain.

In one embodiment, the third radio resource block comprises a positive integer number of slot(s) in time domain.

In one embodiment, the third radio resource block comprises a positive integer number of sub-slot(s) in time domain.

In one embodiment, the third radio resource block comprises a positive integer number of ms(s) in time domain.

In one embodiment, the third radio resource block comprises a positive integer number of discontinuous slot(s) in time domain.

In one embodiment, the third radio resource block comprises a positive integer number of continuous slot(s) in time domain.

In one embodiment, the third radio resource block comprises a positive integer number of subframe(s) in time domain.

In one embodiment, the third radio resource block is configured by a higher-layer signaling.

In one embodiment, the third radio resource block is configured by an RRC signaling.

In one embodiment, the third radio resource block is configured by a MAC CE signaling.

In one embodiment, the third radio resource block is reserved for a physical-layer channel.

In one embodiment, the third radio resource block comprises radio resources reserved for a physical-layer channel.

In one embodiment, the third radio resource block comprises radio resources occupied by a physical-layer channel.

In one embodiment, the third radio resource block comprises time-frequency resources occupied by a physical-layer channel in time-frequency domain.

In one embodiment, the third radio resource block comprises time-frequency resources reserved for a physical-layer channel in time-frequency domain.

In one embodiment, the third radio resource block comprises a PUCCH resource.

In one embodiment, the third radio resource block corresponds to the second index.

In one embodiment, the third radio resource block is reserved for a physical-layer channel corresponding the first index.

In one embodiment, the third radio resource block is reserved for a PUCCH corresponding the first index.

In one embodiment, the first signaling is used to determine the third radio resource block.

In one embodiment, the first signaling indicates the third radio resource block.

In one embodiment, the first signaling indicates time-domain resources comprised in the third radio resource block.

In one embodiment, the first signaling indicates frequency-domain resources comprised in the third radio resource block.

In one embodiment, the first signaling indicates the third radio resource block from a third radio resource block set.

In one embodiment, the third radio resource block set comprises a PUCCH resource set.

In one embodiment, the third signaling indicates an index of the third radio resource block in the third radio resource block set.

In one embodiment, M number range(s) corresponds (respectively correspond) to M radio resource block set(s); a third number range is one of the M number range(s); a number of bit(s) comprised in the first bit block is equal to a number in the third number range; a third radio resource block set is a radio resource block set corresponding to the third number range among the M radio resource block set(s).

In one embodiment, each of the M radio resource block set(s) comprises a PUCCH resource set.

In one embodiment, the third radio resource block and the second radio resource block are overlapping in frequency domain.

In one embodiment, the third radio resource block and the second radio resource block are overlapping or orthogonal in frequency domain.

In one embodiment, the second radio resource block is reserved for the second bit block; only when the third radio resource block and the second radio resource block are overlapping in time domain, the second field in the first signaling can be used to determine the number of bit(s) related to the second bit block and carried by the first signal.

In one subembodiment of the above embodiment, when the third radio resource block and the second radio resource block are orthogonal in time domain, the first signal does not carry any bit related to the second bit block.

In one embodiment, the second radio resource block set comprises one or multiple radio resource blocks.

In one embodiment, the third radio resource block set comprises one or multiple radio resource blocks.

### Embodiment 6D

Embodiment 6D illustrates a schematic diagram of relations among a first signaling, K time windows and a first time window according to one embodiment of the present application, as shown in FIG. 6D

In embodiment 6D, a first signaling is used to determine K time window, and K is a positive integer greater than 1; a first time window is one of the K time windows.

In one subembodiment of embodiment 6D, each of the K time windows is respectively reserved for a physical-layer channel transmission with configured grant used to carry the first bit block in the present application.

In one embodiment, the first signaling explicitly indicate the K time windows.

In one embodiment, the first signaling implicitly indicate the K time windows.

In one embodiment, information indicated by the first signaling is used to infer the K time windows.

In one embodiment, the first signaling and a signaling other than the first signaling are used together to determine the K time windows.

In one embodiment, any of the K time windows is a continuous duration.

In one embodiment, any of the K time windows comprises a positive integer number of time element(s).

In one embodiment, any of the K time windows comprises one or multiple continuous the time elements.

In one embodiment, any of the K time units comprises a slot.

In one embodiment, any of the K time units comprises a positive integer number of slot(s).

In one embodiment, any of the K time units comprises a sub-slot.

In one embodiment, a length of any of the K time windows is not greater than one slot.

In one embodiment, the K time windows are mutually orthogonal to each other.

In one embodiment, there exist numbers of the time elements comprised in two of the K time windows being not equal.

In one embodiment, there exist numbers of the time elements comprised in two of the K time windows being equal.

In one embodiment, there exists one of the K time windows only comprising the time element.

In one embodiment, there exists one of the K time windows comprising multiple time elements.

In one embodiment, any of the K time windows comprises more than one the time element.

In one embodiment, the K time windows are continuous in time domain.

In one embodiment, the K time windows are discontinuous in time domain.

In one embodiment, the first time window is an i-th time window in the K time windows, i being a positive integer less than K.

In one embodiment, the first time window is a time window other than a first time window among the K time windows.

In one embodiment, the first time window is a time window other than a time window with an earliest start time among the K time windows.

In one embodiment, the first time window is reserved for one of K repetitions of the first bit block.

In one embodiment, the K time windows are respectively reserved for K repetitions of the first bit block.

In one embodiment, the phrase of the first time window being reserved for a transmission of the first bit block comprising: the first time window is reserved for one of the K repetitions of the first bit block.

In one embodiment, the K repetitions of the first bit block are respectively K actual repetitions.

In one embodiment, there exists a repetition in the K repetitions of the first bit block occupying all the time elements in a corresponding time window.

In one embodiment, there exists a repetition in the K repetitions of the first bit block occupying only partial the time elements in a corresponding time window.

In one embodiment, the K repetitions of the first bit block occupy same frequency-domain resources.

In one embodiment, there exists two repetitions in the K repetitions of the first bit block occupying different frequency-domain resources.

In one embodiment, the K repetitions of the first bit block belong to a same Bandwidth Part (BWP) in frequency domain.

In one embodiment, the K repetitions of the first bit block belong to a same serving cell in frequency domain.

In one embodiment, any of the K repetitions of the first bit block is transmitted on a Physical Uplink Shared CHannel (PUSCH).

In one embodiment, for any two adjacent time windows in the K time windows, if there exists a positive integer number of the time element(s) between the two adjacent time windows, the first node does not transmit a radio signal in a serving cell to which the first signal belongs in any the time element between the two adjacent time windows.

In one embodiment, for any two adjacent time windows in the K time windows, if there exists a positive integer number of the time element(s) between the two adjacent time windows, the first node does not transmit a radio signal carrying the first bit block in a serving cell to which the first signal belongs in any the time element between the two adjacent time windows.

In one embodiment, the first node transmits a radio signal in the K time windows.

In one embodiment, the first node transmits a radio signal in only M time window(s) in the K time windows, M being less than the K.

In one embodiment, the first node transmits a radio signal carrying the first bit block in the K time windows.

In one embodiment, the first node transmits a radio signal carrying the first bit block in only M time window(s) in the K time windows, M being less than the K.

In one embodiment, a Listen Before Talk (LBT) procedure is used to determine whether the first node transmits a radio signal in one of the K time windows.

In one embodiment, an LBT procedure is used to determine whether the first node transmits a radio signal carrying the first bit block in one of the K time windows.

In one embodiment, the LBT procedure comprises: the first node executes sensing to judge whether a channel is idle.

In one embodiment, the physical-layer channel in the present application comprises a PUSCH.

In one embodiment, the physical-layer channel in the present application comprises an sPUSCH.

In one embodiment, the physical-layer channel in the present application comprises an NB-PUSCH.

In one embodiment, the physical-layer channel in the present application comprises a Physical Sidelink Shared Channel (PSSCH).

In one embodiment, each of the K time windows is respectively reserved for a PUSCH transmission with a Configured Grant (CG).

In one embodiment, each of the K time windows is respectively reserved for a transmission with Configured Uplink Grant Type 1.

In one embodiment, each of the K time windows is respectively reserved for a transmission with Configured Uplink Grant Type 2.

In one embodiment, each of the K time windows is respectively reserved for a PUSCH transmission with Configured Uplink Grant Type 1.

In one embodiment, each of the K time windows is respectively reserved for a PUSCH transmission with Configured Uplink Grant Type 2.

### Embodiment 7A

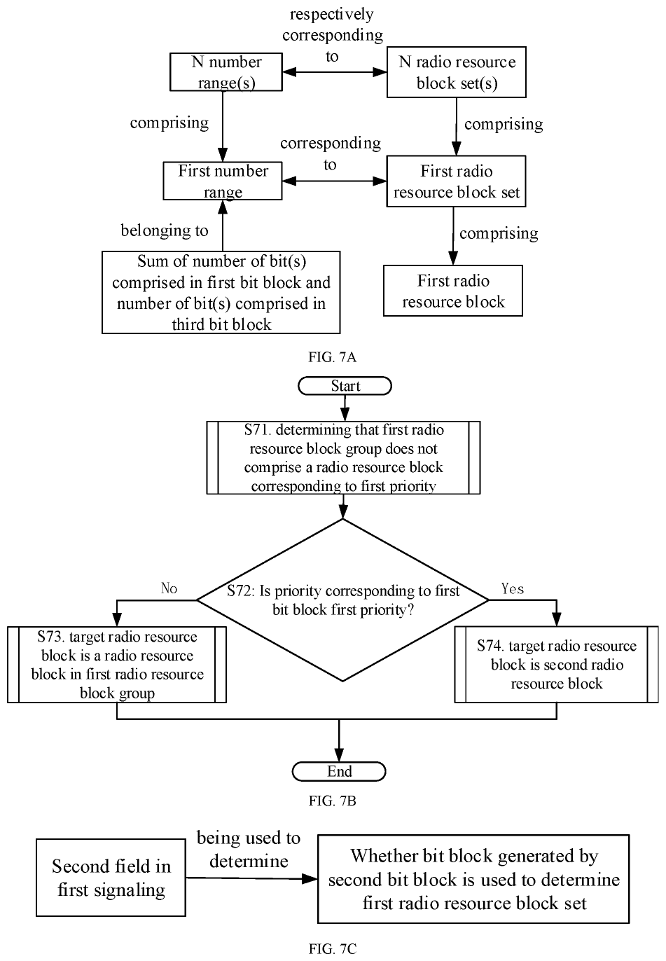

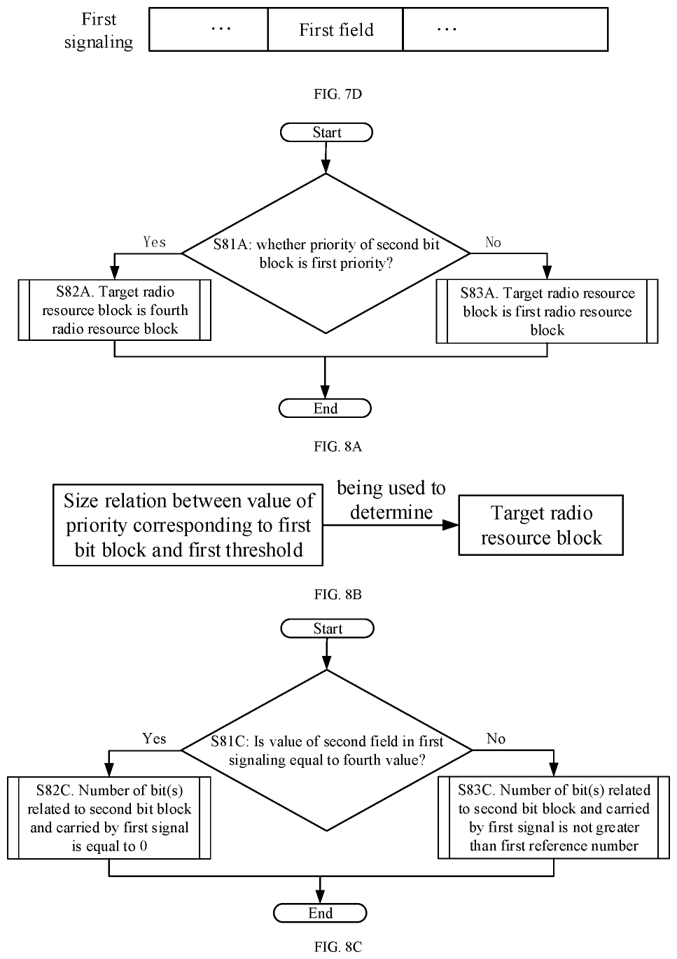

Embodiment 7A illustrates a schematic diagram of relations among N number range(s), N radio resource block set(s), a sum of a number of bit(s) comprised in a first bit block and a number of bit(s) comprised in a third bit block, a first number range, a first radio resource block set and a first radio resource block according to one embodiment of the present application, as shown in FIG. 7A.

In embodiment 7A, N number range(s) corresponds (respectively correspond) to N radio resource block set(s); a first number range is one of the N number ranges; a sum of a number of bit(s) comprised in a first bit block and a number of bit(s) comprised in the first bit block is equal to a number in the first number range; a first radio resource block set is a radio resource block set corresponding to the first number range among the N radio resource block set(s); a first radio resource block is a radio resource block in the first radio resource block set.

In one embodiment, each of the N radio resource block set(s) respectively comprises a PUCCH resource set.

In one embodiment, the first radio resource block set comprises a PUCCH resource set.

In one embodiment, the first signaling indicates the first radio resource block from the first radio resource block set.

In one embodiment, the second signaling indicates the first radio resource block from the first radio resource block set.

In one embodiment, N number range(s) corresponds (respectively correspond) to N radio resource block(s); a first number range is one of the N number ranges; a sum of a number of bit(s) comprised in the first bit block and a number of bit(s) comprised in the third bit block is equal to a number in the first number range; the first radio resource block is a radio resource block set corresponding to the first number range among the N radio resource blocks.

In one embodiment, each radio resource block in the N radio resource block(s) respectively comprises a PUCCH resource.

In one embodiment, the N number range(s) is(are) mutually orthogonal to each other.

In one embodiment, N is a positive integer greater than 1.

In one embodiment, N is not greater than 4.

In one embodiment, N is not greater than 8.

In one embodiment, N is not greater than 16.

In one embodiment, N is not greater than 256.

In one embodiment, N is not greater than 1024.

In one embodiment, the first number is used to determine the fourth radio resource block; M number range(s) respectively correspond to M radio resource block set(s); a second number range is one of the M number range(s); the first number is equal to a number in the second number range; a second radio resource block set is one of the M radio resource block set(s) corresponding to the second number range; the second radio resource block set comprises the fourth radio resource block.

In one embodiment, each of the M radio resource block set(s) respectively comprises a PUCCH resource set.

In one embodiment, the second radio resource block set comprises a PUCCH resource set.

In one embodiment, the first signaling indicates the fourth radio resource block from the second radio resource block set.

In one embodiment, the second signaling indicates the fourth radio resource block from the second radio resource block set.

In one embodiment, the first number is used to determine the fourth radio resource block; M number range(s) corresponds (respectively correspond) to M radio resource block(s); a second number range is one of the M number range(s); the first number is equal to a number in the second number range; the fourth radio resource block is a radio resource block set corresponding to the second number range among the M radio resource block(s).

In one embodiment, each radio resource block in the M radio resource block(s) respectively comprises a PUCCH resource.

In one embodiment, the M number range(s) is(are) mutually orthogonal to each other.

In one embodiment, M is equal to the N.

In one embodiment, the M radio resource block(s) is(are) the N radio resource block set(s).

In one embodiment, the M radio resource(s) is(are) the N radio resource blocks.

In one embodiment, M is a positive integer greater than 1.

In one embodiment, M is not greater than 4.

In one embodiment, M is not greater than 8.

In one embodiment, M is not greater than 16.

In one embodiment, M is not greater than 256.

In one embodiment, M is not greater than 1024.

In one embodiment, T number range(s) corresponds (respectively correspond) to T radio resource block set(s); a fifth number range is one of the T number range(s); a number of bit(s) comprised in the first bit block is equal to a number in the fifth number range; a fifth radio resource block set is a radio resource block set corresponding to the fifth number range among the T radio resource block set(s); the fifth radio resource block set comprises the fifth radio resource block.

In one embodiment, T number range(s) corresponds (respectively correspond) to T radio resource block sets; a fifth number range is one of the T number range(s); a number of bit(s) comprised in a bit block generated by the sixth bit block in the present application is equal to a number in the fifth number range; a fifth radio resource block set is a radio resource block set corresponding to the fifth number range among the T radio resource block set(s); the fifth radio resource block set comprises the fifth radio resource block.

In one embodiment, each of the T radio resource block set(s) respectively comprises a PUCCH resource set.

In one embodiment, the fifth radio resource block set comprises a PUCCH resource set.

In one embodiment, the first signaling indicates the fifth radio resource block from the fifth radio resource block set.

In one embodiment, T number range(s) corresponds (respectively correspond) to T radio resource blocks; a fifth number range is one of the T number range(s); a number of bit(s) comprised in the first bit block is equal to a number in the fifth number range; the fifth radio resource block is a radio resource block set corresponding to the fifth number range among the T radio resource block(s).

In one embodiment, the first signaling indicates the fifth radio resource block from the fifth radio resource block set.

In one embodiment, T number range(s) corresponds (respectively correspond) to T radio resource blocks; a fifth number range is one of the T number range(s); a number of bit(s) comprised in a bit block generated by the sixth bit block in the present application is equal to a number in the fifth number range; the fifth radio resource block is a radio resource block set corresponding to the fifth number range among the T radio resource blocks.

In one embodiment, each radio resource block in the T radio resource block(s) respectively comprises a PUCCH resource.

In one embodiment, the T number range(s) is(are) mutually orthogonal to each other.

In one embodiment, T is a positive integer greater than 1.

In one embodiment, T is not greater than 4.

In one embodiment, T is not greater than 8.

In one embodiment, T is not greater than 16.

In one embodiment, T is not greater than 256.

In one embodiment, T is not greater than 1024.

In one embodiment, T is equal to N.

In one embodiment, the T radio resource block(s) is(are) the N radio resource block set(s).

In one embodiment, the T radio resource(s) is(are) the N radio resource block(s).

In one embodiment, a number of bit(s) comprised in the third bit block is used to determine the third radio resource block; K number range(s) corresponds (respectively correspond) to K radio resource block set(s); a third number range is one of the K number range(s); the number of bit(s) comprised in the third bit block is equal to a number in the third umber range; a third radio resource block set is a radio resource block set corresponding to the third number range among the K radio resource block set(s); the third radio resource block set comprises the third radio resource block.

In one embodiment, a number of bit(s) comprised in a bit block generated by the seventh bit block in the present application is used to determine the third radio resource block; K number range(s) corresponds (respectively correspond) to K radio resource block set(s); a third number range is one of the K number range(s); the number of bit(s) comprised in the bit block generated by the seventh bit block is equal to a number in the third umber range; a third radio resource block set is a radio resource block set corresponding to the third number range among the K radio resource block set(s); the third radio resource block set comprises the third radio resource block.

In one embodiment, each of the K radio resource block set(s) respectively comprises a PUCCH resource set.

In one embodiment, the third radio resource block set comprises a PUCCH resource set.

In one embodiment, the second signaling indicates the third radio resource block from the third radio resource block set.

In one embodiment, a number of bit(s) comprised in the third bit block is used to determine the third radio resource block; K number range(s) corresponds (respectively correspond) to K radio resource block(s); a third number range is one of the K number range(s); the number of bit(s) comprised in the third bit block is equal to a number in the third umber range; the third radio resource block is a radio resource block set corresponding to the third number range among the K radio resource block(s).

In one embodiment, a number of bit(s) comprised in a bit block generated by the seventh bit block in the present application is used to determine the third radio resource block; K number range(s) corresponds (respectively correspond) to K radio resource block(s); a third number range is one of the K number range(s); the number of bit(s) comprised in the bit block generated by the seventh bit block is equal to a number in the third umber range; the third radio resource block is a radio resource block set corresponding to the third number range among the K radio resource block(s).

In one embodiment, each radio resource block in the K radio resource block(s) respectively comprises a PUCCH resource.

In one embodiment, the K number range(s) is(are) mutually orthogonal to each other.

In one embodiment, K is a positive integer greater than 1.

In one embodiment, K is not greater than 4.

In one embodiment, K is not greater than 8.

In one embodiment, K is not greater than 16.

In one embodiment, K is not greater than 256.

In one embodiment, K is not greater than 1024.

### Embodiment 7B

Embodiment 7B illustrates a schematic diagram of a flowchart of determining the target radio resource block according to one embodiment of the present application, as shown in FIG. 7B.

In embodiment 7B, the first node in the present application firstly determines that a first radio resource block group does not comprise a radio resource block corresponding to a first priority in step S71; then judges whether a priority corresponding to a first bit block is a first priority in step S72; if yes, determines that a target radio resource block is a second radio resource block in step S74; otherwise, determines that a target radio resource block is a radio resource block in a first radio resource block group in step S73.

In one subembodiment of embodiment 7, when the target radio resource block is a radio resource block in the first radio resource block group, a bit block generated by the first bit block is transmitted in the radio resource block in the first radio resource block group; when the target radio resource block is the second radio resource block, a bit block generated by the first bit block is transmitted in the second radio resource block.

In one embodiment, the first radio resource block group does not comprise a radio resource block corresponding to the first priority; when the priority corresponding to the first bit block is the first priority, the target radio resource block is a radio resource block in the first radio resource block group; when the priority corresponding to the first bit block is not the first priority, the target radio resource block is the second radio resource block.

In one embodiment, when the first radio resource block group does not comprise a radio resource block corresponding to the first priority, the first radio resource block group only comprises one or multiple radio resource blocks corresponding to the second priority.

In one embodiment, when the priority corresponding to the first bit block is not the first priority, the priority corresponding to the first bit block is the second priority.

In one subembodiment of the above embodiment, the radio resource block in the first radio resource block group corresponds to the second priority.

In one embodiment, the second radio resource block is reserved for the first bit block; any radio resource block in the first radio resource block group is reserved for a bit block other than the first bit block.

In one embodiment, the phrase of a bit block generated by the first bit block being transmitted in a radio resource block in the first radio resource block group comprises: the radio resource block in the first radio resource block group being reserved for a first physical-layer channel; the bit block generated by the first bit block being transmitted on the first physical-layer channel.

In one embodiment, the phrase of a bit block generated by the first bit block being transmitted in the second radio resource block comprises: the second radio resource block being reserved for a second physical-layer channel; the bit block generated by the first bit block being transmitted on the second physical-layer channel.

### Embodiment 7C

Embodiment 7C illustrates a schematic diagram of relations among a second field in a first signaling, a second bit block and a first radio resource block set according to one embodiment of the present application, as shown in FIG. 7C.

In embodiment 7C, a second field in a first signaling is used to determine whether a bit block generated by a second bit block is used to determine a first radio resource block set.

In embodiment 7C, a first radio resource block is a radio resource block in the first radio resource block set.

In one embodiment, when a value of the second field in the first signaling is equal to a fourth value, a number of bit(s) related to the second bit block and carried by the first signal is equal to 0, and a bit block generated by the second bit block is not used to determine the first radio resource block set; when a value of the second field in the first signaling is not equal to the fourth value, a number of bit(s) related to the second bit block and carried by the first signal is greater than 0, and a bit block generated by the second bit block is used to determine the first radio resource block set.

In one embodiment, when the value of the second field in the first signaling is not equal to the fourth value, the value of the second field in the first signaling is equal to a fifth value.

In one embodiment, the fourth value is equal to 0, and the fifth value is equal to 1.

In one embodiment, the fourth value is equal to 1, and the fifth value is equal to 0.

In one embodiment, the fourth value is equal to one of 00, 01, 10 or 11.

In one embodiment, the bit block generated by the second bit block comprises: the second bit block.

In one embodiment, the bit block generated by the second bit block comprises: all or partial bits in the second bit block.

In one embodiment, the bit block generated by the second bit block comprises: partial or all of bits in the second bit block sequentially through one or more operations of logic and, logical or, xor, deleting bit or zero-padding.

In one embodiment, the bit block generated by the second bit block comprises: a bit related to the second-type HARQ-ACK comprised in the second bit block.

In one embodiment, the phrase of a number of bit(s) related to the second bit block and carried by the first signal being equal to 0 comprises: the first signal does not carry any bit related to the second-type HARQ-ACK comprised in the second bit block.

In one embodiment, the phrase of a number of bit(s) related to the second bit block and carried by the first signal being equal to 0 comprises: the first signal does not carry the second bit block.

In one embodiment, the phrase of a number of bit(s) related to the second bit block and carried by the first signal being equal to 0 comprises: the first signal does not carry any bit related to the second bit block.

In one embodiment, the phrase of a number of bit(s) related to the second bit block and carried by the first signal being greater than 0 comprises: the first signal carries a positive integer number of bit(s) related to the second-type HARQ-ACK comprised in the second bit block.

In one embodiment, the phrase of a number of bit(s) related to the second bit block and carried by the first signal being greater than 0 comprises: the first signal carries the second bit block.

In one embodiment, the phrase of a number of bit(s) related to the second bit block and carried by the first signal being greater than 0 comprises: the first signal carries a bit block generated by the second bit block.

In one embodiment, the phrase of a number of bit(s) related to the second bit block and carried by the first signal being greater than 0 comprises: the first signal carries the second-type HARQ-ACK comprised in the second bit block.

In one embodiment, when a bit block generated by the second bit block is not used to determine the first radio resource block set: the first radio resource block set is the third radio resource block set in the present application, and the first radio resource block is the third radio resource block in the present application.

In one embodiment, when a bit block generated by the second bit block is not used to determine the first radio resource block set: only a former of the first bit block and the second bit block is used to determine the first radio resource block set.

In one embodiment, M number range(s) corresponds (respectively correspond) to M radio resource block set(s); a first number range is one of the M number range(s);

In one subembodiment of the above embodiment, when the bit block generated by the second bit block is used to determine the first radio resource block set: the first bit block and the bit block generated by the second bit block are used together to determine the first number range; the first radio resource block set is a radio resource block set corresponding to the first number range among the M radio resource block set(s).

In one subembodiment of the above embodiment, when the bit block generated by the second bit block is used to determine the first radio resource block set: a sum of a number of bit(s) comprised in the first bit block and a number of bit(s) comprised in the bit block generated by the second bit block is equal to a number in the first number range; the first radio resource block set is a radio resource block set corresponding to the first number range among the M radio resource block set(s).

In one embodiment, each of the M radio resource block set(s) comprises a PUCCH resource set.

In one embodiment, the first radio resource block set comprises one or multiple radio resource blocks.

In one embodiment, when the bit block generated by the second bit block is used to determine the first radio resource block set: the first signaling indicates the first radio resource bock from the first radio resource block set.

In one embodiment, when the bit block generated by the second bit block is used to determine the first radio resource block set: the first bit block, the second bit block and the first signaling are used together to determine the first radio resource block.

In one embodiment, when a bit block generated by the second bit block is not used to determine the first radio resource block set: the first bit block and the first signaling are used together to determine the first radio resource block.

In one embodiment, the bit block generated by the second bit block comprises: all or partial bits in the second bit block.

In one embodiment, the bit block generated by the second bit block comprises: partial or all of bits in the second bit block sequentially through one or more operations of logic and, logical or, xor, deleting bit or zero-padding.

In one embodiment, the bit block generated by the second bit block comprises: a bit related to the second-type HARQ-ACK comprised in the second bit block.

In one embodiment, the phrase of a bit block generated by the second bit block refers to: the second bit block.

In one embodiment, the phrase of a bit block generated by the second bit block not being used to determine the first radio resource block set comprises: the second bit block not being used to determine the first radio resource block set.

In one embodiment, the phrase of a bit block generated by the second bit block not being used to determine the first radio resource block set comprises: any bit block generated by the second bit block not being used to determine the first radio resource block set.

### Embodiment 7D

Embodiment 7D illustrates a schematic diagram of a first signaling being used to determine K time windows according to one embodiment of the present application, as shown in FIG. 7D.

In embodiment 7D, the first signaling comprises a first field, and the first field in the first signaling indicates the K time windows.

In one embodiment, the first field comprises more than one bit.

In one embodiment, the first field comprises information in one or multiple fields in a DCI.

In one embodiment, the first field comprises information in one or multiple fields in an IE.

In one embodiment, the first field in the first signaling indicates a first Start and Length Indicator Value (SLIV), and the first SLIV indicates a start time of a first time window in the K time windows and a length of each of the K time windows.

In one embodiment, a first one of the time element(s) in the present application occupied by a first one of the K time windows is a first time element in a first time unit, and the first field in the first signaling indicates a time interval between the first time unit and a time unit to which the first signaling belongs as well as a position of the first time element in the first time unit.

In one embodiment, the K time windows are respectively located in K continuous time units, and positions of the K time windows in the K continuous time units are the same.

In one embodiment, the first field in the first signaling indicates K.

In one embodiment, the time unit is a slot.

In one embodiment, the time unit is a sub-slot.

In one embodiment, the time unit is a multicarrier symbol.

In one embodiment, the time unit consists of more than one continuous multicarrier symbol.

In one embodiment, a number of multicarrier symbol(s) comprised in the time unit is configured by an RRC signaling.

### Embodiment 8A

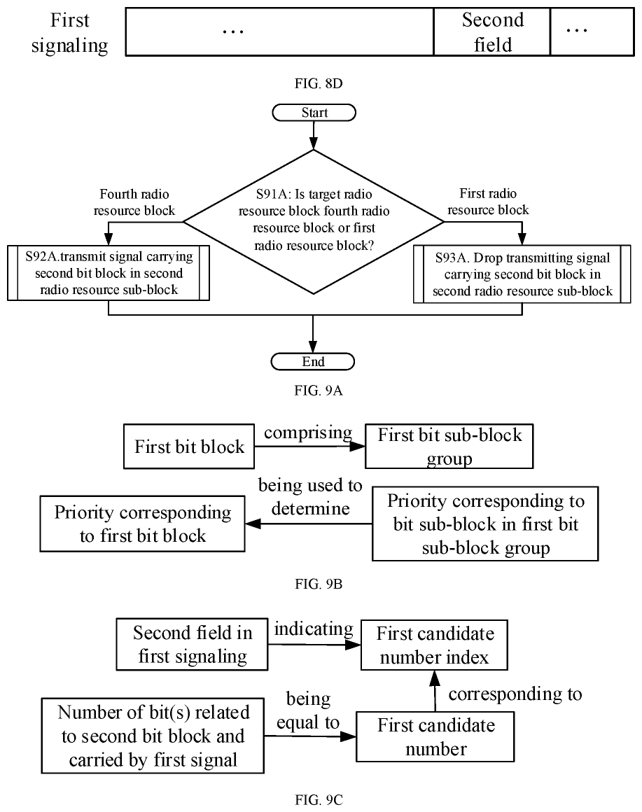

Embodiment 8A illustrates a schematic diagram of a flowchart of a priority of a second bit block being used to determine a target radio resource block from a first radio resource block and a fourth radio resource block according to one embodiment of the present application, as shown in FIG. 8A.

In embodiment 8A, the first node in the present application judges whether a priority of a second bit block is a first priority in step S81A; if yes, determines that a target radio resource block is a fourth radio resource block in step S82A; otherwise, determines that the target radio resource block is a first radio resource block in step S83A.

In one embodiment, when a priority of the second bit block is not the first priority, the priority of the second bit block is the second priority.

In one embodiment, when a priority of the second bit block is not the first priority, the priority of the second bit block is a priority other than the second priority.

In one embodiment, when a priority of the second bit block is the second priority, the target radio resource block is the fourth radio resource block; when a priority of the second bit block is not the second priority, the target radio resource block is the first radio resource block.

In one embodiment, when a priority of the second bit block is not the second priority, the priority of the second bit block is the first priority.

In one embodiment, when a priority of the second bit block is not the second priority, the priority of the second bit block is a priority other than the first priority.

In one embodiment, when a priority of the second bit block is a first priority in a first priority subset, the target radio resource block is the fourth radio resource block; when a priority of the second bit block is a priority in a second priority subset, the target radio resource block is the first radio resource block; a first priority set comprises the first priority subset and the second priority subset, the first priority subset has no intersection with the second priority subset.

In one embodiment, a priority of the first bit block is different from a priority of the third bit block; when a priority of the second bit block is lower than the priority of the first bit block and a priority of the second bit block is lower than the priority of the third bit block, the target radio resource block is the fourth radio resource block; when a priority of the second bit block is not lower than the priority of the first bit block or a priority of the second bit block is not lower than the priority of the third bit block, the target radio resource block is the first radio resource block.

In one embodiment, a priority of the first bit block is different from a priority of the third bit block; when a priority of the second bit block is lower than the priority of the first bit block and a priority of the second bit block is lower than the priority of the third bit block, the target radio resource block is the first radio resource block; when a priority of the second bit block is not lower than the priority of the first bit block or a priority of the second bit block is not lower than the priority of the third bit block, the target radio resource block is the fourth radio resource block.

In one embodiment, a priority of the first bit block is different from a priority of the third bit block; when a priority of the second bit block is greater than the priority of the first bit block and a priority of the second bit block is greater than the priority of the third bit block, the target radio resource block is the fourth radio resource block; when a priority of the second bit block is not greater than the priority of the first bit block or a priority of the second bit block is not greater than the priority of the third bit block, the target radio resource block is the first radio resource block.

In one embodiment, a priority of the first bit block is different from a priority of the third bit block; when a priority of the second bit block is greater than the priority of the first bit block and a priority of the second bit block is greater than the priority of the third bit block, the target radio resource block is the first radio resource block; when a priority of the second bit block is not greater than the priority of the first bit block or a priority of the second bit block is not greater than the priority of the third bit block, the target radio resource block is the fourth radio resource block.

In one embodiment, when a priority of the second bit block is greater than a priority of the third bit block, the target radio resource block is the first radio resource block; when a priority of the second bit block is not greater than a priority of the third bit block, the target radio resource block is the fourth radio resource block.

In one embodiment, when a priority of the second bit block is lower than a priority of the third bit block, the target radio resource block is the first radio resource block; when a priority of the second bit block is not lower than a priority of the third bit block, the target radio resource block is the fourth radio resource block.

In one embodiment, a value corresponding to a priority of the third bit block is greater than a first threshold.

In one embodiment, the first threshold is greater than 0.

In one embodiment, the first threshold is a positive integer.

In one embodiment, the first threshold is configured by a higher-layer signaling.

In one embodiment, the first threshold is configured by an RRC signaling.

In one embodiment, the first threshold is configured by a MAC CE signaling.

In one embodiment, the first threshold is pre-defined.

### Embodiment 8B

Embodiment 8B illustrates a schematic diagram of relations among a value of a priority corresponding to a first bit block, a first threshold and a target radio resource block according to one embodiment of the present application, as shown in FIG. 8B.

In embodiment 8B, a size relation between a value of a priority corresponding to a first bit block and a first threshold is used to determine a target radio resource block.

In one subembodiment of embodiment 8B, the first threshold is less than a second threshold.

In one embodiment, the value of the priority corresponding to the first bit block is a value in a first value set.

In one embodiment, the first value set comprises multiple values.

In one embodiment, the first value comprises multiple positive integers.

In one embodiment, the first value set comprises 0 and 1.

In one embodiment, each value in the first value set respectively represents a priority,

In one embodiment, each value in the first value set respectively corresponds to multiple QoS values.

In one embodiment, each value in the first value set respectively corresponds to a QoS value.

In one embodiment, each value in the first value set is respectively used to indicate a priority of a signal transmission on sidelink.

In one embodiment, each value in a first value set respectively represents a priority; the value of the priority corresponding to the first bit block represents the priority corresponding to the first bit block.

In one embodiment, the first threshold is pre-configured.

In one embodiment, the first threshold is configured at an RRC layer.

In one embodiment, the first threshold is configured at a MAC layer.

In one embodiment, the first threshold is used to determine whether a priority of a transmission of an information bit block (such as, SL HARQ reporting) related to sidelink is greater than a priority of other cellular link uplink transmissions.

In one embodiment, the first threshold is used to determine whether a priority of a transmission of an information bit block (such as, SL HARQ reporting) related to sidelink is greater than a priority of an uplink transmission of cellular link URLLC service type.

In one embodiment, the first threshold is a threshold related to URLLC.

In one embodiment, the second threshold is pre-configured.

In one embodiment, the second threshold is configured at an RRC layer.

In one embodiment, the second threshold is configured at a MAC layer.

In one embodiment, the second threshold is used to determine whether a priority of a transmission of an information bit block (such as, SL HARQ reporting) related to sidelink is greater than a priority of an uplink transmission of cellular link eMBB service type.

In one embodiment, the second threshold is a threshold related to eMBB.

In one embodiment, a value of the priority corresponding to the first bit block is greater than a second threshold; the second threshold is less than the first threshold.

In one embodiment, the first radio resource block group does not comprise a radio resource block corresponding to the first priority; when the value of the priority corresponding to the first bit block is not less than the first threshold, the target radio resource block is a radio resource block in the first radio resource block group, and a bit block generated by the first bit block is transmitted in the radio resource block in the first radio resource block group; when the value of the priority corresponding to the first bit block is less than the first threshold, the target radio resource block is the second radio resource block, and a bit block generated by the first bit block is transmitted in the second radio resource block.

In one embodiment, the first radio resource block group does not comprise a radio resource block corresponding to the first priority; when the value of the priority corresponding to the first bit block is not greater than the first threshold, the target radio resource block is a radio resource block in the first radio resource block group, and a bit block generated by the first bit block is transmitted in the radio resource block in the first radio resource block group; when the value of the priority corresponding to the first bit block is greater than the first threshold, the target radio resource block is the second radio resource block, and a bit block generated by the first bit block is transmitted in the second radio resource block.

In one embodiment, the first radio resource block group does not comprise a radio resource block corresponding to the first priority; when the value of the priority corresponding to the first bit block is less than the first threshold, the target radio resource block is a radio resource block in the first radio resource block group, and a bit block generated by the first bit block is transmitted in the radio resource block in the first radio resource block group; when the value of the priority corresponding to the first bit block is not less than the first threshold, the target radio resource block is the second radio resource block, and a bit block generated by the first bit block is transmitted in the second radio resource block.

In one embodiment, the first radio resource block group does not comprise a radio resource block corresponding to the first priority; when the value of the priority corresponding to the first bit block is greater than the first threshold, the target radio resource block is a radio resource block in the first radio resource block group, and a bit block generated by the first bit block is transmitted in the radio resource block in the first radio resource block group; when the value of the priority corresponding to the first bit block is not greater than the first threshold, the target radio resource block is the second radio resource block, and a bit block generated by the first bit block is transmitted in the second radio resource block.

### Embodiment 8C

Embodiment 8C illustrates a schematic diagram of a flowchart of a second field in a first signaling being used to determine a number of bit(s) related to a second bit block and carried by a first signal according to one embodiment of the present application, as shown in FIG. 8C.

In embodiment 8C, the first node in the present application judges whether a value of a second field in a first signaling is equal to a fourth value in step S81C; if yes, determines that a number of bit(s) related to a second bit block and carried by a first signal is equal to 0 in step S82C; otherwise, determines that a number of bit(s) related to a second bit block and carried by a first signal is not greater than a first reference number in step S83C.

In one embodiment, when a value of the second field in the first signaling is equal to a fourth value, a number of bit(s) related to the second bit block and carried by the first signal is equal to 0, and a bit block generated by the second bit block is not used to determine the first radio resource block set; when a value of the second field in the first signaling is not equal to the fourth value, a number of bit(s) related to the second bit block and carried by the first signal is not greater than a first reference number.

In one embodiment, a third bit block is a bit block generated by the second bit block.

In one embodiment, the third bit block comprises: all or partial bits in the second bit block.

In one embodiment, the third bit block comprises: an output acquired after partial or all of bits in the second bit block sequentially through one or more operations of logic and, logical or, xor, deleting bit or zero-padding.

In one embodiment, the third bit block comprises: a bit related to the second-type HARQ-ACK comprised in the second bit block.

In one embodiment, the third bit block is the second bit block.

In one embodiment, when the value of the second field in the first signaling is not equal to the fourth value, the number of bit(s) related to the second bit block and carried by the first signal is greater than 0.

In one embodiment, when the value of the second field in the first signaling is not equal to the fourth value, the number of bit(s) related to the second bit block and carried by the first signal is equal to the first reference number.

In one embodiment, the value of the second field in the first signaling is not equal to the fourth value; when a total number of bit(s) comprised in the third bit block is less than the first reference number: the number of bit(s) related to the second bit block and carried by the first signal is less than the first reference number.

In one embodiment, the value of the second field in the first signaling is not equal to the fourth value; a total number of bit(s) comprised in the third bit block is less than the first reference number: the number of bit(s) related to the second bit block and carried by the first signal is equal to a total number of bit(s) comprised in the third bit block.

In one embodiment, the value of the second field in the first signaling is not equal to the fourth value; when a total number of bit(s) comprised in the third bit block is not less than the first reference number: the number of bit(s) related to the second bit block and carried by the first signal is equal to the first reference number.

In one embodiment, the value of the second field in the first signaling is not equal to the fourth value; when a total number of bit(s) comprised in the third bit block is less than the first reference number: a bit related to the second bit block and carried by the first signal comprises a positive integer number of zero padding bit(s).

In one embodiment, the first reference number is a positive integer.

In one embodiment, the first reference number is not less than 2000.

In one embodiment, the first reference number is configured at a higher layer.

In one embodiment, the first reference number is configured at an RRC layer.

In one embodiment, the first reference number is configured at a MAC layer.

In one embodiment, the first reference number is pre-configured.

In one embodiment, the first reference number is pre-defined.

In one embodiment, a total number of bit(s) comprised in the second bit block is greater than a second reference number.

In one embodiment, a total number of bit(s) comprised in the second bit block is less than a third reference number.

In one embodiment, the second reference number is less than the first reference number.

In one embodiment, the third reference number is greater than the first reference number.

In one embodiment, the second reference number is a non-negative integer.

In one embodiment, the second reference number is a positive integer.

In one embodiment, the second reference number is configured at a higher layer.

In one embodiment, the second reference number is configured at an RRC layer.

In one embodiment, the second reference number is configured at a MAC layer.

In one embodiment, the second reference number is pre-configured.

In one embodiment, the second reference number is pre-defined.

In one embodiment, the third reference number is a positive integer.

In one embodiment, the third reference number is not less than 2000.

In one embodiment, the third reference number is configured at a higher layer.

In one embodiment, the third reference number is configured at an RRC layer.

In one embodiment, the third reference number is configured at a MAC layer.

In one embodiment, the third reference number is pre-configured.

In one embodiment, the third reference number is pre-defined.

In one embodiment, the first reference number is a reference number in a first reference number set.

In one embodiment, the second reference number is a reference number in a first reference number set.

In one embodiment, the third reference number is a reference number in a first reference number set.

In one embodiment, the first reference number set is configured at a higher layer.

In one embodiment, the first reference number set is configured at an RRC layer.

In one embodiment, the first reference number set is configured at a MAC layer.

In one embodiment, the first reference number set is pre-configured.

In one embodiment, the first reference number set is pre-defined.

In one embodiment, the value of the second field in the first signaling is not equal to the fourth value; a total number of bit(s) comprised in the third bit block is less than the first reference number: the number of bit(s) related to the second bit block and carried by the first signal is equal to the second reference number.

In one embodiment, M number range(s) corresponds (respectively correspond) to M radio resource block set(s); a first number range is one of the M number range(s).

In one subembodiment of the above embodiment, when the value of the second field in the first signaling is not equal to the fourth value: a sum of a number of bit(s) comprised in the first bit block and the first reference number is equal to a number in the first number range; the first radio resource block set is a radio resource block set corresponding to the first number range among the M radio resource block set(s).

In one subembodiment of the above embodiment, when the value of the second field in the first signaling is not equal to the fourth value: a sum of a number of bit(s) comprised in the first bit block and a first intermediate number is equal to a number in the first number range; the first radio resource block set is a radio resource block set corresponding to the first number range among the M radio resource block set(s); the first intermediate number is equal to a smallest value of a total number of bit(s) comprised in the third bit block and the first reference number.

In one subembodiment of the above embodiment, when the value of the second field in the first signaling is not equal to the fourth value: a sum of a number of bit(s) comprised in the first bit block and a second intermediate number is equal to a number in the first number range; the first radio resource block set is a radio resource block set corresponding to the first number range among the M radio resource block set(s); when a total number of bit(s) comprised in the third bit block is less than the first reference number: the second intermediate number is equal to the second reference number; when a total number of bit(s) comprised in the third bit block is not less than the first reference number: the second intermediate number is equal to the first reference number.

### Embodiment 8D

Embodiment 8D illustrates a schematic diagram of a first signaling being used to determine K time windows according to one embodiment of the present application, as shown in FIG. 8D.

In embodiment 8D, the first signaling comprises a second field, the second field in the first signaling indicates a first time slice set, the first time slice set comprises a positive integer number of time slice(s), and any time slice in the first time slice set is a continuous duration; the first time slice set is used to determine the K time windows.

In one embodiment, the second field comprises more than one bit.

In one embodiment, the second field comprises information in one or multiple fields in a DCI.

In one embodiment, the second field comprises information in one or multiple fields in an IE.

In one embodiment, the first time slice set only comprises one time slice.

In one embodiment, the first time slice set comprises multiple slices.

In one embodiment, any time slice in the first time slice set comprises one or more than one continuous time element.

In one embodiment, numbers of the time elements comprised in any two time slices in the first time slice set are equal.

In one embodiment, the first time slice set comprises multiple slices, and the multiple time slices are mutually orthogonal to each other.

In one embodiment, any two adjacent time slices in the first time slice set are continuous in time domain.

In one embodiment, any time slice in the first time slice set is reserved for a nominal repetition of the first bit block.

In one embodiment, the second field in the first signaling indicates a second SLIV, and the second SLIV indicates a start time of an earliest time slice in the first time slice set and a length of each time slice in the first time slice set.

In one embodiment, a second time unit comprises a time unit; a first one of the time elements occupied by an earliest time slice in the first time slice set is a second time element in the second time unit, and the second field in the first signaling indicates a time interval between the second time unit and a time unit to which the first signaling belongs as well as a position of the second time element in the second time unit.

In one embodiment, the time unit is a slot.

In one embodiment, the time unit is a sub-slot.

In one embodiment, the time unit is a multicarrier symbol.

In one embodiment, the time unit consists of more than one continuous multicarrier symbol.

In one embodiment, a number of multicarrier symbol(s) comprised in the time unit is configured by an RRC signaling.

In one embodiment, the second field in the first signaling indicates a number of time slice(s) comprised in the first time slice set.

In one embodiment, any time window in the K time windows belongs to a time slice in the first time slice set.

In one embodiment, the first time slice set is used to determine K.

In one embodiment, the first time slice set is used to determine a start time of each of the K time window(s).

In one embodiment, the first time slice set is used to determine a length of each of the K time window(s).

In one embodiment, a number of time slice(s) comprised in the first time slice set is used to determine the first RV in the present application.

In one embodiment, when a number of time slice(s) comprised in the first time slice set is an odd number, the first RV is RV j1; when a number of time slice(s) comprised in the first time slice set is an even number, the first RV is RV j2; j1 is not equal to the j2.

In one embodiment, j1 and j2 are respectively equal to one of 0, 1, 2 or 3.

In one embodiment, the RV j1 and the RV j2 are configured by a higher-layer signaling.

In one embodiment, the RV j1 and the RV j2 are configured by a RRC signaling.

In one embodiment, the RV j1 and the RV j2 are configured by a MAC CE signaling.

In one embodiment, the RV j1 and the RV j2 are pre-defined.

In one embodiment, the RV j1 and the RV j2 are fixed.

### Embodiment 9A

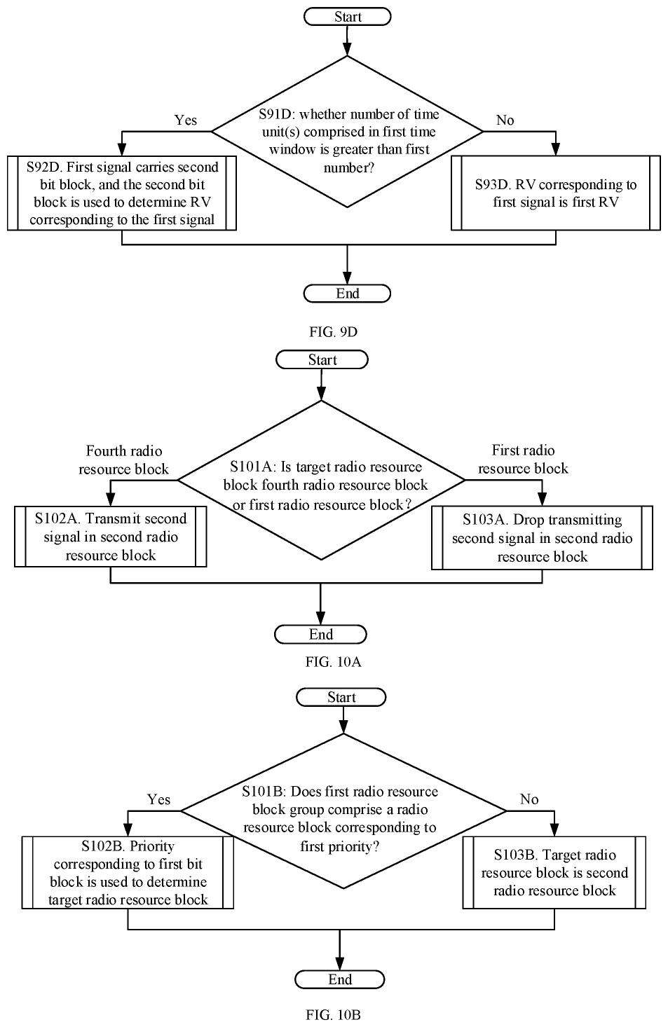

Embodiment 9A illustrates a schematic diagram of a flowchart of judging whether a signal carrying a second bit block is not transmitted in a second radio resource sub-block according to one embodiment of the present application, as shown in FIG. 9A.

In embodiment 9A, the first node in the present application judges whether a target radio resource block is a fourth radio resource block or a first radio resource block in step S91A; if it determines that the target radio resource block is the fourth radio resource block, then determines that a signal carrying a second bit block is transmitted in a second radio resource sub-block in step S92A; if it determines that the target radio resource block is the first radio resource block, then determines that a signal carrying the second bit block is not transmitted in the second radio resource sub-block in step S93A.

In embodiment 9A, the second radio resource block comprises the second radio resource sub-block.

In one subembodiment of embodiment 9A, the second radio resource sub-block comprises a part of the second radio resource block overlapping in time domain with time-domain resources occupied by the first radio resource block in the present application.

In one subembodiment of embodiment 9A, the second radio resource block also comprises radio resources other than the second radio resource sub-block; when the first node judges that the target radio resource block is the fourth radio resource block, the first node also transmits a signal carrying the second bit block in the radio resources other than the second radio resource sub-block in the second radio resource block.

In one embodiment, the second radio resource sub-block is a part overlapping with the first radio resource block in time domain and comprised in the second radio resource block.

In one embodiment, the second radio resource block also comprises radio resources other than the second radio resource sub-block; when the target radio resource block is the first radio resource block, the first node transmits a signal carrying the second bit block in the radio resources other than the second radio resource sub-block in the second radio resource block.

In one embodiment, the second radio resource block also comprises radio resources other than the second radio resource sub-block; when the target radio resource block is the first radio resource block, the first node does not transmit a signal carrying the second bit block in the radio resources other than the second radio resource sub-block in the second radio resource block.

In one embodiment, when the target radio resource block is the fourth radio resource block, the first node transmits a second signal in the second radio resource block; when the target radio resource block is the first radio resource block, the first node does not transmit a part of the second signal mapped into a second radio resource sub-block; the second radio resource sub-block comprises a part of the second radio resource block overlapping in time domain with time-domain resources occupied by the first radio resource block.

In one embodiment, when a priority of the second bit block in the present application is a first priority, the first node transmits a second signal in the second radio resource block; when a priority of the second bit block is not the first priority, the first node does not transmit a part of the second signal mapped into a second radio resource sub-block; the second radio resource sub-block comprises a part of the second radio resource block overlapping in time domain with time-domain resources occupied by the first radio resource block.

In one embodiment, the second radio resource block also comprises radio resources other than the second radio resource sub-block; when the target radio resource block is the first radio resource block, the first node transmits a part of the second signal mapped into the radio resources other than the second radio resource sub-block in the second radio resource block.

In one embodiment, the second radio resource block also comprises radio resources other than the second radio resource sub-block; when the target radio resource block is the first radio resource block, the first node does not transmit a part of the second signal mapped into the radio resources other than the second radio resource sub-block in the second radio resource block.

In one embodiment, when the target radio resource block is the first radio resource block: the first node does not transmit a signal carrying the second bit block in the second radio resource block.

In one embodiment, when the target radio resource block is the fourth radio resource block, the first node transmits the second signal in the second radio resource block.

In one embodiment, the second signal carries the second bit block.

In one embodiment, the signal carrying the second bit block comprises all or part of an output acquired after all or partial bits in the second bit block sequentially through CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, the second signal comprises an output acquired after all or partial bits in the second bit block sequentially through part or all of CRC Insertion, Segmentation, Code Block-level CRC Insertion, Channel Coding, Rate Matching, Concatenation, Scrambling, Modulation, Spreading, Layer Mapping, Precoding, Mapping to Resource Element, Multicarrier symbol Generation and Modulation and Upconversion.

In one embodiment, based on time domain, time-domain resources occupied by the first radio resource block comprise time-domain resources occupied by the second radio resource sub-block.

In one embodiment, based on time domain, time-domain resources occupied by the first radio resource block comprise time-domain resources occupied by the second radio resource sub-block.

In one embodiment, when the target radio resource block is the first radio resource block: the first node transmits a second signal in radio resources other than the second radio resource sub-block in the second radio resource block, and the second signal carries a signal of the second bit block.

In one embodiment, a start time of the second radio resource block is earlier than a start time of the first radio resource block; a start time of the second radio resource sub-block is later than a start time of the second radio resource block.

In one embodiment, a start time of the second radio resource block is earlier than a start time of the first radio resource block; a start time of the second radio resource sub-block is not later than a start time of the first radio resource block.

In one embodiment, a start time of the second radio resource block is earlier than a start time of the first radio resource block; a start time of the second radio resource sub-block is the same as a start time of the first radio resource block.

In one embodiment, a start time of the second radio resource block is earlier than a start time of the first radio resource block.

In one embodiment, a start time of the second radio resource block is earlier than a start time of the fourth radio resource block.

In one embodiment, a start time of the second radio resource block is not earlier than a start time of the first radio resource block.

In one embodiment, a start time of the second radio resource block is not earlier than a start time of the fourth radio resource block.

### Embodiment 9B

Embodiment 9B illustrates a schematic diagram of a relation between a first bit block and a first bit sub-block group according to one embodiment of the present application, as shown in FIG. 9B.

In embodiment 9B, a first bit block comprises a first bit sub-block group; a priority corresponding to a bit sub-block comprised in a first bit sub-block group is used to determine a priority corresponding to a first bit block.

In one embodiment, the first bit block comprises a first bit sub-block group; each bit sub block comprised in the first bit sub-block group respectively corresponds to a priority; a priority corresponding to the first bit block is not lower than a priority corresponding to any bit sub-block in the first bit sub-block group.

In one embodiment, the first bit block comprises a first bit sub-block group; each bit sub-block comprised in the first bit sub-block group respectively corresponds to a priority; when each bit sub-block in the first bit sub-block group corresponds to a same priority, a priority corresponding to the first bit block is equal to the same priority corresponding to the each bit sub-block in the first bit sub-block group; when there exist multiple bit sub-blocks in the first bit sub-block group respectively corresponding to different priorities, a priority corresponding to the first bit block is a highest priority among the different priorities corresponding to the multiple bit sub-blocks in the first bit sub-block group.

In one embodiment, the first bit block comprises a first bit sub-block group; the first signaling is used to determine a bit sub-block in the first bit sub-block group.

In one embodiment, the first bit block comprises a first bit sub-block group; the second radio resource block is reserved for a bit sub-block in the first sub-block group.

In one embodiment, the first bit block comprises a first bit sub-block group; a bit sub-block in the first bit sub-block group comprises indication information of whether the first signaling is correctly received, or, a bit sub-block in the first bit sub-block group comprises indication information of whether a bit block scheduled by the first signaling is correctly received.

In one embodiment, each bit sub-block in the first bit sub-block group respectively comprises a positive integer number of bit(s).

In one embodiment, the first bit block is a bit block comprising a HARQ-ACK.

In one embodiment, each bit sub-block in the first bit sub-block group comprises a HARQ-ACK.

In one embodiment, each bit sub-block in the first bit sub block group comprises a UCI.

In one embodiment, each bit sub-block comprised in the first bit sub-block group respectively corresponds to a priority in the first priority set.

In one embodiment, each bit sub-block comprised in the first bit sub-block group respectively corresponds to a priority in the second priority set.

In one embodiment, the first bit sub-block group comprises a positive integer number of bit sub-block(s).

In one embodiment, the first bit block comprises a first bit sub-block group; the second radio resource block is reserved for a bit sub-block in the first sub-block group; a priority corresponding to the second radio resource block is the same as a priority corresponding to the bit sub-block in the first bit sub-block group.

In one embodiment, the first bit block comprises a first bit sub-block group; the first bit sub-block group comprises a bit sub-block corresponding to the second priority.

In one embodiment, the first priority is higher than the second priority.

In one embodiment, the first bit block comprises a first bit sub-block group; any bit sub-block in the first bit sub-block group comprises: indication information of whether a signaling in a first signaling group is correctly received, or indication information of whether a bit block scheduled by a signaling in a first signaling group is correctly received.

In one embodiment, a signaling in the first signaling group is a physical-layer signaling or a higher-layer signaling.

In one embodiment, a signaling in the first signaling group is an RRC-layer signaling.

In one embodiment, a signaling in the first signaling group comprises one or multiple fields in an RRC-layer signaling.

In one embodiment, a signaling in the first signaling group comprises one or multiple fields in a physical-layer signaling.

In one embodiment, a signaling in the first signaling group comprises one or multiple fields in a higher-layer signaling.

In one embodiment, a signaling in the first signaling group is a DCI signaling.

In one embodiment, a signaling in the first signaling group comprises one or multiple fields in a DCI.

In one embodiment, a signaling in the first signaling group comprises one or multiple fields in an IE.

In one embodiment, a signaling in the first signaling group is dynamically configured.

In one embodiment, a signaling in the first signaling group is a downlink grant signaling

In one embodiment, a signaling in the first signaling group is an uplink grant signaling.

In one embodiment, the first signaling group comprises the first signaling.

In one embodiment, the first bit block comprises a first bit sub block group; a signaling in the first signaling group indicates a priority corresponding to a bit sub-block in the first bit sub-block group.

In one embodiment, the first bit block comprises a first bit sub-block group; signalings in the first signaling group respectively indicate a priority corresponding to a bit sub-block in the first bit sub-block group.

### Embodiment 9C

Embodiment 9C illustrates a schematic diagram of relations among a number of bit(s) related to a second bit block and carried by a first signal, a first candidate number, a second field in a first signaling and a first candidate number index according to one embodiment of the present application, as shown in FIG. 9C.

In embodiment 9C, a number of bit(s) related to a second bit block and carried by a first signal is equal to a first candidate number in K candidate numbers; a second field in a first signaling indicates a first candidate number index, and the first candidate number index is an index of the first candidate number among the K candidate numbers; K is greater than 1.

In one subembodiment of embodiment 9C, when a value of the second field in the first signaling is equal to a first value, the second field in the first signaling indicates that the number of bit(s) related to the second bit block and carried by the first signal is equal to 0; when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

In one embodiment, the K candidate numbers comprise 0.

In one embodiment, the K candidate numbers comprise 1.

In one embodiment, the K candidate numbers comprise a total number of bit(s) comprised in the second bit block.

In one embodiment, K1 candidate number(s) in the K candidate numbers is(are) candidate number(s) related to a size of the first bit block; K2 candidate number(s) other than the K1 candidate number(s) in the K candidate numbers is(are) unrelated to a size of the first bit block; both K1 and K2 are positive integers, and a sum of K1 and K2 is not greater than K.

In one embodiment, the first value, the second value and the third value are respectively equal to an index of one of the K candidate numbers.

In one embodiment, all the first value, the second value and the third value are positive integers.

In one embodiment, the seventh number is configured at a higher layer.

In one embodiment, the seventh number is configured at an RRC layer.

In one embodiment, the seventh number is configured at a MAC layer.

In one embodiment, the seventh number is pre-configured.

In one embodiment, the seventh number is pre-defined.

In one embodiment, the seventh number is equal to a positive integer.

In one embodiment, the seventh number is equal to a positive integer not greater than 2000.

In one embodiment, the seventh number is equal to a total number of bit(s) comprised in the second bit block.

In one embodiment, when the value of the second field in the first signaling is equal to the second value, the second field in the first signaling indicates that the number of bit(s) related to the second bit block and carried by the first signal is equal to a smaller one of the seventh number and a total number of bits comprised in the second bit block.

In one embodiment, when the value of the second field in the first signaling is equal to the second value, the second field in the first signaling indicates that the number of bit(s) related to the second bit block and carried by the first signal is equal to 1.

### Embodiment 9D

Embodiment 9D illustrates a schematic diagram of a flowchart of judging whether an RV corresponding to a first signal is determined by a bit block carried by a first signal according to one embodiment of the present application, as shown in FIG. 9D.

In embodiment 9D, the first node in the present application judges whether a number of time element(s) comprised in a first time window is greater than a first number in step S91D; if yes, determines in step S92D: a first signal carries a second bit block, and the second bit block is used to determine an RV corresponding to the first signal; otherwise, determines that an RV corresponding to a first signal is a first RV in step S93D.

In one embodiment, when the number of the time element(s) comprised in the first time window is not greater than the first number: the first signal not carrying any bit block indicating the RV corresponding to the first signal.

In one embodiment, the first number is equal to a positive integer.

In one embodiment, the first number is equal to 1.

In one embodiment, the first number is equal to 2.

In one embodiment, the first number is equal to 3.

In one embodiment, the first number is equal to 4.

In one embodiment, the first number is not greater than 12.

In one embodiment, the first number is not greater than 14.

In one embodiment, the first number is not greater than 12000.

In one embodiment, the first number is not greater than 14000.

In one embodiment, the first RV is configured by a higher-layer signaling.

In one embodiment, the first RV is configured by an RRC signaling.

In one embodiment, the first RV is configured by a MAC CE signaling.

In one embodiment, the first RV is fixed.

In one embodiment, the first RV is predefined.

In one embodiment, the first RV is Redundancy Version 0 (RV0).

In one embodiment, the first RV is RV 1.

In one embodiment, the first RV is RV 2.

In one embodiment, the first RV is RV 3.

In one embodiment, each of the K time windows in the present application respectively corresponds to an RV configured by a higher-layer signaling; the first RV is the RV configured by the higher-layer signaling corresponding to the first time window.

In one embodiment, each of the K time windows in the present application respectively corresponds to an RV configured by an RRC signaling; the first RV is the RV configured by the RRC signaling corresponding to the first time window.

In one embodiment, each of the K time windows in the present application respectively corresponds to an RV configured by a MAC CE signaling; the first RV is the RV configured by the MAC CE corresponding to the first time window.

In one embodiment, each of the K time windows in the present application respectively corresponds to a predefined RV; the first RV is the pre-defined RV corresponding to the first time window.

In one embodiment, the second bit block comprises a physical-layer signaling.

In one embodiment, the second bit block comprises a positive integer number of bit(s).

In one embodiment, the second bit block comprises a CG-UCI.

In one embodiment, the second bit block comprises indication information of a Hybrid Automatic Repeat reQuest (HARQ) process number.

In one embodiment, the second bit block comprises indication information of RV.

In one embodiment, the second bit block comprises indication information of a New Data Indicator (NDI).

In one embodiment, the second bit block comprises indication information related to a COT.

In one embodiment, the second bit block comprises a HARQ process number field.

In one embodiment, the second bit block comprises a Redundancy version field.

In one embodiment, the second bit block comprises a New data indicator field.

In one embodiment, the second bit block comprises a Channel Occupancy Time (COT) sharing information field.

In one embodiment, the first signal carries a second bit block; the second bit block indicates the RV corresponding to the first signal.

In one embodiment, the first signal carries a second bit block; the second bit block comprises a third field; the third field comprised in the second bit block is used to determine the RV corresponding to the first signal.

In one embodiment, the first signal carries a second bit block; the second bit block comprises a third field; the third field comprised in the second bit block indicates the RV corresponding to the first signal.

In one embodiment, the third field is a Redundancy version field.

### Embodiment 10A

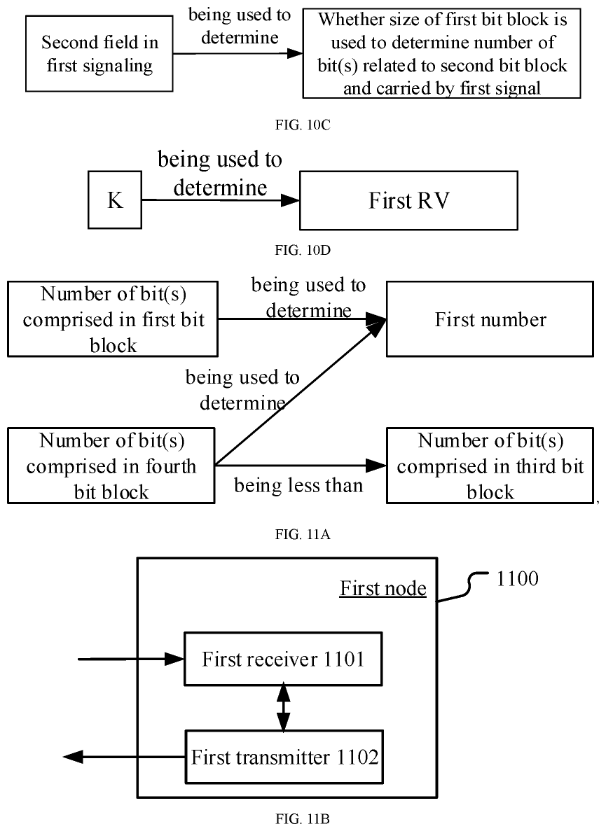

Embodiment 10A illustrates a schematic diagram of judging whether a second signal is transmitted in a second radio resource block according to one embodiment of the present application, as shown in FIG. 10A.

In embodiment 10A, the first node in the present application judges whether a target radio resource block is a fourth radio resource block or a first radio resource block in step S101A; if it determines that the target radio resource block is the fourth radio resource block, then determines a second signal is transmitted in the second radio resource block in step S102A; if it determines that the target radio resource block is the first radio resource block, then determines that the second signal is not transmitted in the second radio resource block in step S103A.

In embodiment 10A, the second signal carries the second bit block in the present application.

In one embodiment, when the target radio resource block is the first radio resource block: the first node does not transmit a signal carrying the second bit block in the second radio resource block.

In one embodiment, when the target radio resource block is the fourth radio resource block, the first node transmits a signal carrying the second bit block in the second radio resource block.

In one embodiment, when a priority of the second bit block in the present application is a first priority, the first node transmits a second signal in the second radio resource block; when a priority of the second bit block is not the first priority, the first node does not transmit the second signal in the second radio resource block.

### Embodiment 10B

Embodiment 10B illustrates a schematic diagram of a flowchart of whether a priority corresponding to a first bit block is used to determine a target radio resource block according to another embodiment of the present application, as shown in FIG. 10B.

In embodiment 10B, a second signaling is used to determine a second bit block, a first signaling is used to determine a fourth bit block, the fourth bit block is used to generate a first bit block, and the second bit block and the fourth bit block are used together to determine a fourth radio resource block.

In embodiment 10B, the first node in the present application judges whether a first radio resource block group comprises a radio resource block corresponding to a first priority in step S101B; if yes, it determines that a priority corresponding to a first bit block is used to determine a target radio resource block in step S102B; otherwise, it determines that a target radio resource block is a second radio resource block in step S103B.

In one embodiment, when the first radio resource block group does not comprise a radio resource block corresponding to the first priority, a priority corresponding to the first bit block is not used to determine the target radio resource block; when the first radio resource block group comprises a radio resource block corresponding to the first priority, a priority corresponding to the first bit block is used to determine the target radio resource block.

In one embodiment, when the first radio resource block group comprises a radio resource block corresponding to the first priority, when a priority corresponding to the first bit block is not a first priority, the target radio resource block is a radio resource block in the first radio resource block group, and a bit block generated by the first bit block is transmitted in the radio resource block in the first radio resource block group; when a priority corresponding to the first bit block is a first priority, the target radio resource block is the second radio resource block, and a bit block generated by the first bit block is transmitted in the second radio resource block.

In one embodiment, the radio resource block in the first radio resource block group comprises resources reserved for a physical-layer channel.

In one embodiment, the radio resource block in the first radio resource block group comprises time-frequency resources reserved for a PUSCH.

In one embodiment, the phrase of being transmitted in the radio resource block in the first radio resource block group comprises: being transmitted in a PUSCH; the radio resource block in the first radio resource block group comprising time-frequency resources occupied by the PUSCH.

In one embodiment, the second radio resource block comprises resources reserved for another physical-layer channel.

In one embodiment, the second radio resource block comprises radio resources reserved for a PUCCH.

In one embodiment, the phrase of being transmitted in the second radio resource block comprises: being transmitted in a PUCCH; the second radio resource block comprising radio resources occupied by the PUCCH.

In one embodiment, the second radio resource block corresponds to a priority in the first priority set.

In one embodiment, a first radio resource block set comprises multiple radio resource blocks.

In one embodiment, the first radio resource block set comprises the second radio resource block; all radio resource blocks in the first radio resource block set correspond to a same priority.

In one embodiment, each radio resource block in the first radio resource block set is reserved for the first bit block.

In one embodiment, each radio resource block in the first radio resource block set is reserved for a bit block generated by the first bit block.

In one embodiment, each radio resource block in the first radio resource block set is respectively reserved for a transmission of multiple repetitions of a bit block generated by the first bit block.

In one embodiment, each radio resource block in the first radio resource block set is respectively reserved for one of multiple repetitions on a PUCCH.

In one embodiment, any radio resource block other than the second radio resource block in the first radio resource block set and all radio resource blocks in the first radio resource block group are non-overlapping in time domain.

In one embodiment, a radio resource block other than the second radio resource block in the first radio resource block set and a radio resource block in the first radio resource block group are overlapping in time domain.

In one embodiment, the multiple repetitions in the present application comprise multiple repetitions on multiple slots.

In one embodiment, the multiple repetitions in the present application comprise multiple repetitions on multiple sub-slots.

In one embodiment, the multiple repetitions in the present application comprise multiple repetitions within multiple periods.

In one embodiment, the multiple repetitions in the present application comprise multiple repetitions within a time window.

### Embodiment 10C

Embodiment 10C illustrates a schematic diagram of relations among a second field in a first signaling, a size of a first bit block and a number of bit(s) related to a second bit block and carried by a first signal according to one embodiment of the present application, as shown in FIG. 10C.

In embodiment 10C, a second field in a first signaling is used to whether a size of a first bit block is used to determine a number of bit(s) related to a second bit block and carried by a first signal.

In one embodiment, when a value of the second field in the first signaling is equal to a fourth value, a size of the first bit block is not used to determine the number of bit(s) related to the second bit block and carried by the first signal; when a value of the second field in the first signaling is not equal to the fourth value, a size of the first bit block is used to determine the number of bit(s) related to the second bit block and carried by the first signal.

In one embodiment, when a value of the second field in the first signaling is equal to a fourth value, a size of the first bit block is not used to determine the number of bit(s) related to the second bit block and carried by the first signal, and the number of bit(s) related to the second bit block and carried by the first signal is equal to a fifth number; when a value of the second field in the first signaling is not equal to the fourth value, a size of the first bit block is used to determine the number of bit(s) related to the second bit block and carried by the first signal.

In one subembodiment of the above embodiment, the value of the second field in the first signaling is not equal to the fourth value; when a number of bit(s) comprised in the first bit block is not greater then a first number, the number of bit(s) related to the second bit block and carried by the first signal is equal to a second number; when a number of bit(s) comprised in the first bit block is greater than a first number, the number of bit(s) related to the second bit block and carried by the first signal is equal to a third number.

In one subembodiment of the above embodiment, the value of the second field in the first signaling is not equal to the fourth value; the number of bit(s) related to the second bit block and carried by the first signal is equal to a second number; the first bit block is used to determine the second number.

In one subembodiment of the above embodiment, when the value of the second field in the first signaling is not equal to the fourth value, the value of the second field in the first signaling is equal to a fifth value.

In one embodiment, the fifth number is equal to 0.

In one embodiment, the fifth number is configured at a higher layer.

In one embodiment, the fifth number is pre-configured.

In one embodiment, the fifth number is pre-defined.

In one embodiment, the fifth number is configured at an RRC layer.

In one embodiment, the fifth number is configured at a MAC layer.

In one embodiment, the fifth number is equal to 1.

In one embodiment, the fifth number is equal to 2.

In one embodiment, the fifth number is equal to a positive integer not greater than 2000.

In one embodiment, the second number is configured at a higher layer.

In one embodiment, the third number is configured at a higher layer.

In one embodiment, the second number is pre-configured.

In one embodiment, the third number is pre-configured.

In one embodiment, the second number is pre-defined.

In one embodiment, the third number is pre-defined.

In one embodiment, the second number is configured at an RRC layer.

In one embodiment, the second number is configured at a MAC layer.

In one embodiment, the third number is configured at an RRC layer.

In one embodiment, the third number is configured at a MAC layer.

In one embodiment, the second number is equal to a number of bit(s) of the second-type HARQ-ACK comprised in the second bit block.

In one embodiment, the third number is equal to a number of bit(s) of the second-type HARQ-ACK comprised in the second bit block.

In one embodiment, the second bit block is used to determine the second number.

In one embodiment, the second bit block is used to determine the third number.

In one embodiment, the second number is equal to 1.

In one embodiment, the third number is equal to 1.

In one embodiment, the second number is not greater than 2.

In one embodiment, the third number is not greater than 2.

In one embodiment, the second number is equal to 0.

In one embodiment, the third number is equal to 0.

In one embodiment, the second number is not equal to the third number.

In one embodiment, the second number is equal to a smallest value between a number of bit(s) comprised in the second bit block and a fourth number.

In one embodiment, the third number is equal to a smallest value between a number of bit(s) comprised in the second bit block and a fourth number.

In one embodiment, the fourth number is configured at a higher layer.

In one embodiment, the fourth number is pre-configured.

In one embodiment, the first bit block is used to determine the fourth number.

In one embodiment, a number of bit(s) comprised in the first bit block is used to determine the fourth number.

In one embodiment, the fourth number is equal to a first number threshold minus a number of bit(s) comprised in the first bit block.

In one embodiment, the fourth number is linearly related to a number of bit(s) comprised in the first bit block.

In one embodiment, the first number threshold is pre-configured.

In one embodiment, the first number threshold is predefined.

In one embodiment, the fourth number is configured at an RRC layer.

In one embodiment, the fourth number is configured at a MAC layer.

In one embodiment, the fourth value is equal to 0, and the fifth value is equal to 1.

In one embodiment, the fourth value is equal to 1, and the fifth value is equal to 0.

In one embodiment, the fourth value is equal to one of 00, 01, 10 or 11.

In one embodiment, the value of the second field in the first signaling is not equal to the fourth value; when the number of bit(s) related to the second bit block and carried by the first signal is less than the fourth number: the first signal carries a positive integer number of zero-padding bit(s).

In one embodiment, the phrase of the second field in the first signaling being used to determine the number of bit(s) related to the second bit block and carried by the first signal comprises: the second field in the first signaling is used to determine a size of the first bit block; a size of the first bit block is used to determine the number of bit(s) related to the second bit block and carried by the first signal.

In one embodiment, the second field in the first signaling is used to calculate a Downlink Assignment Index (DAI) field of the first-type HARQ-ACK comprised in the first bit block.

In one embodiment, the second field in the first signaling is used to determine a size of the first bit block; when a number of bit(s) comprised in the first bit block is not greater then a first number, the number of bit(s) related to the second bit block and carried by the first signal is equal to a second number; when a number of bit(s) comprised in the first bit block is greater than a first number, the number of bit(s) related to the second bit block and carried by the first signal is equal to a third number.

In one embodiment, when a number of bit(s) comprised in the first bit block is not greater than the first number, the first bit block and a bit block generated by the second bit block are used together to determine a first radio resource block set.

In one embodiment, when a number of bit(s) comprised in the first bit block is not greater than the first number, the first bit block is used to determine a first radio resource block, and a bit block generated by the second bit block is not used to determine the first radio resource block set.

In one embodiment, when a number of bit(s) comprised in the first bit block is greater than the first number, the first bit block and a bit block generated by the second bit block are used together to determine a first radio resource block set.

In one embodiment, when a number of bit(s) comprised in the first bit block is greater than the first number, the first bit block is used to determine a first resource set, and a bit block generated by the second bit block is not used to determine a first radio resource block set.

In one embodiment, when a size of the first bit block is used to determine the number of bit(s) related to the second bit block and carried by the first signal: a number of bit(s) comprised in the first bit block and a number of bit(s) comprised in the second bit block are used to determine the number of bit(s) related to the second bit block and carried by the first signal.

### Embodiment 10D

Embodiment 10D illustrates a schematic diagram of a relation between K and a first RV according to one embodiment of the present application, as shown in FIG. 10D.

In embodiment 10D, K is used to determine a first RV.

In one subembodiment of embodiment 10D, the number in the present application of the time element(s) in the present application comprised in the first time window in the present application is not greater than the first number in the present application.

In one embodiment, a first RV set comprises multiple RVs; a first element set comprises multiple elements; each RV in the first RV set respectively corresponds to an element in the first element set; K is associated with an element in the first element set; the first RV is an RV corresponding to the element in the first element set to which the K is associated in the first RV set.

In one embodiment, the first element set comprises two elements of odd number and even number.

In one embodiment, when K is an odd number, the first RV is RV j1; when K is an even number, the first RV is RV j2; j1 is not equal to the j2.

In one embodiment, j1 and j2 are respectively equal to one of 0, 1, 2 or 3.

In one embodiment, the RV j1 and the RV j2 are configured by a higher-layer signaling.

In one embodiment, the RV j1 and the RV j2 are configured by a RRC signaling.

In one embodiment, the RV j1 and the RV j2 are configured by a MAC CE signaling.

In one embodiment, the RV j1 and the RV j2 are pre-defined.

In one embodiment, the RV j1 and the RV j2 are fixed.

In one embodiment, each element comprised in the first element set respectively corresponds to a number range; the phrase of K being associated with an element in the first element set comprises: K belongs to a number range corresponding to the element in the first element set.

### Embodiment 11A

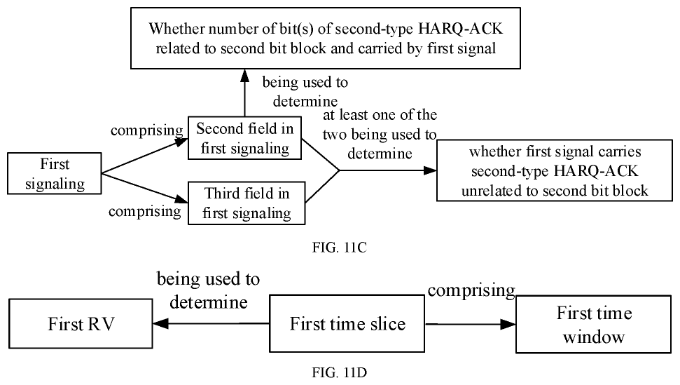

Embodiment 11A illustrates a schematic diagram of relations among a number of bit(s) comprised in a first bit block, a number of bit(s) comprised in a fourth bit block, a first number and a number of bit(s) comprised in a third bit block according to one embodiment of the present application, as shown in FIG. 11A.

In embodiment 11A, a number of bit(s) comprised in a first bit block and a number of bit(s) comprised in a fourth bit block are used to determine a first number; a number of bit(s) comprised in the fourth bit block is less than a number of bit(s) comprised in a third bit block.

In one embodiment, the seventh bit block in the present application is used to generate the fourth bit block.

In one embodiment, the fourth bit block comprises partial bits in the seventh bit block.

In one embodiment, the fourth bit block comprises an output acquired after partial or all bits in the seventh bit block sequentially through one or more operations of logic and, logical or, xor, deleting bit or zero-padding.

In one embodiment, both the fourth bit block and the third bit block are bit blocks generated by the seventh bit block.

In one embodiment, the third bit block is used to generate the fourth bit block.

In one embodiment, the fourth bit block comprises partial bits in the third bit block.

In one embodiment, the fourth bit block comprises an output acquired after partial or all bits in the third bit block sequentially through one or more operations of logic and, logical or, xor, deleting bit or zero-padding.

In one embodiment, the first number is equal to a sum of a number of bit(s) comprised in the first bit block and a number of bit(s) comprised in the fourth bit block.

In one embodiment, a sum of a number of bit(s) comprised in the first bit block and a number of bit(s) comprised in a fourth bit block is used to determine the first number.

### Embodiment 11B

Embodiment 11B illustrates a structure block diagram of a processor in a first node, as shown in FIG. 11B. In FIG. 11B, a processor 1100 in a first node comprises a first receiver 1101 and a first transmitter 1102.

In one embodiment, the first node 1100 is a UE.

In one embodiment, the first node 1100 is a relay node.

In one embodiment, the first node 1100 is a vehicle-mounted communication device.

In one embodiment, the first node 1100 is a UE that supports V2X communications.

In one embodiment, the first node 1100 is a relay node that supports V2X communications.

In one embodiment, the first receiver 1101 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1101 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1102 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1102 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first two of the antenna 452, the transmitter 454, the multi-antenna transmitting processor 457, the transmitting processor 468, the controller/processor 459, the memory 460, and the data source 467 in FIG. 4 of the present application.

In Embodiment 11B, the first receiver 1101 receives a first signaling; the first transmitter 1102 transmits a first signal in a target radio resource block, the first signal carries a bit block generated by a first bit block; the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one embodiment, when the first radio resource block group comprises a radio resource block corresponding to the first priority, a priority corresponding to the first bit block is not used to determine the target radio resource block; when the first radio resource block group does not comprise a radio resource block corresponding to the first priority, a priority corresponding to the first bit block is used to determine the target radio resource block.

In one embodiment, a second priority set comprises multiple priorities; the priority corresponding to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group.

In one embodiment, the first radio resource block group does not comprise a radio resource block corresponding to the first priority; when the priority corresponding to the first bit block is not the first priority, the target radio resource block is a radio resource block in the first radio resource block group, and a bit block generated by the first bit block is transmitted in the radio resource block in the first radio resource block group; when the priority corresponding to the first bit block is the first priority, the target radio resource block is the second radio resource block, and a bit block generated by the first bit block is transmitted in the second radio resource block.

In one embodiment, when the first radio resource block group does not comprise a radio resource block corresponding to the first priority, a size relation between a value of the priority corresponding to the first bit block and a first threshold is used to determine the target radio resource block.

In one embodiment, a value of the priority corresponding to the first bit block is less than a second threshold; the second threshold is greater than the first threshold.

In one embodiment, when the first radio resource block group does not comprise a radio resource block corresponding to the first priority, a bit block generated by the first bit block is transmitted in the second radio resource block; when the first radio resource block group comprises a radio resource block corresponding to the first priority, a priority corresponding to the first bit block is used to determine the target radio resource block.

In one embodiment, the second radio resource block comprises radio resources reserved fora first PUCCH; a radio resource block in the first radio resource block group comprises radio resources reserved for a PUSCH; when a priority corresponding to the first PUSCH is the first priority, a priority corresponding to the first bit block is not used to determine the target radio resource block, the target radio resource block is the radio resource block in the first radio resource block group, and a bit block generated by the first bit block is transmitted on the first PUSCH; when a priority corresponding to the first PUSCH is the second priority and a priority corresponding to the first bit block is the second priority, the target radio resource block is the radio resource block in the first radio resource block group, and a bit block generated by the first bit block is transmitted on the first PUSCH; when a priority corresponding to the first PUSCH is the second priority and a priority corresponding to the first bit block is the first priority, the target radio resource block is the second radio resource block, and a bit block generated by the first bit block is transmitted on the first PUCCH.

In one subembodiment of the above embodiment, when a priority corresponding to the first PUSCH is the second priority and a priority corresponding to the first bit block is the first priority, the first PUSCH is not transmitted.

In one subembodiment of the above embodiment, the first bit block comprises a first bit sub-block group; the first bit sub-block group comprises a bit sub-block corresponding to the second priority.

In one embodiment, the second radio resource block comprises radio resources reserved fora first PUCCH; a radio resource block in the first radio resource block group comprises radio resources reserved for a PUSCH; the first priority and the second priority respectively correspond to priority index 1 and priority index 0; when a priority index corresponding to the first PUSCH is equal to 1, a priority corresponding to the first bit block is not used to determine the target radio resource block, the target radio resource block is the radio resource block in the first radio resource block group, and a bit block generated by the first bit block is transmitted on the first PUSCH; when a priority index corresponding to the first PUSCH is equal to 0 and a priority index corresponding to the first bit block is equal to 0, the target radio resource block is the radio resource block in the first radio resource block group, and a bit block generated by the first bit block is transmitted on the first PUSCH; when a priority index corresponding to the first PUSCH is equal to 0 and a priority index corresponding to the first bit block is equal to 1, the target radio resource block is the second radio resource block, and a bit block generated by the first bit block is transmitted on the first PUCCH.

In one subembodiment of the above embodiment, when a priority index corresponding to the first PUSCH is equal to 0 and a priority index corresponding to the first bit block is equal to 1, the first PUSCH is not transmitted.

In one subembodiment of the above embodiment, the first bit block comprises one of a HARQ-ACK corresponding to the priority index 0 and a HARQ-ACK corresponding to the priority index 1.

In one embodiment, the second radio resource block comprises radio resources reserved for a first PUCCH; a radio resource block in the first radio resource block group comprises radio resources reserved for a PUSCH; the first priority and the second priority respectively correspond to priority index 1 and priority index 0; the first bit block comprises a bit sub-block corresponding to the priority index 0; when a priority index corresponding to the first PUSCH is equal to 1, the target radio resource block is the radio resource block in the first radio resource block group, and a bit block generated by the first bit block is transmitted on the first PUSCH; when a priority index corresponding to the first PUSCH is equal to 0 and the first bit block only comprises one or multiple bit sub-blocks corresponding to the priority index 0, the target radio resource block is the radio resource block in the first radio resource block group, and a bit block generated by the first bit block is transmitted on the first PUSCH; when a priority index corresponding to the first PUSCH is equal to 0 and the first bit block also comprises a bit sub-block corresponding to the priority index 1, the target radio resource block is the second radio resource block, and a bit block generated by the first bit block is transmitted on the first PUCCH.

In one subembodiment of the above embodiment, when a priority index corresponding to the first PUSCH is equal to 0 and the first bit block also comprises a bit sub-block corresponding to the priority index 1, the first PUSCH is not transmitted.

In one subembodiment of the above embodiment, the first bit block comprises at least a former of a HARQ-ACK corresponding to the priority index 0 and a HARQ-ACK corresponding to the priority index 1.

In one subembodiment of the above embodiment, the bit sub-block corresponding to the priority index 0 comprised in the first bit block comprises a HARQ-ACK corresponding to the priority index 0.

### Embodiment 11C

Embodiment 11C illustrates a schematic diagram of relations among a first signaling, a second field in a first signaling, a third field in a first signaling and a HARQ_ACK carried by a first signal according to one embodiment of the present application, as shown in FIG. 11C.

In embodiment 11C, a first signaling comprises a second field and a third field; the second field in the first signaling is used to determine whether a number of bit(s) of a second-type HARQ-ACK related to a second bit block and carried by a first signal is greater than 0; at least one of the second field in the first signaling or the third field in the first signaling is used to determine whether the first signal carries the second-type HARQ-ACK unrelated to the second bit block.

In one subembodiment of embodiment 11C, when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

In one embodiment, the first signaling comprises a third field; the third field in the first signaling is used to determine whether the first signal carries the second-type HARQ-ACK unrelated to the second bit block.

In one embodiment, the first signaling comprises a third field; the second field in the first signaling is used to determine whether the third field in the first signaling is used to determine whether the first signal carries the second-type HARQ-ACK unrelated to the second bit block.

In one embodiment, when a value of the second field in the first signaling is equal to a sixth value, the third field in the first signaling is used to determine whether the first signal carries the second-type HARQ-ACK unrelated to the second bit block; when the value of the second field in the first signaling is not equal to the sixth value, the third field in the first signaling is not used to determine whether the first signal carries the second-type HARQ-ACK unrelated to the second bit block, the first signal does not carry the second-type HARQ-ACK unrelated to the second bit block.

In one embodiment, when a value of the second field in the first signaling is equal to the sixth value, the number of bit(s) of the second-type HARQ-ACK related to the second bit block and carried by the first signal is greater than 0; when the value of the second field in the first signaling is not equal to the sixth value, the number of bit(s) of the second-type HARQ-ACK related to the second bit block and carried by the first signal is equal to 0.

In one embodiment, the first signaling comprises a third field; a value of the third field in the first signaling is not equal to a seventh value.

In one embodiment, the first signaling comprises a third field; only when a value of the third field in the first signaling is not equal to a seventh value, the second field in the first signaling is used to determine whether a number of bit(s) of the second-type HARQ-ACK related to the second bit block and carried by the first signal is greater than 0.

In one embodiment, the phrase of the number of bit(s) of the second-type HARQ-ACK related to the second bit block and carried by the first signal being greater than 0 comprises: the first signal carrying the second-type HARQ-ACK related to the second bit block.

In one embodiment, the phrase of the number of bit(s) of the second-type HARQ-ACK related to the second bit block and carried by the first signal being equal to 0 comprises: the first signal not carrying the second-type HARQ-ACK related to the second bit block.

In one subembodiment of the above embodiment, when a value of the third field in the first signaling is equal to the seventh value, a number of bit(s) of the second-type HARQ-ACK related to the second bit block and carried by the first signal is equal to 0.

In one embodiment, when the value of the second field in the first signaling is equal to the sixth value and the value of the third field in the first signaling is equal to the seventh value, the first signal carries the first-type HARQ-ACK unrelated to the first bit block.

In one embodiment, when the value of the second field in the first signaling is equal to the sixth value and the value of the third field in the first signaling is equal to the seventh value, the first signal carries the second-type HARQ-ACK related to the second bit block.

In one embodiment, when the value of the second field in the first signaling is equal to the sixth value and the value of the third field in the first signaling is not equal to the seventh value, the first signal carries the second-type HARQ-ACK related to the second bit block.

In one embodiment, when the value of the second field in the first signaling is not equal to the sixth value and the value of the third field in the first signaling is equal to the seventh value, the first signal carries the first-type HARQ-ACK unrelated to the first bit block.

In one embodiment, the phrase of a bit of the second-type HARQ-ACK being related to the second bit block comprises: the second-type HARQ-ACK comprised in the second bit block.

In one embodiment, the phrase of a bit of the second-type HARQ-ACK being related to the second bit block comprises: all or partial bits in the second-type HARQ-ACK information bit comprised in the second bit block.

In one embodiment, the phrase of a bit of the second-type HARQ-ACK being related to the second bit block comprises: a bit related to the second-type HARQ-ACK comprised in the second bit block.

In one embodiment, a first downlink channel group and a second downlink channel group are respectively different downlink channel groups.

In one embodiment, the second bit block is not used to determine the second-type HARQ-ACK unrelated to the second bit block.

In one embodiment, the second-type HARQ-ACK related to the second bit block corresponds to a first downlink channel group; the second-type HARQ-ACK unrelated to the second bit block corresponds to a second downlink channel group.

In one embodiment, the second-type HARQ-ACK related to the second bit block is used to indicate whether a bit block corresponding to the second index in the present application transmitted in a first downlink channel group is correctly received; the second-type HARQ-ACK unrelated to the second bit block is used to indicate whether a bit block corresponding to the second index in the present application transmitted in a second downlink channel group is correctly received.

In one embodiment, the first downlink channel group is a PDSCH group, and the second downlink channel group is another PDSCH group.

In one embodiment, the first downlink channel group and the second downlink channel group respectively correspond to different PDSCH group indexes.

In one embodiment, a PDSCH group index of the first downlink channel group is equal to 0, and a PDSCH group index of the second downlink channel group is equal to 1.

In one embodiment, a PDSCH group index of the first downlink channel group is equal to 1, and a PDSCH group index of the second downlink channel group is equal to 0.

In one embodiment, the number of bit(s) of the second-type HARQ-ACK related to the second bit block and carried by the first signal is the number of bit(s) related to the second bit block and carried by the first signal in the present application.

In one embodiment, the phrase of the first signal not carrying the second-type HARQ-ACK unrelated to the second bit block comprises: the first signal does not carry the second-type HARQ-ACK unrelated to the second bit block.

In one embodiment, the phrase of the first signal not carrying the second-type HARQ-ACK unrelated to the second bit block comprises: the first signal does not carry any second-type HARQ-ACK, or, the second-type HARQ-ACK(s) carried by the first signal is(are) the second-type HARQ-ACK(s) related to the second bit block.

In one embodiment, both the first bit block and the second bit block correspond to the first downlink channel group.

In one embodiment, the first-type HARQ-ACK comprised in the first bit block corresponds to the first downlink channel group.

In one embodiment, the third field indicates whether the first signal carries a HARQ-ACK corresponding to a downlink channel group or a HARQ-ACK corresponding to multiple downlink channel groups.

In one embodiment, the third field is used to determine whether the first signal carries a HARQ-ACK corresponding to the second downlink channel group.

In one embodiment, a value of the third field is equal to one of 0 or 1; value 0 indicates that the first signal carries only a former of a HARQ-ACK corresponding to the first downlink channel group and a HARQ-ACK corresponding to the second downlink channel group; value 1 indicates that the first signal carries a HARQ-ACK corresponding to the first downlink channel group and a HARQ-ACK corresponding to the second downlink channel group.

In one embodiment, the third field comprises a Number of requested PDSCH group(s) field.

In one embodiment, the third field comprises one bit.

In one embodiment, the third field comprises multiple bits.

In one embodiment, the first signaling indicates the first downlink channel group.

In one embodiment, the second signaling indicates the first downlink channel group.

In one embodiment, the first signaling comprises a fourth field; the fourth field in the first signaling indicates an index corresponding to the first downlink channel group.

In one embodiment, the second signaling comprises a fourth field; the fourth field in the second signaling indicates an index corresponding to the first downlink channel group.

In one embodiment, the fourth field comprises a PDSCH group index field.

In one embodiment, the fourth field comprises 1 bit.

In one embodiment, the fourth field comprises multiple bits.

In one embodiment, the sixth value is equal to 1.

In one embodiment, the seventh value is equal to 1.

In one embodiment, the sixth value is equal to 0.

In one embodiment, the seventh value is equal to 0.

In one embodiment, when the value of the third field in the first signaling is equal to the seventh value, the first signal carries a bit of the first-type HARQ-ACK unrelated to the first bit block.

In one embodiment, when the value of the third field in the first signaling is equal to the seventh value, the first signal carries at least one of the first-type HARQ-ACK unrelated to the first bit block or the second-type HARQ-ACK unrelated to the second bit block.

In one embodiment, when the value of the third field in the first signaling is equal to the seventh value, the first signal carries only one of the first-type HARQ-ACK unrelated to the first bit block or the second-type HARQ-ACK unrelated to the second bit block.

In one embodiment, the first-type HARQ-ACK unrelated to the first bit block comprises the first-type HARQ-ACK related to the second downlink channel group.

In one embodiment, the first-type HARQ-ACK comprised in the first bit block is used to indicate whether a bit block corresponding to the first index in the present application transmitted in the first downlink channel group is correctly received; the first-type HARQ-ACK unrelated to the first bit block is used to indicate whether a bit block corresponding to the first index in the present application transmitted in the second downlink channel group is correctly received.

In one embodiment, the first signaling comprises a fifth field; when the first signal carries the first-type HARQ-ACK unrelated to the first bit block and the second-type HARQ-ACK related to the second bit block: the fifth field comprised in the first signaling is used to determine only a former of the first-type HARQ-ACK unrelated to the first bit block and the second-type HARQ-ACK related to the second bit block.

In one embodiment, the first signaling comprises a fifth field; when the first signal carries the first-type HARQ-ACK unrelated to the first bit block and the second-type HARQ-ACK related to the second bit block: the fifth field comprised in the first signaling is used to determine only a latter of the first-type HARQ-ACK unrelated to the first bit block and the second-type HARQ-ACK related to the second bit block.

In one embodiment, the first signaling comprises a fifth field; when the first signal carries the second-type HARQ-ACK unrelated to the second bit block and the second-type HARQ-ACK related to the second bit block: the fifth field comprised in the first signaling is used to determine only a former of the second-type HARQ-ACK unrelated to the second bit block and the second-type HARQ-ACK related to the second bit block.

In one embodiment, the first signaling comprises a fifth field; when the first signal carries the second-type HARQ-ACK unrelated to the second bit block and the second-type HARQ-ACK related to the second bit block: the fifth field comprised in the first signaling is used to determine only a latter of the second-type HARQ-ACK unrelated to the second bit block and the second-type HARQ-ACK related to the second bit block.

In one embodiment, the first signaling comprises a fifth field; when the first signal carries the first-type HARQ-ACK unrelated to the first bit block and the second-type HARQ-ACK unrelated to the second bit block: the fifth field comprised in the first signaling is used to determine only a former of the first-type HARQ-ACK unrelated to the first bit block and the second-type HARQ-ACK unrelated to the second bit block.

In one embodiment, the first signaling comprises a fifth field; when the first signal carries the first-type HARQ-ACK unrelated to the first bit block and the second-type HARQ-ACK unrelated to the second bit block: the fifth field comprised in the first signaling is used to determine only a latter of the first-type HARQ-ACK unrelated to the first bit block and the second-type HARQ-ACK unrelated to the second bit block.

In one embodiment, the fifth field is a Downlink Assignment Index (DAI) field.

In one embodiment, the fifth field comprises a total DAI.

In one embodiment, the fifth field comprises 2 bits of a total DAI.

In one embodiment, the fifth field comprises 4 bits of a total DAI.

In one embodiment, when a value of the second field in the first signaling is equal to an eighth value, the number of bit(s) of the second-type HARQ-ACK related to the second bit block and carried by the first signal is greater than 0; when the value of the second field in the first signaling is not equal to the eighth value, the number of bit(s) of the second-type HARQ-ACK related to the second bit block and carried by the first signal is equal to 0.

In one embodiment, when the value of the second field in the first signaling is not equal to the eighth value, the first signal carries at most one of the first-type HARQ-ACK unrelated to the first bit block or the second-type HARQ-ACK unrelated to the second bit block.

In one embodiment, when the value of the second field in the first signaling is not equal to the eighth value, the first signal carries the first-type HARQ-ACK unrelated to the first bit block or the second-type HARQ-ACK unrelated to the second bit block.

In one embodiment, the eighth value is equal to one of 00, 01, 10 or 11.

### Embodiment 11D

Embodiment 11D illustrates a schematic diagram of relations among a first time slice, a first time window, a first RV according to one embodiment of the present application, as shown in FIG. 11D.

In embodiment 11D, a first time slice comprises a first time window, and the first time slice is used to determine a first RV.

In one subembodiment of embodiment 11D, the number in the present application of the time element(s) in the present application comprised in the first time window in the present application is not greater than the first number in the present application.

In one embodiment, the first time slice is reserved for a nominal repetition of the first bit block.

In one embodiment, the first time slice is a time slice in a first time slice set.

In one embodiment, each time slice in the first time slice set comprises one or multiple time windows in the K time windows in the present application.

In one embodiment, the first time slice comprises one or multiple time windows in the K time windows in the present application.

In one embodiment, each time slice in the first time slice set respectively corresponds to an RV; the first RV is an RV corresponding to the first time slice.

In one embodiment, an RV corresponding to a time slice in the first time slice set is equal to one of 0, 1, 2 or 3.

In one embodiment, an RV corresponding to a time slice in the first time slice set is configured by a higher-layer signaling.

In one embodiment, an RV corresponding to a time slice in the first time slice set is configured by an RRC signaling.

In one embodiment, an RV corresponding to a time slice in the first time slice set is configured by a MAC CE signaling.

In one embodiment, an RV corresponding to a time slice in the first time slice set is pre-defined.

In one embodiment, an RV corresponding to a time slice in the first time slice set is equal to one of 0, 1, 2 or 3.

In one embodiment, an RV corresponding to any time slice in the first time slice set is configured by a higher-layer signaling.

In one embodiment, an RV corresponding to any time slice in the first time slice set is configured by an RRC signaling.

In one embodiment, an RV corresponding to any time slice in the first time slice set is configured by a MAC CE signaling.

In one embodiment, an RV corresponding to any time slice in the first time slice set is pre-defined.

In one embodiment, an order of the first time slice in the first time slice set (according to an ascending chronological order of start times of time slices) is used to determine the first RV.

In one embodiment, the first time slice is a u-th time slice in the first time slice set.

In one embodiment, according to an ascending chronological order of start times of time slices, the first time slice is a u-th time slice in the first time slice set.

In one embodiment, the first time slice is a u-th time slice in the first time slice set; a number of time slice(s) whose start time(s) being earlier than a start time of the first time slice in the first time slice set is equal to u−1.

In one embodiment, u is a positive integer.

In one embodiment, u is not greater than a number of time slice(s) comprised in the first time slice set.

In one embodiment, when u is an odd number, the first RV is RV u1; when u is an even number, the first RV is RV u2; u1 is not equal to u2.

In one embodiment, u1 and the u2 are respectively equal to one of 0, 1, 2 or 3.

In one embodiment, both the RV u1 and the RV u2 are configured by a higher-layer signaling.

In one embodiment, both the RV u1 and the RV u2 are configured by an RRC signaling.

In one embodiment, both the RV u1 and the RV u2 are configured by a MAC CE signaling.

In one embodiment, both the RV u1 and the RV u2 are pre-defined.

In one embodiment, both the RV u1 and the RV u2 are fixed.

In one embodiment, u and a first value sequence are used together to determine the first RV.

In one embodiment, a first value sequence comprises P values, and the P values are sequentially i_0, i_1, . . . , i_{P−1}; P is greater than 1; when the result acquired after executing the modulo operation on the P after subtracting 1 from the u is equal to e((u−1) mod P=e), the first redundant version is RV i_e.

### Embodiment 12A

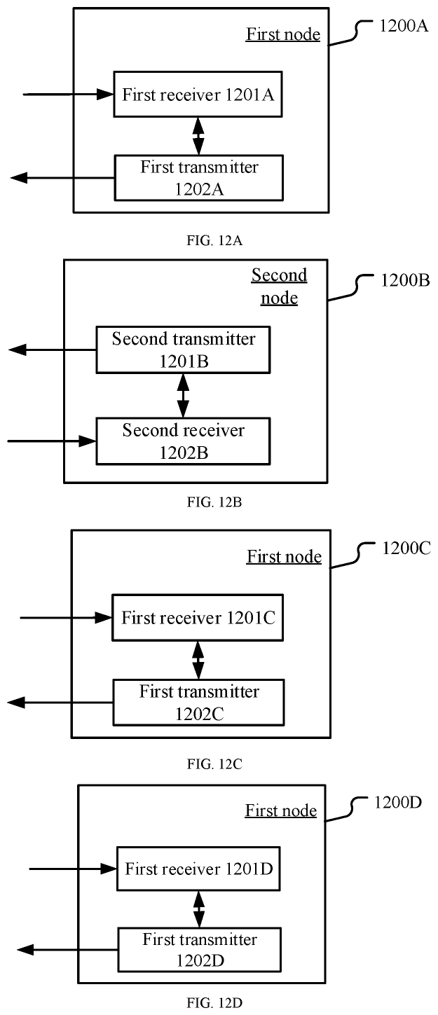

Embodiment 12A illustrates a structure block diagram of a processor in a first node, as shown in FIG. 12A. In FIG. 12A, a processor 1200A in a first node comprises a first receiver 1201A and a first transmitter 1202A.

In one embodiment, the first node 1200A is a UE.

In one embodiment, the first node 1200A is a relay node.

In one embodiment, the first node 1200A is a vehicle-mounted communication device.

In one embodiment, the first node 1200A is a UE that supports V2X communications.

In one embodiment, the first node 1200A is a relay node that supports V2X communications.

In one embodiment, the first receiver 1201A comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201A comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201A comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201A comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201A comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202A comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202A comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202A comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202A comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202A comprises at least first two of the antenna 452, the transmitter 454, the multi-antenna transmitting processor 457, the transmitting processor 468, the controller/processor 459, the memory 460, and the data source 467 in FIG. 4 of the present application.

In embodiment 12A, the first receiver 1201A receives a first signaling and a second signaling; the first transmitter 1202A transmits a first signal in a target radio resource block, and the first signal carries a first bit block; the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one embodiment, the first bit block comprises a first-type HARQ-ACK; the third bit block comprises a second-type HARQ-ACK.

In one embodiment, when a priority of the second bit block is a first priority, the target radio resource block is the fourth radio resource block; when a priority of the second bit block is not the first priority, the target radio resource block is the first radio resource block.

In one embodiment, a fifth radio resource block is reserved for the first bit block; a third radio resource block is reserved for the third bit block; the fifth radio resource block overlaps with the third radio resource block in time domain.

In one embodiment, N number range(s) corresponds (respectively correspond) to N radio resource block set(s); a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block set(s); the first radio resource block set comprises the first radio resource block.

In one embodiment, when the target radio resource block is the first radio resource block, the first node does not transmit a signal carrying the second bit block in a second radio resource sub-block; the second radio resource sub-block is a part overlapping with the first radio resource block in time domain and comprised in the second radio resource block.

In one embodiment, the first number is used to determine the fourth radio resource block; a number of bit(s) comprised in the first bit block and a number of bit(s) comprised in a fourth bit block are used to determine the first number; the fourth bit block is related to the third bit block; a number of bit(s) comprised in the fourth bit block is less than a number of bit(s) comprised in the third bit block.

In one embodiment, a first signaling is used to determine a first bit block, a second signaling is used to determine a third bit block; a first signaling indicates a first priority, and the second signaling indicates a second priority; a second radio resource block is reserved for a second bit block; a sum of a number of bit(s) comprised in the first bit block and a number of bit(s) comprised in the third bit block is used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block; when a priority of the second bit block is the first priority, the target radio resource block is the fourth radio resource block; when a priority of the second bit block is the second priority, the target radio resource block is the first radio resource block.

In one subembodiment of the above embodiment, the first bit block comprises a UCI corresponding to priority index 1, and the second bit block comprises a UCI corresponding to priority index 0.

In one subembodiment of the above embodiment, the first bit block comprises a UCI corresponding to priority index 0, and the second bit block comprises a UCI corresponding to priority index 1.

In one subembodiment of the above embodiment, the first bit block comprises a HARQ-ACK corresponding to priority index 1, and the second bit block comprises a HARQ-ACK corresponding to priority index 0.

In one subembodiment of the above embodiment, the first bit block comprises a HARQ-ACK corresponding to priority index 0, and the second bit block comprises a HARQ-ACK corresponding to priority index 1.

In one subembodiment of the above embodiment, the second bit block comprises a TB or a CB or a CBG.

In one subembodiment of the above embodiment, the first priority corresponds to priority index 1, and the second priority corresponds to priority index 0.

In one subembodiment of the above embodiment, the first priority corresponds to priority index 0, and the second priority corresponds to priority index 1.

In one subembodiment of the above embodiment, a fifth radio resource block is reserved for the first bit block; a third radio resource block is reserved for the third bit block; the fifth radio resource block overlaps with the third radio resource block in time domain; the fifth radio resource block and the second radio resource block are orthogonal in time domain; the second radio resource block and the third radio resource block are orthogonal in time domain.

In one subembodiment of the above embodiment, a fifth radio resource block is reserved for the first bit block; a third radio resource block is reserved for the third bit block; the fifth radio resource block overlaps with the third radio resource block in time domain; the first number is equal to the number of bit(s) comprised in the first bit block; the fourth radio resource block is the fifth radio resource block; the fifth radio resource block and the second radio resource block are orthogonal in time domain; the second radio resource block and the third radio resource block are orthogonal in time domain.

In one subembodiment of the above embodiment, the first radio resource block comprises a PUCCH resource.

In one subembodiment of the above embodiment, the fourth radio resource block comprises a PUCCH resource.

In one subembodiment of the above embodiment, a third radio resource block comprises a PUCCH resource.

In one subembodiment of the above embodiment, a fifth radio resource block comprises a PUCCH resource.

In one subembodiment of the above embodiment, the second radio resource block comprises a PUCCH resource.

In one subembodiment of the above embodiment, the second radio resource block comprises radio resources reserved for a PUSCH transmission.

In one subembodiment of the above embodiment, when the target radio resource block is the fourth radio resource block, and the first node in the present application transmits a second signal in the second radio resource block; when the target radio resource block is the first radio resource block, the first node does not transmit the second signal in the second radio resource block; the second signal carries the second bit block.

In one subembodiment of the above embodiment, when the target radio resource block is the fourth radio resource block, the first node in the present application transmits a second signal in the second radio resource block; when the target radio resource block is the first radio resource block, the first node does not transmit a part of the second signal mapped into a second radio resource sub-block; the second radio resource sub-block comprises a part of the second radio resource block being overlapping in time domain with time-domain resources occupied by the first radio resource block; the second signal carries the second bit block.

### Embodiment 12B

Embodiment 12B illustrates a structure block diagram of a processor in a second node, as shown in FIG. 12B. In FIG. 12B, a processor 1200B in a second node comprises a second transmitter 1201B and a second receiver 1202B.

In one embodiment, the second node 1200B is a UE.

In one embodiment, the second node 1200B is a base station.

In one embodiment, the second node 1200B is a relay node.

In one embodiment, the second node 1200B is a vehicle-mounted communication device.

In one embodiment, the second node 1200B is a UE that supports V2X communications. [moo] In one embodiment, the second transmitter 1201B comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1201B comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1202B comprises at least one of the antenna 420, the receiver 418, the multi-antenna receiving processor 472, the receiving processor 470, the controller/processor 475 or the memory 476 in FIG. 4 of the present application.

In one embodiment, the second receiver 1202B comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least first two of the antenna 420, the receiver 418, the multi-antenna receiving processor 472, the receiving processor 470, the controller/processor 475 and the memory 476 in FIG. 4 of the present application.

In embodiment 12B, the second transmitter 1201B transmits a first signaling; the second receiver 1202B receives a first signal in a target radio resource block, and the first signal carries a bit block generated by a first bit block; the first signaling is used to determine a second radio resource block; the second radio resource block and all radio resource blocks in a first radio resource block group are overlapping in time domain; any radio resource block in the first radio resource block group is reserved for a bit block; each radio resource block in the first radio resource block group corresponds to a priority in a first priority set; the first priority set comprises a first priority and a second priority, and the first priority is different from the second priority; the target radio resource block is the second radio resource block or a radio resource block in the first radio resource block group; whether a first condition is satisfied is used to determine whether a priority corresponding to the first bit block is used to determine the target radio resource block; the first condition comprises: the first radio resource block group comprises a radio resource block corresponding to the first priority.

In one embodiment, when the first radio resource block group comprises a radio resource block corresponding to the first priority, a priority corresponding to the first bit block is not used to determine the target radio resource block; when the first radio resource block group does not comprise a radio resource block corresponding to the first priority, a priority corresponding to the first bit block is used to determine the target radio resource block.

In one embodiment, a second priority set comprises multiple priorities; the priority corresponding to the first bit block is a priority in the second priority set; when the first radio resource block group comprises a radio resource block corresponding to the first priority, no matter the priority corresponding to the first bit block is which priority in the second priority set, a bit block generated by the first bit block is always transmitted in a radio resource block corresponding to the first priority and comprised in the first radio resource block group.

In one embodiment, the first radio resource block group does not comprise a radio resource block corresponding to the first priority; when the priority corresponding to the first bit block is not the first priority, the target radio resource block is a radio resource block in the first radio resource block group, and a bit block generated by the first bit block is transmitted in the radio resource block in the first radio resource block group; when the priority corresponding to the first bit block is the first priority, the target radio resource block is the second radio resource block, and a bit block generated by the first bit block is transmitted in the second radio resource block.

In one embodiment, when the first radio resource block group does not comprise a radio resource block corresponding to the first priority, a size relation between a value of the priority corresponding to the first bit block and a first threshold is used to determine the target radio resource block.

In one embodiment, a value of the priority corresponding to the first bit block is less than a second threshold; the second threshold is greater than the first threshold.

In one embodiment, when the first radio resource block group does not comprise a radio resource block corresponding to the first priority, a bit block generated by the first bit block is transmitted in the second radio resource block; when the first radio resource block group comprises a radio resource block corresponding to the first priority, a priority corresponding to the first bit block is used to determine the target radio resource block.

In one embodiment, the second radio resource block comprises radio resources reserved fora first PUCCH; a radio resource block in the first radio resource block group comprises radio resources reserved for a first PUSCH; another radio resource block in the first radio resource block group comprises radio resources reserved for a second PUSCH; a priority corresponding to the second PUSCH is the second priority; when a priority corresponding to the first PUSCH is the first priority, a priority corresponding to the first bit block is not used to determine the target radio resource block, the target radio resource block is the radio resource block in the first radio resource block group, and a bit block generated by the first bit block is always transmitted on the first PUSCH; when a priority corresponding to the first PUSCH is the second priority and a priority corresponding to the first bit block is the second priority, the target radio resource block is the radio resource block in the first radio resource block group or the another radio resource block in the first radio resource block group, and a bit block generated by the first bit block is transmitted on the first PUSCH or the second PUSCH; when a priority corresponding to the first PUSCH is the second priority and a priority corresponding to the first bit block is the first priority, the target radio resource block is the second radio resource block, and a bit block generated by the first bit block is transmitted on the first PUCCH.

In one subembodiment of the above embodiment, the first bit block comprises a first bit sub-block group; the first bit sub-block group comprises a bit sub-block corresponding to the second priority.

In one subembodiment of the above embodiment, when a priority corresponding to the first PUSCH is the second priority and a priority corresponding to the first bit block is the first priority, the first PUSCH and the second PUSCH are not transmitted.

In one subembodiment of the above embodiment, the first priority and the second priority respectively correspond to priority index 1 and priority index 0.

In one subembodiment of the above embodiment, the first bit block comprises a first bit sub-block group; the first bit sub-block group comprises a bit sub-block corresponding to the second priority; when the first bit block also comprises a bit sub-block of the first priority, the priority corresponding to the first bit block is the first priority; when the first bit block only comprises a bit sub-block of the second priority, the priority corresponding to the first bit block is the second priority.

In one subembodiment of the above embodiment, the first bit block comprises one of a HARQ-ACK corresponding to the priority index 0 and a HARQ-ACK corresponding to the priority index 1.

In one embodiment, the second radio resource block comprises radio resources reserved for a first PUCCH; a radio resource block in the first radio resource block group comprises radio resources reserved for a PUSCH; when a priority corresponding to the first PUSCH is the first priority, a priority corresponding to the first bit block is not used to determine the target radio resource block, the target radio resource block is the radio resource block in the first radio resource block group, and a bit block generated by the first bit block is transmitted on the first PUSCH; when a priority corresponding to the first PUSCH is the second priority and the value of the priority corresponding to the first bit block is not less than the first threshold, the target radio resource block is the radio resource block in the first radio resource block group, and a bit block generated by the first bit block is transmitted on the first PUSCH; when a priority corresponding to the first PUSCH is the second priority and the value of the priority corresponding to the first bit block is less than the first threshold, the target radio resource block is the second radio resource block, and a bit block generated by the first bit block is transmitted on the first PUCCH.

In one subembodiment of the above embodiment, when a priority corresponding to the first PUSCH is the second priority and the value of the priority corresponding to the first bit block is less than the first threshold, the first PUSCH is not transmitted.

In one subembodiment of the above embodiment, the value of the priority corresponding to the first bit block is less than a second threshold; the second threshold is greater than the first threshold.

In one subembodiment of the above embodiment, the first bit block comprises an SL HARQ-ACK.

In one embodiment, the second radio resource block comprises radio resources reserved for a first PUCCH; a radio resource block in the first radio resource block group comprises radio resources reserved for a PUSCH; another radio resource block in the first radio resource block group comprises radio resources reserved for a second PUSCH; a priority corresponding to the second PUSCH is the second priority; when a priority corresponding to the first PUSCH is the first priority, a priority corresponding to the first bit block is not used to determine the target radio resource block, the target radio resource block is the radio resource block in the first radio resource block group, and a bit block generated by the first bit block is always transmitted on the first PUSCH; when a priority corresponding to the first PUSCH is the second priority and the value of the priority corresponding to the first bit block is not less than the first threshold, the target radio resource block is the radio resource block in the first radio resource block group or the another radio resource block in the first radio resource block group, and a bit block generated by the first bit block is transmitted on the first PUSCH or the second PUSCH; when a priority corresponding to the first PUSCH is the second priority and the value of the priority corresponding to the first bit block is less than the first threshold, the target radio resource block is the second radio resource block, and a bit block generated by the first bit block is transmitted on the first PUCCH.

In one subembodiment of the above embodiment, when a priority corresponding to the first PUSCH is the second priority and the value of the priority corresponding to the first bit block is less than the first threshold, the first PUSCH and the second PUSCH are not transmitted.

In one subembodiment of the above embodiment, the value of the priority corresponding to the first bit block is less than a second threshold; the second threshold is greater than the first threshold.

In one subembodiment of the above embodiment, the first bit block comprises an SL HARQ-ACK.

In one embodiment, a first radio resource block set comprises the second radio resource block; a radio resource block in a first radio resource block set is reserved for executing multiple repetitions of a bit block generated by the first bit block on a first PUCCH; the second radio resource block is reserved for executing a transmission in multiple repetitions of a bit block generated by the first bit block on the first PUCCH; a radio resource block in the first radio resource block group comprises radio resources reserved for a PUSCH; when a priority corresponding to the first PUSCH is the second priority, a priority corresponding to the first bit block is not used to determine the target radio resource bock, the target radio resource block is the second radio resource block, and a transmitting end of the first signal executes a transmission in multiple repetitions of a bit block generated by the first bit block in the second radio resource block; when a priority corresponding to the first PUSCH is the first priority and a priority corresponding to the first bit block is the second priority, the target radio resource block is the radio resource block in the first radio resource block group, and a bit block generated by the first bit block is transmitted on the first PUSCH; when a priority corresponding to the first PUSCH is the first priority and a priority corresponding to the first bit block is the first priority, the target radio resource block is the second radio resource block, and a transmitting end of the first signal executes a transmission in multiple repetitions of a bit block generated by the first bit block in the second radio resource block.

In one subembodiment of the above embodiment, when a bit block generated by the first bit block is executed a transmission in multiple repetitions in the second radio resource block, the first PUSCH is not transmitted.

In one subembodiment of the above embodiment, when a bit block generated by the first bit block is transmitted on the first PUSCH, a transmitting end of the first signal drops a signal transmission on the first PUCCH in the second radio resource block.

In one subembodiment of the above embodiment, the first priority and the second priority respectively correspond to priority index 1 and priority index 0.

In one subembodiment of the above embodiment, the first radio resource block group only comprises the radio resource block in the first radio resource block group.

In one subembodiment of the above embodiment, the first bit block comprises one of a UCI corresponding to the first priority or a UCI corresponding to the second priority.

In one subembodiment of the above embodiment, the first bit block comprises one of a HARQ-ACK corresponding to the first priority or a HARQ-ACK corresponding to the second priority.

### Embodiment 12C

Embodiment 12C illustrates a structure block diagram of a processor in a first node, as shown in FIG. 12C. In FIG. 12C, a processor 1200C of the first node comprises a first receiver 1201 C and a first transmitter 1202C.

In one embodiment, the first node 1200C is a UE.

In one embodiment, the first node 1200C is a relay node.

In one embodiment, the first node 1200C is a vehicle-mounted communication device.

In one embodiment, the first node 1200C is a UE that supports V2X communications.

In one embodiment, the first node 1200C is a relay node that supports V2X communications.

In one embodiment, the first receiver 1201C comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201C comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201C comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201C comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201C comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202C comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202C comprises at least first five the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202C comprises at least first four the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202C comprises at least first three of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202C comprises at least first two of the antenna 452, the transmitter 454, the multi-antenna transmitting processor 457, the transmitting processor 468, the controller/processor 459, the memory 460, and the data source 467 in FIG. 4 of the present application.

In embodiment 12C, the first receiver 1201C receives a second signaling and a first signaling; the first transmitter 1202C transmits a first signal in a first radio resource block, and the first signal carries a first bit block; the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

In one embodiment, a third radio resource block is reserved for the first bit block; a second radio resource block is reserved for the second bit block; the third radio resource block and the second radio resource block are overlapping in time domain.

In one embodiment, the second field in the first signaling is used to determine whether a bit block generated by the second bit block is used to determine a first radio resource block set; the first radio resource block is a radio resource block in the first radio resource block set.

In one embodiment, the number of bit(s) related to the second bit block and carried by the first signal is equal to one of K candidate numbers; the second field in the first signaling indicates an index of the number of bit(s) related to the second bit block and carried by the first signal among the K candidate numbers; K is greater than 1.

In one embodiment, when a value of the second field in the first signaling is equal to a first value, the second field in the first signaling indicates that the number of bit(s) related to the second bit block and carried by the first signal is equal to 0; when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

In one embodiment, the second field in the first signaling is used to determine whether a size of the first bit block is used to determine the number of bit(s) related to the second bit block and carried by the first signal.

In one embodiment, the second field in the first signaling is used to determine whether a number of bit(s) of the second-type HARQ-ACK related to the second bit block and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

In one embodiment, the first radio resource block comprises a PUCCH resource; the first signal carries a first bit block; the first bit block comprises a first-type HARQ-ACK, and the second bit block comprises a second-type HARQ-ACK; the first-type HARQ-ACK corresponds to priority index 1, and the second-type HARQ-ACK corresponds to priority index 0; the first signaling comprises a DCI; the first signaling comprises a second field; the second field in the first signaling is used to determine a number of bit(s) related to the second bit block and carried by the first signal; the second field in the first signaling is used to determine whether a bit block generated by the second bit block is used to determine a first radio resource block set; the first radio resource block set comprises a PUCCH resource set; the first radio resource block is a radio resource block in the first radio resource block set; when a value of the second field in the first signaling is equal to a fourth value, a number of bit(s) related to the second bit block and carried by the first signal is equal to 0, and a bit block generated by the second bit block is not used to determine the first radio resource block set; when a value of the second field in the first signaling is equal to a fifth value, a number of bit(s) related to the second bit block and carried by the first signal is greater than 0, and a bit block generated by the second bit block is used to determine the first radio resource block set.

In one subembodiment of the above embodiment, the third radio resource block is reserved for the first bit block; the second radio resource block is reserved for the second bit block; the third radio resource block and the second radio resource block are overlapping in time domain.

In one subembodiment of the above embodiment, the fourth value is equal to 0, and the fifth value is equal to 1.

In one subembodiment of the above embodiment, the fourth value is equal to 1, and the fifth value is equal to 0.

In one subembodiment of the above embodiment, when the value of the second field in the first signaling is equal to the fourth value: a number of bit(s) comprised in the first bit block is used to select the first radio resource set from M radio resource block sets.

In one subembodiment of the above embodiment, when the value of the second field in the first signaling is equal to the fifth value: a sum of a number of bit(s) comprised in the first bit block and a number of bit(s) comprised in the bit block generated by the second bit block is used to select the first radio resource set from M radio resource block sets.

In one subembodiment of the above embodiment, when the value of the second field in the first signaling is equal to the fifth value: a size of the first bit block is used to determine the number of bit(s) related to the second bit block and carried by the first signal.

In one subembodiment of the above embodiment, the first signaling comprises a priority indicator field.

### Embodiment 12D

Embodiment 12D illustrates a structure block diagram of a processor in a first node, as shown in FIG. 12D.

In FIG. 12D, a processor 1200D in a first node comprises a first receiver 1201D and a first transmitter 1202D.

In one embodiment, the first node 1200D is a UE.

In one embodiment, the first node 1200D is a relay node.

In one embodiment, the first node 1200D is a vehicle-mounted communication device.

In one embodiment, the first node 1200D is a UE that supports V2X communications.

In one embodiment, the first node 1200D is a relay node that supports V2X communications.

In one embodiment, the first receiver 1201D comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201D comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201D comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201D comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201D comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202D comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202D comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202D comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202D comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202D comprises at least first two of the antenna 452, the transmitter 454, the multi-antenna transmitting processor 457, the transmitting processor 468, the controller/processor 459, the memory 460, and the data source 467 in FIG. 4 of the present application.

In Embodiment 12D, the first receiver 1201D receives a first signaling; the first transmitter 1202D transmits a first signal in a first time window, and the first signal carries a first bit block; the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

In one embodiment, the first signaling is used to determine K time windows, and K is a positive integer greater than 1; the first time window is one of the K time windows.

In one embodiment, each of the K time windows is respectively reserved for a physical-layer channel transmission with configured grant used to carry the first bit block in the present application.

In one embodiment, when the number of the time element(s) comprised in the first time window is not greater than a first number, the first signal does not carry a bit block used to determine the RV corresponding to the first signal, and the RV corresponding to the first signal is a first RV; when the number of the time element(s) comprised in the first time window is greater than the first number, the first signal carries a second bit block, and the second bit block is used to determine the RV corresponding to the first signal.

In one embodiment, K is used to determine the first RV.

In one embodiment, a first time slice comprises the first time window; the first time slice is used to determine the first RV.

In one embodiment, the second bit block is transmitted in the first time window; the second bit block comprises indication information related to channel occupation time.

### Embodiment 13A

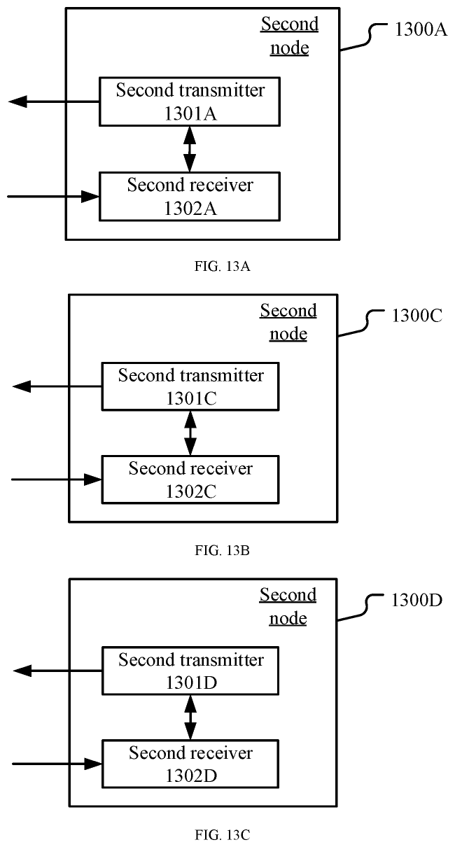

Embodiment 13A illustrates a structure block diagram of a processor in a second communication node, as shown in FIG. 13A. In FIG. 13A, a processor 1300A of a second node comprises a second transmitter 1301A and a second receiver 1302A.

In one embodiment, the second node 1300A is a UE.

In one embodiment, the second node 1300A is a base station.

In one embodiment, the second node 1300A is a relay node.

In one embodiment, the second node 1300A is a vehicle-mounted communication device.

In one embodiment, the second node 1300A is a UE supporting V2X communications.

In one embodiment, the second transmitter 1301A comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301A comprises at least first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301A comprises at least first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301A comprises at least first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301A comprises at least first two of the antenna 420, the transmitter 418, the multi-antenna transmitting processor 471, the transmitting processor 416, the controller/processor 475 and the memory 476 in FIG. 4 of the present application.

In one embodiment, the second receiver 1302A comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302A comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1302A comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1302A comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1302A comprises at least first two of the antenna 420, the receiver 418, the multi-antenna receiving processor 472, the receiving processor 470, the controller/processor 475 and the memory 476 in FIG. 4 of the present application.

In embodiment 13A, the second transmitter 1301A transmits a first signaling and a second signaling; the first receiver 1302A receives a first signal in a target radio resource block, and the first signal carries a first bit block; the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

In one embodiment, the first bit block comprises a first-type HARQ-ACK; the third bit block comprises a second-type HARQ-ACK.

In one embodiment, when a priority of the second bit block is a first priority, the target radio resource block is the fourth radio resource block; when a priority of the second bit block is not the first priority, the target radio resource block is the first radio resource block.

In one embodiment, a fifth radio resource block is reserved for the first bit block; a third radio resource block is reserved for the third bit block; the fifth radio resource block overlaps with the third radio resource block in time domain.

In one embodiment, N number range(s) corresponds (respectively correspond) to N radio resource block set(s); a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block set(s); the first radio resource block set comprises the first radio resource block.

In one embodiment, when the target radio resource block is the first radio resource block, the second node does not execute a signal reception for the second bit block in a second radio resource sub-block; the second radio resource sub-block is a part overlapping with the first radio resource block in time domain and comprised in the second radio resource block.

In one embodiment, the first number is used to determine the fourth radio resource block; a number of bit(s) comprised in the first bit block and a number of bit(s) comprised in a fourth bit block are used to determine the first number; the fourth bit block is related to the third bit block; a number of bit(s) comprised in the fourth bit block is less than a number of bit(s) comprised in the third bit block.

### Embodiment 13B

Embodiment 13B illustrates a structure block diagram of a processor in a second node, as shown in FIG. 13B. In FIG. 13B, a processor 1300C of a second node comprises a second transmitter 1301C and a second receiver 1302C.

In one embodiment, the second node 1300C is a UE.

In one embodiment, the second node 1300C is a base station.

In one embodiment, the second node 1300C is a relay node.

In one embodiment, the second node 1300C is a vehicle-mounted communication device.

In one embodiment, the second node 1300C is a UE supporting V2X communications.

In one embodiment, the second transmitter 1301C comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301C comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301C comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301C comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301C comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302C comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302C comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1302C comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1302C comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1302C comprises at least first two of the antenna 420, the receiver 418, the multi-antenna receiving processor 472, the receiving processor 470, the controller/processor 475 and the memory 476 in FIG. 4 of the present application.

In embodiment 13B, the second transmitter 1301C transmits a second signaling and a first signaling; the second receiver 1302C receives a first signal in a first radio resource block, the first signal carries a first bit block; the first signaling and the second signaling are respectively used to determine the first bit block and a second bit block; the first signaling is used to determine the first radio resource block; the first bit block comprises a first-type HARQ-ACK, and the second bit block comprises a second-type HARQ-ACK; the first-type HARQ-ACK and the second-type HARQ-ACK are respectively different types of HARQ-ACKs; the first bit block and the second bit block respectively correspond to different indexes; the first signaling comprises a second field; the second field in the first signaling is used to determine a number of bit(s) related to the second bit block and carried by the first signal.

In one embodiment, a third radio resource block is reserved for the first bit block; a second radio resource block is reserved for the second bit block; the third radio resource block and the second radio resource block are overlapping in time domain.

In one embodiment, the second field in the first signaling is used to determine whether a bit block generated by the second bit block is used to determine a first radio resource block set; the first radio resource block is a radio resource block in the first radio resource block set.

In one embodiment, the number of bit(s) related to the second bit block and carried by the first signal is equal to one of K candidate numbers; the second field in the first signaling indicates an index of the number of bit(s) related to the second bit block and carried by the first signal among the K candidate numbers; K is greater than 1.

In one embodiment, when a value of the second field in the first signaling is equal to a first value, the second field in the first signaling indicates that the number of bit(s) related to the second bit block and carried by the first signal is equal to 0; when a value of the second field in the first signaling is equal to a second value, the second field in the first signaling indicates that the number of bit(s) related to the second bit block and carried by the first signal is not greater than a seventh number; when a value of the second field in the first signaling is equal to a third value, the second field in the first signaling indicates that the number of bit(s) related to the second bit block and carried by the first signal is equal to a total number of bit(s) comprised in the second bit block.

In one embodiment, the second field in the first signaling is used to determine whether a size of the first bit block is used to determine the number of bit(s) related to the second bit block and carried by the first signal.

In one embodiment, the second field in the first signaling is used to determine whether a number of bit(s) of the second-type HARQ-ACK related to the second bit block and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK unrelated to the second bit block; when a value of the second field in the first signaling is not equal to the sixth value or a value of the third field in the first signaling is not equal to the seventh value, the first signal does not carry the second-type HARQ-ACK unrelated to the second bit block.

In one embodiment, the first signal carries the first-type HARQ-ACK corresponding to a first PDSCH group; the first signaling comprises a DCI; the first signaling comprises a second field; the second field in the first signaling is used to determine whether a number of bit(s) of the second-type HARQ-ACK corresponding to the first PDSCH group and carried by the first signal is greater than 0; the first signaling comprises a third field; when a value of the second field in the first signaling is equal to a sixth value and a value of the third field in the first signaling is equal to a seventh value, the first signal carries the second-type HARQ-ACK corresponding to the first PDSCH group, the first-type HARQ-ACK corresponding to a second PDSCH group and the second-type HARQ-ACK corresponding to the second PDSCH group; when the value of the second field in the first signaling is not equal to the sixth value and the value of the third field in the first signaling is equal to the seventh value, the first signal carries the first-type HARQ-ACK corresponding to the second PDSCH group; when the value of the second field in the first signaling is equal to the sixth value and the value of the third field in the first signaling is not equal to the seventh value, the first signal carries the second-type HARQ-ACK corresponding to the first PDSCH group.

In one subembodiment of the above embodiment, the third field comprises a Number of requested PDSCH group(s) field.

In one subembodiment of the above embodiment, the third field comprises one bit.

In one subembodiment of the above embodiment, the second field comprises one bit.

In one subembodiment of the above embodiment, when the value of the second field in the first signaling is not equal to the sixth value and the value of the third field in the first signaling is not equal to the seventh value: the first signal carries only the first-type HARQ-ACK corresponding to the first PDSCH group in the first-type HARQ-ACK corresponding to the first PDSCH group, the second-type HARQ-ACK corresponding to the first PDSCH group, the first-type HARQ-ACK corresponding to the second PDSCH group and the second-type HARQ-ACK corresponding to the second PDSCH group.

In one subembodiment of the above embodiment, the first-type HARQ-ACK corresponds to priority index 1, and the second-type HARQ-ACK corresponds to priority index 0.

In one subembodiment of the above embodiment, the first-type HARQ-ACK corresponds to priority index 0, and the second-type HARQ-ACK corresponds to priority index 1.

In one subembodiment of the above embodiment, the first signaling comprises a priority indicator field.

In one subembodiment of the above embodiment, the sixth value is equal to 1.

In one subembodiment of the above embodiment, the seventh value is equal to 1.

In one subembodiment of the above embodiment, the sixth value is equal to 0.

In one subembodiment of the above embodiment, the seventh value is equal to 0.

In one subembodiment of the above embodiment, the first signaling comprises a PDSCH group index field.

In one subembodiment of the above embodiment, a PDSCH group index field comprised in the first signaling indicates an index corresponding to the first PDSCH.

In one subembodiment of the above embodiment, the first radio resource block comprises a PUCCH resource.

### Embodiment 13C

Embodiment 13C illustrates a structure block diagram of a processor in a second node, as shown in FIG. 13C. In FIG. 13C, a processor 1300D of the second node comprises a second transmitter 1301D and a second receiver 1302D.

In one embodiment, the second node 1300D is a UE.

In one embodiment, the second node 1300D is a base station.

In one embodiment, the second node 1300D is a relay node.

In one embodiment, the second node 1300D is a vehicle-mounted communication device.

In one embodiment, the second node 1300D is a UE supporting V2X communications.

In one embodiment, the second transmitter 1301D comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301D comprises at least first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301D comprises at least first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301D comprises at least first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301D comprises at least first two of the antenna 420, the transmitter 418, the multi-antenna transmitting processor 471, the transmitting processor 416, the controller/processor 475 and the memory 476 in FIG. 4 of the present application.

In one embodiment, the second receiver 1302D comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302D comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1302D comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1302D comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1302D comprises at least first two of the antenna 420, the receiver 418, the multi-antenna receiving processor 472, the receiving processor 470, the controller/processor 475 and the memory 476 in FIG. 4 of the present application.

In embodiment 13C, the second transmitter 1301D transmits a first signaling; the second receiver 1302D receives a first signal in a first time window, the first signal carries a first bit block; the first signaling is used to determine the first time window; the first time window is reserved for a transmission of the first bit block; the first time window comprises one or more time element(s); a number of the time element(s) comprised in the first time window is used to determine whether an RV corresponding to the first signal is determined by a bit block carried by the first signal.

In one embodiment, the first signaling is used to determine K time windows, and K is a positive integer greater than 1; the first time window is one of the K time windows.

In one embodiment, each of the K time windows is respectively reserved for a physical-layer channel transmission with configured grant used to carry the first bit block in the present application.

In one embodiment, when the number of the time element(s) comprised in the first time window is not greater than a first number, the first signal does not carry a bit block used to determine the RV corresponding to the first signal, and the RV corresponding to the first signal is a first RV; when the number of the time element(s) comprised in the first time window is greater than the first number, the first signal carries a second bit block, and the second bit block is used to determine the RV corresponding to the first signal.

In one embodiment, K is used to determine the first RV.

In one embodiment, a first time slice comprises the first time window; the first time slice is used to determine the first RV.

In one embodiment, the second bit block is transmitted in the first time window; the second bit block comprises indication information related to channel occupation time.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling; and
a first transmitter, transmitting a first signal in a target radio resource block, the first signal carrying a first bit block;
wherein the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

2. The first node according to claim 1, wherein the first bit block comprises a first-type HARQ-ACK, the first-type HARQ-ACK comprises HARQ-ACK corresponding to priority index 1, the third bit block comprises an SR, and the second bit block comprises a TB; the first radio resource block comprises a PUCCH resource, the second radio resource block comprises a PUCCH resource or radio resources occupied by a PUSCH, and the fourth radio resource block comprises a PUCCH resource.

3. The first node according to claim 2, wherein a first priority and a second priority are respectively different priorities, a priority of the first bit block is the first priority, and a priority of the third bit block is the second priority; a priority of the second bit block is one of the first priority or the second priority;
or, wherein the third bit block comprises an SR corresponding to priority index 1, and the first radio resource block comprises radio resources occupied by a PUSCH.

4. The first node according to claim 1, wherein when a priority of the second bit block is a first priority, the target radio resource block is the fourth radio resource block; when a priority of the second bit block is not the first priority, the target radio resource block is the first radio resource block.

5. The first node according to claim 1, wherein a fifth radio resource block is reserved for the first bit block; a third radio resource block is reserved for the third bit block; the fifth radio resource block overlaps with the third radio resource block in time domain.

6. The first node according to claim 1, wherein N number rages respectively correspond to N radio resource block sets; a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block sets; the first radio resource block set comprises the first radio resource block.

7. The first node according to claim 1, wherein when the target radio resource block is the first radio resource block, the first node does not transmit a signal carrying the second bit block in a second radio resource sub-block; the second radio resource sub-block is a part overlapping with the first radio resource block in time domain and comprised in the second radio resource block.

8. A second node for wireless communications, comprising:
a second transmitter, transmitting a first signaling and a second signaling; and
a second receiver, receiving a first signal on a target radio resource block, the first signal carrying a first bit block;
wherein the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

9. The second node according to claim 8, wherein the first bit block comprises a first-type HARQ-ACK, the first-type HARQ-ACK comprises HARQ-ACK corresponding to priority index 1, the third bit block comprises an SR, and the second bit block comprises a TB; the first radio resource block comprises a PUCCH resource, the second radio resource block comprises a PUCCH resource or radio resources occupied by a PUSCH, and the fourth radio resource block comprises a PUCCH resource.

10. The second node according to claim 9, wherein a first priority and a second priority are respectively different priorities, a priority of the first bit block is the first priority, and a priority of the third bit block is the second priority; a priority of the second bit block is one of the first priority or the second priority;
or, wherein the third bit block comprises an SR corresponding to priority index 1, and the first radio resource block comprises radio resources occupied by a PUSCH.

11. The second node according to claim 8, wherein when a priority of the second bit block is a first priority, the target radio resource block is the fourth radio resource block; when a priority of the second bit block is not the first priority, the target radio resource block is the first radio resource block.

12. The second node according to claim 8, wherein a fifth radio resource block is reserved for the first bit block; a third radio resource block is reserved for the third bit block; the fifth radio resource block overlaps with the third radio resource block in time domain.

13. The second node according to claim 8, wherein N number rages respectively correspond to N radio resource block sets; a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block sets; the first radio resource block set comprises the first radio resource block.

14. A method in a first node for wireless communications, comprising:
receiving a first signaling and a second signaling; and
transmitting a first signal in a target radio resource block, the first signal carrying a first bit block;
wherein the first signaling is used to determine the first bit block, and the second signaling is used to determine a third bit block; a second radio resource block is reserved for a second bit block; a number of bit(s) comprised in the first bit block and a number of bit(s) comprised in the third bit block are used to determine a first radio resource block, and the first radio resource block overlaps with the second radio resource block in time domain; a first number is used to determine a fourth radio resource block, the first number is not less than the number of bit(s) comprised in the first bit block and is less than a sum of the number of bit(s) comprised in the first bit block and the number of bit(s) comprised in the third bit block, and the fourth radio resource block and the second radio resource block are orthogonal to each other in time domain; the target radio resource block is the first radio resource block or the fourth radio resource block, and a priority of the second bit block is used to determine the target radio resource block from the first radio resource block and the fourth radio resource block.

15. The method in a first node according to claim 14, wherein the first bit block comprises a first-type HARQ-ACK, the first-type HARQ-ACK comprises HARQ-ACK corresponding to priority index 1, the third bit block comprises an SR, and the second bit block comprises a TB; the first radio resource block comprises a PUCCH resource, the second radio resource block comprises a PUCCH resource or radio resources occupied by a PUSCH, and the fourth radio resource block comprises a PUCCH resource.

16. A method in a first node according to claim 15, wherein a first priority and a second priority are respectively different priorities, a priority of the first bit block is the first priority, and a priority of the third bit block is the second priority; a priority of the second bit block is one of the first priority or the second priority;
or, wherein the third bit block comprises an SR corresponding to priority index 1, and the first radio resource block comprises radio resources occupied by a PUSCH.

17. The method in a first node according to claim 14, wherein when a priority of the second bit block is a first priority, the target radio resource block is the fourth radio resource block; when a priority of the second bit block is not the first priority, the target radio resource block is the first radio resource block.

18. A method in a first node according to claim 14, wherein a fifth radio resource block is reserved for the first bit block; a third radio resource block is reserved for the third bit block; the fifth radio resource block overlaps with the third radio resource block in time domain.

19. The method in a first node according to claim 14, wherein N number rages respectively correspond to N radio resource block sets; a first number range is one of the N number ranges; a sum of the number of bit(s) comprised in the first bit block and the number of bit(s) comprised in the third bit block is equal to a number in the first number range; a first radio resource block set is a radio resource block set corresponding to the first number range among the N radio resource block sets; the first radio resource block set comprises the first radio resource block.

20. The method in a first node according to claim 14, wherein when the target radio resource block is the first radio resource block, a signal carrying the second bit block is not transmitted in a second radio resource sub-block; the second radio resource sub-block is a part overlapping with the first radio resource block in time domain and comprised in the second radio resource block.
